(19) United States
(12) Patent Application Publication
(10) Pub. No.: US 2025/0030047 A1
(43) Pub. Date: Jan. 23, 2025

(54) HIGH PERFORMANCE AIR STABLE SOLID POLYMER ELECTROLYTE

(71) Applicants: University of Maryland, College Park, College Park, MD (US); The United States of America as Represented by the Secretary of the Army, Washington, DC (US)

(72) Inventors: Matthew D. WIDSTROM, Ellicott City, MD (US); Peter KOFINAS, N. Bethesda, MD (US); Arthur V. CRESCE, Beltsville, MD (US); Kang XU, Potomac, MD (US); Kyle B. LUDWIG, Berwyn Heights, MD (US)

(21) Appl. No.: 18/905,792

(22) Filed: Oct. 3, 2024

Related U.S. Application Data
(63) Continuation-in-part of application No. 18/131,745, filed on Apr. 6, 2023.
Application No. 18/131,745 is a continuation of application No. 16/241,813, filed on Jan. 7, 2019, now Pat. No. 11,631,892.
(60) Provisional application No. 63/587,580, filed on Oct. 3, 2023.
(60) Provisional application No. 62/613,858, filed on Jan. 5, 2018.

(51) Int. Cl. H01M 10/0565; H01M 4/38; H01M 4/505; H01M 4/58; H01M 10/0525

(52) U.S. Cl. CPC H01M 10/0565; H01M 4/38; H01M 4/505; H01M 4/5825; H01M 10/0525; H01M 2300/0082

(57) ABSTRACT

The present invention is directed to aqueous solid polymer electrolytes that comprise a lithium salt and an ionic liquid, and battery cells comprising the same. The present invention is also directed to methods of making the electrolytes and methods of using the electrolytes in batteries and other electrochemical technologies.

### CROSS-REFERENCE TO RELATED APPLICATIONS

The present application is a continuation-in-part of U.S. application Ser. No. 18/131,745, filed on Apr. 6, 2023, which is a continuation of U.S. application Ser. No. 16/241,813, filed on Jan. 7, 2019, which claims priority to U.S. Provisional Application No. 62/613,858, filed on Jan. 5, 2018, each of which is incorporated by reference herein in its entirety.

### STATEMENT REGARDING FEDERALLY SPONSORED RESEARCH OR DEVELOPMENT

This invention was made with government support under CBET2037835 awarded by the National Science Foundation and 201414082800003 awarded by the Central Intelligence Agency. The government has certain rights in the invention.

### BACKGROUND OF THE INVENTION

### Field of the Invention

The present invention describes aqueous solid polymer electrolytes that comprise a lithium salt and at least one ionic liquid, and battery cells comprising the same. The present invention is also directed to methods of making the electrolytes and methods of using the electrolytes in batteries and other electrochemical technologies.

### Background of the Invention

Rechargeable batteries that output high cell voltages (>3.0 V) typically utilize non-aqueous and aprotic solvents to dissolve conducting salts, because these solvents are able to afford the stability against the oxidative or reductive reactions incurred by electrode surfaces of extreme potentials. Because electrolyte components are almost never thermodynamically stable on strongly reductive surfaces of the anode or strongly oxidative surfaces of the cathode, electrochemical stability is rather attained through the passivation of the electrode surfaces.

Commonly, the component in a Li-ion battery that makes an interface between the two electrodes is an electrolyte. Traditionally, liquid electrolytes were used in Li-ion batteries due to their efficient ion transport ability across the two electrodes. However, liquid electrolytes suffer from limitations such as problems in storage and transportation, leakage at the electrode-electrolyte interfaces, and difficulties in handling and processing. Solid electrolytes are superior to liquid electrolytes in several aspects: stability, enhanced electrode-electrolyte compatibility, less likely to leak, and flexibility. However, the limitation of low ionic conductivity curtails the use of solid electrolytes in Li-ion batteries.

State-of-the-art battery chemistries using such non-aqueous electrolytes suffer from high flammability of these organic solvents, as well as the toxicity with the fluorophosphates anions of Li, Na, and other metal salts. Non-aqueous electrolytes used to dissolve Mg and Al are typically very dangerous and reactive Lewis acid solutions known as Grignard reagents are highly toxic and corrosive. The moisture-sensitivity and high reactivity of these non-aqueous electrolyte components also require special moisture exclusion facilities during manufacturing and processing, thus causing additional costs. In addition to the direct costs incurred by these expensive electrolyte components, the potential safety hazards associated with these highly reactive electrolyte components also adds to the final cost of the battery packs, where expensive packaging and electronic protective devices and safety management have to be used.

Aqueous electrolytes could resolve these concerns; however, their electrochemical stability window (1.23 V) is too narrow to support most of the electrochemical couples used in Li-ion batteries. In particular, hydrogen evolution at the anode presents the gravest challenge because it occurs at a potential (between approximately 2.21-3.04 V vs. Li (depending on the pH value)) far above where most Li-ion battery anode materials operate. Even in trace amounts, hydrogen severely deteriorates the electrode structure during cycling.

The present invention describes a new class of aqueous polymer electrolytes that are sufficiently stable to accommodate Li-ion battery chemistries and when employed in full cells can operate with cell voltages greater than 3 V. These aqueous polymer electrolytes are able to accommodate high concentrations of various lithium salts.

### BRIEF SUMMARY OF THE INVENTION

The present invention describes an electrolyte, comprising:
(a) at least one lithium salt in water;
(b) at least one ionic liquid; and
(c) at least one polymer;
   wherein the mass ratio of the polymer to the at least one lithium salt and at least one ionic liquid in the electrolyte from about 1:1 to about 100:1.

In some embodiments, the at east one lithium salt comprises an anion selected from the group consisting of bis(trifluoromethane sulfonyl)imide (TFSI⁻), trifluoromethane sulfonate (TF⁻), bis(fluorosulfonyl) imide (FSI⁻), tetrafluorophosphate (BF₄⁻), hexafluorophosphate (PF₆⁻), bis(perfluoroethyl sulfonyl)imide (BETI⁻), 4,5-dicyano-2-trifluoromethanoimidazole (DCMI⁻), [fluoro (nonafluorobutane) sulfonyl] imide (FNF⁻), perchlorate (ClO₄⁻), sulfate (SO₄⁻), bis(oxalate) borate (BOB⁻), dicyanamide (C₂N₃⁻), nitrate (NO₃⁻), acetate (CH₃CO₂⁻), chloride (Cl⁻), bromide (Br⁻), and iodide (I⁻).

In some embodiments, the at least one lithium salt is LiTFSI.

In some embodiments, the molality of the lithium salt and ionic liquid to water is from about 10 mol/kg and about 60 mol/kg.

In some embodiments, the at least one polymer is selected from the group consisting of polyethylene oxide, polyacrylonitrile, polyvinylidene fluoride, poly(methyl acrylate), poly(methyl methacrylate), poly(oxymethylene), and polystyrene.

In some embodiments, the at least one polymer is polyethylene oxide or polyacrylonitrile.

In some embodiments, the ionic liquid comprises an anion selected from the group consisting of bis(trifluoromethane sulfonyl)imide (TFSI⁻), trifluoromethane sulfonate (TF⁻), bis(fluorosulfonyl) imide (FSI⁻), tetrafluorophosphate (BF₄⁻), hexafluorophosphate (PF₆⁻), bis(perfluoroethyl sulfonyl)imide (BETI⁻), 4,5-dicyano-2-trifluoromethanoimidazole (DCMI⁻), [fluoro (nonafluorobutane) sulfonyl] imide (FNF⁻), perchlorate (ClO₄⁻), sulfate (SO₄⁻), bis(oxalate) borate (BOB⁻), dicyanamide (C₂N₃⁻), nitrate (NO₃⁻), acetate (CH₃CO₂⁻), chloride (Cl⁻), bromide (Br⁻), and iodide (I⁻).

In some embodiments, the ionic liquid comprises a cation selected from the group consisting of imidazolium, pyrrolidinium, pyridinium, phosphonium, ammonium, guanidinium, piperidinium, and sulfonium.

In some embodiments, the pyrrolidinium is 1-methyl-1-propylpyrrolidinium (Pyr_{1,3}).

In some embodiments, the sulfonium is triethylsulfonium (S_{2,2,2}).

In some embodiments, the molar ratio of the at least one polymer to water is from about 1:1 to about 1:6.

In some embodiments, the molar ratio of the at least one ionic liquid to water is from about 1:2 to about 1:60.

In some embodiments, the mass ratio of the at least one polymer to the at least one lithium salt is between about 1:107 and about 107:1.

In some embodiments, the electrolyte has an ionic conductivity at 25° C. from about 1 mS/cm to about 7 mS/cm.

The present invention also describes an electrochemical battery cell comprising:
(a) an electrolyte disclosed herein;
(b) a positive electrode; and
(c) a negative electrode.

In some embodiments, the positive electrode is selected from the group consisting of LiCoO₂, LiNi_{0.33}Mn_{0.33}Co_{0.33}O₂, LiNi_{0.5}Mn_{1.5}O₂, LiCoPO₄, LiFePO₄, LiNiPO₄, and LiMn₂O₄.

In some embodiments, the negative electrode is selected from the group consisting of lithium, magnesium, aluminum, zinc, chromium, iron, nickel, tin, lead, hydrogen, copper, silver, palladium, mercury, platinum, gold, molybdenum, sulfur, combinations thereof, and oxides thereof.

The present invention also describes a method of preparing an electrolyte comprising:
(a) admixing at least one lithium salt in water, at least one ionic liquid, and at least one polymer, wherein the mass ratio of the polymer to the at least one lithium salt and at least one ionic liquid in the electrolyte from about 1:1 to about 100:1; and
(b) pressing the admixture of (a) at a temperature from about 30° C. to about 150° C. and at a pressure from about 0.2 metric tons to about 2 metric tons.

In some embodiments, the electrolyte is a thin film having a thickness from about 50 μm to about 300 μm.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention. The following drawings are given by way of illustration only, and thus are not intended to limit the scope of the present invention.

FIG. 1 is a graph of conductivity versus inverse temperature for a solid polymer electrolyte (21 molal solution of lithium bis(trifluoromethylsulfonyl)imide (LiTFSI) salt in water mixed with poly(ethylene oxide) (PEO) polymer (MW=1 million) (10:3 mass ratio) hot-pressed at 85° C.) measured by impedence spectroscopy. Temperature was taken from 0° C. to 80° C. The conductivity of the solid polymer electrolyte was shown to be 0.99 mS/cm at 25° C.

FIG. 2 is a graph showing cyclic performance at 25° C. for a solid polymer electrolyte (21 molal solution of LiTFSI salt in water mixed with PEO polymer (MW=1 million) (10:3 mass ratio) hot-pressed at 85° C.), a lithium titanate (Li₄Ti₅O₁₂ (LTO)) anode, and a lithium manganese oxide (LiMn₂O₄) cathode. □ represents specific capacity and Δ represents coloumbic efficiency.

FIG. 3 is a graph showing voltage versus time for the cycling performance at 25° C. for a solid polymer electrolyte (21 molal solution of LiTFSI salt in water mixed with PEO polymer (MW=1 million) (10:3 mass ratio) hot-pressed at 85° C.), a LTO anode, and a LiMn₂O₄ cathode. The battery test cell was cycled at a charge rate of C/3 with ˜98% coulombic efficiency delivering ˜120 mA/g capacity.

FIG. 4 is a linear sweep voltammogram for a coin cell comprising an aluminum working electrode, a solid polymer electrolyte (21 molal solution of LiTFSI salt in water mixed with PEO polymer (MW=1 million) (10:3 mass ratio) hot-pressed at 85° C.), and a LiFePO₄ reference electrode. The coin cell was tested at 60° C. with the electrochemical stability window tested fro 0.75 V to 6.5 V. The coin cell produced an electrochemical stability window of 5.75 V at 0.1 mA/cm².

FIG. 5 is a differential scanning calorimetry (DSC) thermogram of a solid polymer electrolyte (21 molal solution of LiTFSI salt in water mixed with PEO polymer (MW=1 million) (10:3 mass ratio) hot-pressed at 85° C.) measured in the range between −40° C. and 100° C. No thermal transitions were observed.

FIG. 6 is a graph showing stress versus strain response for a solid polymer electrolyte (21 molal solution of LiTFSI salt in water mixed with PEO polymer (MW=1 million) (10:3 mass ratio) hot-pressed at 85° C.) measured under tension at 25° C. using dynamic mechanical analysis. The elastic modulus of the solid polymer electrolyte was measured as G=1.51 kPa and showed a Young's modulus of E=15.1 kPa.

FIG. 7 is a graph showing the conductivity of a solid polymer electrolyte (22 molal solution of LiTFSI salt in water mixed with poly(acrylonitrile) (PAN) polymer (MW=100,000) (10:3 mass ratio) hot-pressed at 85° C.) between 0° C. and 100° C. The solid polymer electrolyte showed conductivity of 2.6 mS/cm at room temperature.

FIG. 8 is a graph showing the conductivity of a solid polymer electrolyte (22 molal solution of LiTFSI salt in water mixed with poly(acrylonitrile) (PAN) polymer (MW=100,000) (10:3 mass ratio) hot-pressed at 85° C.) between 100° C. and 160° C. The solid polymer electrolyte showed thermal stability up to 160° C. Conductivity was measured up to 160° C. at which point the cells failed.

FIG. 9 is a graph showing the conductivity of a solid polymer electrolyte (21 molal solution of LiTFSI salt in water mixed with PEO polymer (MW=4 million) (10:3 mass ratio) hot-pressed at 85° C.) between 20° C. and 80° C. The solid polymer electrolyte showed conductivity of 1.92 mS/cm at room temperature.

FIG. 10 is a linear sweep voltammogram for a coin cell comprising an aluminum working electrode, a solid polymer electrolyte (21 molal solution of LiTFSI salt and 7 molal solution of lithium trifluoromethane sulfonate (LiTf) salt in water mixed with PEO polymer (MW=1 million) (10:3 mass ratio) hot-pressed at 85° C.), and a LiFePO₄ reference electrode. The coin cell was tested at 60° C. with the electrochemical stability window tested fro 0.75 V to 6.75 V. The coin cell produced an electrochemical stability window of 6 V at 0.1 mA/cm².

FIG. 11 is a graph of conductivity versus inverse temperature for a solid polymer electrolyte (21 molal solution of LiTFSI salt and 7 molal solution of LiOTf salt in water mixed with PEO polymer (MW=1 million) (10:3 mass ratio) hot-pressed at 85° C.) measured by impedence spectroscopy. Temperature was taken from 20° C. to 80° C. The conductivity of the solid polymer electrolyte was shown to be 3.47 mS/cm at 25° C.

FIG. 12 is a graph showing cyclic performance at 25° C. for a solid polymer electrolyte (21 molal solution of LiTFSI salt in water mixed with PEO polymer (MW=1 million) (10:3 mass ratio) hot-pressed at 85° C.), a sulfur anode, and a LiMn₂O₄ cathode. □ represents specific capacity and A represents coloumbic efficiency. The battery test cell was cycled at a charge rate of C/8 (average) and C/4 (final) with ˜95% coulombic efficiency delivering ˜30 mAh/g specific capacity.

FIG. 13 is a schematic depicting the molecular structure, atomic mass, and van der Waals volume ionic for the S_{2,2,2}⁺ and Pyr_{1,3}⁺ ionic liquid cations and the TFSI anion.

FIG. 14 is a line graph depicting mDSC thermograms (offset, exotherm up) in the heating direction over the range of −70° C.-110° C. for four HAILSPE systems studied having the compositions provided in Table 1; the inset plots provide zoomed-in views of the (left) S_{2,2,2} H2.5 and (right) Pyr_{1,3} H2.5 electrolytes.

FIG. 15 is a line graph depicting ionic conductivity, as measured by EIS, over a temperature range of 0-80° C., of the HAILSPE compositions H1 and H2.5 using S_{2,2,2} and Pyr_{1,3} ionic liquids as described in Table 1.

FIG. 16 is a set of Arrhenius plots of ionic conductivity for four HAILSPE systems, (A) S_{2,2,2} H1, (B) Pyr_{1,3} H1, (C) S_{2,2,2} H2.5, and (D) Pyr_{1,3} H2.5, as described in Table 1.

FIG. 17 is a line graph depicting a comparison of the correlation between the Arrhenius pre-exponential factor ln A and the apparent activation energy E_{α} for the HAILSPE systems disclosed herein (stars) and previously disclosed ASPE (left triangle) and ILSPE (right triangle) systems, whose compositions are described in Tables 1, 3, and 4; the inset plot shows the full-temperature ionic conductivity profiles for the circled electrolytes with the smallest (S_{2,2,2} H2.5) and largest (ILSPE 3) E_{α}.

FIG. 18 is a set of scatter plots depicting pfg-NMR measured diffusion coefficients for the mobile species H₂O (squares), Li⁺ (stars), IL⁺ (up triangles), and TFSI⁻ (down triangles) present in S_{2,2,2} H1 (blue, filled), Pyr_{1,3} H1 (blue, empty), S_{2,2,2} H2.5 (green, filled), and Pyr_{1,3} H2.5 (green, empty) electrolytes, whose compositions are provided in Table 2, expressed as a function of the lithium-ion mole fraction X_{Li}⁺.

FIG. 19 is a set of line graphs depicting the determination of the anodic limit via LSV from current density as a function of cell potential for the (A) S_{2,2,2} (solid) and Pyr_{1,3} (dashed) H1 electrolytes, and (B) S_{2,2,2} (solid) and Pyr_{1,3} (dashed) H2.5 electrolytes; the insets provide a zoomed-in view limited to 10% of the ordinate over the range of 3.8-4.8 V vs. Li/Li⁺.

FIG. 20 is a set of line graphs depicting cyclic voltammagrams, limited to 2 V vs. Li/Li⁺, for (A) S_{2,2,2} H1 and (B) Pyr_{1,3} H1, showing the first 5 cycles in both overlayed and stacked forms.

FIG. 21 is a set of line graphs depicting cyclic voltammagrams, limited to 2 V vs. Li/Li⁺, for (A) S_{2,2,2} H2.5 and (B) Pyr_{1,3} H2.5, showing the first 5 cycles in both overlayed and stacked forms.

FIG. 22 is a set of plots depicting room-temperature (25° C.) ionic conductivity as a function of PAN, H₂O, and LiTFSI content for A) S_{2,2,2} H1-H14 and B) Pyr_{1,3} H1-H14, H19-H22 (as described in Tables 7-9); and the ionic conductivity values as a function of just H₂O and LiTFSI for C) S_{2,2,2} and D) Pyr_{1,3}.

FIG. 23 is a set of radar plots depicting representative trends in room-temperature (25° C.) ionic conductivity based on altering H₂O, ionic liquid, LiTFSI, and PAN composition for A-D) S_{2,2,2} and E-H) Pyr_{1,3} electrolyte systems.

FIG. 24 is a set of scatter plots and line graphs depicting ionic conductivity as a function of relative composition and associated mDSC thermograms for corresponding electrolyte systems for A,B) LiTFSI and H₂O (Pyr_{1,3} H19-H21) and C,D) ionic liquid (Pyr_{1,3} H22-H24) having the compositions listed in Table 9.

FIG. 25 is a set of scatter plots depicting the effect of H₂O (“group 3”), ionic liquid (“group 1”), and LiTFSI (“group 2”) concentration on diffusion coefficients of Li⁺, IL⁺, and [TFSI]⁻ for A-C) S_{2,2,2} and D-F) Pyr_{1,3} electrolyte systems, wherein (A/D) represent group 3, (B/E) represent group 1, and (C/F) represent group 2, and all electrolyte compositions are given in Tables 10-13.

FIG. 26 is a set of line graphs and scatter plots describing lineshape analysis (LSA) of NMR 1, 6, and 7 (“group 3”), where only the relative water content was changed, for A-C) S_{2,2,2} and D-F) Pyr_{1,3} HAILSPEs; wherein (A/D) depict spectral lineshapes of each electrolyte obtained from 1H NMR measurements; and (B/E) and (C/F) depict calculated ionic diffusion coefficients and conductivity, respectively, as a function of the concentration of weakly bound H₂O in each system, determined by LSA; and all electrolyte compositions are given in Tables 10-13.

FIG. 27 is a set of line graphs depicting LSV results as a function of H₂O and ionic liquid content for A,B) S_{2,2,2} and C,D) Pyr_{1,3} H2 (black), H15 (green), and H16 (blue) HAILSPE systems measured at room temperature with a scan rate of 0.5 mV s⁻¹; insets provide a zoomed-in, 2D view of the voltammograms; all electrolyte compositions are given in Tables 14 and 15.

FIG. 28 is a set of line graphs depicting CV results as a function of H₂O and ionic liquid content for A,B) S_{2,2,2} and C,D) Pyr_{1,3} H2 (black), H15 (green), and H16 (blue) HAILSPE systems measured at room temperature with a scan rate of 0.5 mV s⁻¹, limited to 2 V versus Li/Li⁺; insets provide a zoomed-in, 2D view of the voltammograms; all electrolyte compositions are given in Tables 14 and 15.

FIG. 29 is a set of plots summarizing XPS analysis of Mo₆S₈ anodes cycled in S_{2,2,2} and Pyr_{1,3} HAILE electrolytes, wherein plots A and B depict cycling stability and voltage profile of S_{2,2,2} HAILE; plots C and D depict galvanostatic cycling of Pyr_{1,3} HAILE; and plots E-I depict spectral data and relevant fittings for E) Mo3d, F) C1s, G) F1s, H) S2p, and I) N1s.

FIG. 30 is a set of line graphs depicting A) cycling stability and B) voltage profile of Mo₆S₈/LiMn₂O₄ full cell with S_{2,2,2} HAILE at a charge-discharge rate of 1 C and 40° C.; and C) cycling stability and D) voltage profile of Mo₆S₈/LiMn₂O₄ full cell with Pyr_{1,3} HAILE at a charge-discharge rate of 1 C and 40° C.

### DETAILED DESCRIPTION OF THE INVENTION

As used herein, the singular terms “a” and “the” are synonymous and used interchangeably with “one or more” and “at least one,” unless the language and/or context clearly indicates otherwise. As used herein, the term “comprising” means including, made up of, and composed of.

All numbers in this description indicating amounts, ratios of materials, physical properties of materials, and/or use are to be understood as modified by the word “about,” except as otherwise explicitly indicated. The term “about” as used herein includes the recited number±10%. Thus, “about ten” means 9 to 11.

The term “aqueous electrolyte” as used herein, refers to an electrolyte composition that contains water. In some embodiments, the content of water in the aqueous electrolyte is between 1% and 99%.

The term “molecular compound” as used herein, refers to any compound that does not dissociate into ions under normal (ambient) conditions.

The term “ionic compound” as used herein, refers to any compound that dissociates into ions under normal (ambient) conditions.

The term “metal compound” as used herein, refers to any metal from the alkali metals (e.g., Li, Na), the alkali earth metals (e.g., Mg, Ca), the transition metals (e.g., Fe, Zn), or the post-transition metals (e.g., Al, Sn). In some embodiments, the metal compound is Li, Na, K, Mg, or Al.

The term “metal salt” as used herein, refers to any compound that can be dissociated by solvents into metal ions and corresponding anions.

The “molality” (m) of a solution is defined as the amount of substance (in moles) of solute, nₛₒₗᵤₜₑ, divided by the mass (in kg) of the solvent, mₛₒₗᵥₑₙₜ.

molality=nₛₒₗᵤₜₑ/mₛₒₗᵥₑₙₜ

The unit for molality (m) is moles per kilogram (mol/kg). A solution of concentration 1 mol/kg is also denoted as 1 molal.

The term “solvent” as used herein, refers to water (aqueous), non-aqueous compounds, or combinations thereof, that can help metal salts dissociate into metal ions and corresponding anions.

The term “non-aqueous solvent” as used herein, refers to an solvent composition that contains molecular solvents, ionic solvents, or combinations thereof. A non-aqueous solvent does not contain water.

The term “ionic liquid” as used herein refers to an organic salt that is a liquid at room temperature and pressure.

### Aqueous Solid Polymer Electrolyte

The present invention is directed to an electrolyte comprising:
(a) at least one lithium salt in water, wherein the molality of the at least one lithium salt to water is between about 1 and about 30; and
(b) at least one polymer.

The present invention is also directed to an electrolyte comprising:
(a) at least one lithium salt in water, wherein the molality of the at least one lithium salt to water is between about 1 and about 30;
(b) at least one ionic liquid; and
(c) at least one polymer.

The present invention is also directed to an electrolyte comprising:
(a) at least one lithium salt in water;
(b) at least one ionic liquid; and
(c) at least one polymer;
   wherein the mass ratio of the polymer to the at least one lithium salt and at least one ionic liquid in the electrolyte from about 1:1 to about 100:1.

### Lithium Salt

In some embodiments, the electrolyte comprises one, two, three, four, or five lithium salts. In some embodiments, the electrolyte comprises between 1 and 5, 1 and 4, 1 and 3, 1 and 2, 2 and 5, 2 and 4, 2 and 3, 3 and 5, 3 and 4, or 4 and 5 lithium salts. In some embodiments, the electrolyte comprises one lithium salt.

In some embodiments, the lithium salt comprises a lithium ion and an anion.

In some embodiments, the anion is selected from the group consisting of bis(trifluoromethane sulfonyl)imide (TFSI⁻), trifluoromethane sulfonate (TF⁻), bis(fluorosulfonyl) imide (FSI⁻), tetrafluorophosphate (BF₄⁻), hexafluorophosphate (PF₆⁻), bis(perfluoroethyl sulfonyl)imide (BETI⁻), 4,5-dicyano-2-trifluoromethanoimidazole (DCMI⁻), [fluoro (nonafluorobutane) sulfonyl] imide (FNF⁻), perchlorate (ClO₄⁻), sulfate (SO₄⁻), bis(oxalate) borate (BOB⁻), dicyanamide (C₂N₃⁻), nitrate (NO₃⁻), acetate (CH₃CO₂⁻), chloride (Cl⁻), bromide (Br⁻), and iodide (I⁻).

In some embodiments, the lithium salt is selected from the group consisting of LiTFSI, LiTF, LIFSI, LiBF₄, LiPF₆, LiBETI, LiDCMI, LiFNF, LiCIO₄, LiSO₄, LiBOB, LiC₂N₃, LiNO₃, LiCO₂CH₃, LiCl, LiBr, and LiI. In some embodiments, the lithium salt is LiTFSI. In some embodiments, the at least one lithium salt comprises LiTFSI and LiTF.

In some embodiments, the molal concentration (mol/kg) of the lithium salt in water is between about 1 and about 30, about 1 and about 25, about 1 and about 20, about 1 and 22, about 1 and about 21, about 1 and about 15, about 1 and about 10, about 1 and about 5, about 5 and about 30, about 5 and about 25, about 5 and about 22, about 5 and about 21, about 5 and about 20, about 5 and about 15, about 5 and about 10, about 10 and about 30, about 10 and about 25, about 10 and about 22, about 10 and about 21, about 10 and about 20, about 10 and about 15, about 15 and about 30, about 15 and about 25, about 15 and about 22, about 15 and about 21, about 15 and about 20, about 20 and about 30, about 20 and about 25, about 20 and about 22, about 20 and about 21, about 21 and about 30, about 21 and about 25, about 21 and about 22, about 22 and about 30, about 22 and about 25, or about 25 and about 30. In some embodiments, the molal concentration of the lithium salt in water is between about 1 and about 30. In some embodiments, the molal concentration of the lithium salt in water is about 20 and about 25. In some embodiments, the molal concentration of the lithium salt in water is about 21. In some embodiments, the molal concentration of the lithium salt in water is about 22.

In some embodiments, the at least one lithium salt and water are combined at a temperature of between about 0° C. and about 100° C., about 0° C. and about 80° C., about 0° C. and about 60° C., about 0° C. and about 40° C., about 0° C. and about 20° C., about 20° C. and about 100° C., about 20° C. and about 80° C., about 20° C. and about 60° C., about 20° C. and about 40° C., about 40° C. and about 100° C., about 40° C. and about 80° C., about 40° C. and about 60° C., about 40° C. and about 100° C., about 40° C. and about 80° C., about 40° C. and about 60° C., about 60° C. and about 100° C., about 60° C. and about 80° C., or between about 80° C. and about 100° C. In some embodiments, the at least one lithium salt is added to water at a temperature of between about 20° C. and about 40° C.

### Ionic Liquid

In some embodiments, the electrolyte further comprises an ionic liquid. In some embodiments, the electrolyte further comprises one, two, three, four, or five ionic liquids. In some embodiments, the electrolyte comprises one ionic liquid.

In some embodiments, the ionic liquid is a ionic liquid at room-temperature.

In some embodiments, the ionic liquid comprises the cation imidazolium, pyrrolidinium, pyridinium, phosphonium, ammonium, guanidinium, piperidinium, or sulfonium. In some embodiments, the imidazolium cation is a 1,3-dialkyl imidazolium or 1,2,3-trialkyl imidazolium. In some embodiments, the pyrrolidinium cation is a N,N-dialkyl pyrrolidium or N-methoxyethyl N-methyl pyrrolidium. In some embodiments, the N,N-dialkyl pyrrolidium is 1-methyl-1-propylpyrrolidinium (Pyr_{1,3}). In some embodiments, the pyridinium cation is N-alkyl pyridinium. In some embodiments, the phosphonium cation is tetraalkyl phosphonium. In some embodiments, the ammonium cation is N,N,N-trialkyl-N-(2-methoxyethyl) ammonium or tetraalkyl ammonium. In some embodiments, the guanidinium cation is N,N,N′,N′,N″,N″-hexaalkyl guanidinium. In some embodiments, the piperidinium cation is N,N-dialkyl piperidinium. In some embodiments, the sulfonium cation is trialkyl sulfonium. In some embodiments, the trialkyl sulfonium is triethylsulfonium (S_{2,2,2}).

In some embodiments, the ionic liquid comprises the anion bis(trifluoromethane sulfonyl)imide (TFSI⁻), trifluoromethane sulfonate (TF⁻), bis(fluorosulfonyl) imide (FSI⁻), tetrafluorophosphate (BF₄⁻), hexafluorophosphate (PF₆⁻), bis(perfluoroethyl sulfonyl)imide (BETI⁻), 4,5-dicyano-2-trifluoromethanoimidazole (DCMI⁻), [fluoro (nonafluorobutane) sulfonyl]imide (FNF⁻), perchlorate (ClO₄⁻), sulfate (SO₄⁻), bis(oxalate) borate (BOB⁻), dicyanamide (C₂N₃⁻), nitrate (NO₃⁻), acetate (CH₃CO₂⁻), chloride (Cl⁻), bromide (Br⁻), or iodide (I⁻).

In some embodiments, the ionic liquid comprises an imidazolium salt. In some embodiments, the ionic liquid comprises an imidazolium salt selected from the group consisting of 1-ethyl-3-methylimidazolium chloride, 1-ethyl-3-methylimidazolium bromide, 1-ethyl-3-methylimidazolium iodide, 1-ethyl-3-methylimidazolium hexafluorophosphate, 1-ethyl-3-methylimidazolium tetrafluoroborate, 1-ethyl-3-methylimidazolium dicyanamide, 1-ethyl-3-methylimidazolium ethyl sulfate, 1-ethyl-3-methylimidazolium hydrogen sulfate, 1-ethyl-3-methylimidazolium trifluoro (trifluoromethyl) borate, 1-ethyl-3-methylimidazolium trifluoromethane sulfonate, 1-ethyl-3-methylimidazolium methane sulfonate, 1-butyl-3-methylimidazolium chloride, 1,3-dimethylimidazolium chloride dimethyl phosphate, 1-butyl-3-methylimidazolium bromide, 1-butyl-3-methylimidazolium chloride 1-butyl-3-methylimidazolium tetrafluoroborate, 1-butyl-3-methylimidazolium hexafluorophosphate, 1-butyl-3-methylimidazolium trifluoromethanesulfonate, 1-butyl-2,3-dimethylimidazolium chloride, 1-butyl-2,3-dimethylimidazolium hexafluorophosphate, 1-butyl-2,3-dimethylimidazolium tetrafluoroborate, 1-butyl-3-methylimidazolium bis(trifluoromethanesulfonyl) imide, 1-butyl-3-methylimidazolium tetrachloroferrate, 1-butyl-3-methylimidazolium iodide, 1-butyl-2,3-dimethylimidazolium bis(trifluoromethanesulfonyl) imide, 1-butyl-3-methylimidazolium trifluoro (trifluoromethyl) borate, 1-butyl-3-methylimidazolium tribromide, 1-butyl-3-methylimidazolium thiocyanate, 1-butyl-2,3-dimethylimidazolium trifluoromethanesulfonate, 1,3-dimethylimidazolium dimethyl phosphate, 1,3-dimethylimidazolium chloride, 1,2-dimethyl-3-propylimidazolium iodide, 2,3-dimethyl-1-propylimidazolium bis(trifluoromethanesulfonyl)imide, 1-decyl-3-methylimidazolium bis(trifluoromethanesulfonyl) imide, 1,3-dimethylimidazolium iodide, 1-hexyl-3-methylimidazolium chloride, 1-hexyl-3-methylimidazolium hexafluorophosphate, 1-hexyl-3-methylimidazolium tetrafluoroborate, 1-hexyl-3-methylimidazolium trifluoromethanesulfonate, 1-hexyl-3-methylimidazolium bromide, 1-hexyl-2,3-dimethylimidazolium iodide, 1-hexyl-3-methylimidazolium bis(trifluoromethanesulfonyl) imide, 1-(2-hydroxyethyl)-3-methylimidazolium tetrafluoroborate, 1-methyl-3-propylimidazolium iodide, 1-methyl-3-n-octylimidazolium bromide, 1-methyl-3-n-octylimidazolium chloride, 1-methyl-3-n-octylimidazolium hexafluorophosphate, 1-methyl-3-n-octylimidazolium trifluoromethanesulfonate, and 1-methyl-3-n-octylimidazolium tetrafluoroborate.

In some embodiments, the ionic liquid comprises a pyrrolidinium salt. In some embodiments, the ionic liquid comprises a pyrrolidinium salt selected from the group consisting of 1-butyl-1-methylpyrrolidinium bis(trifluoromethanesulfonyl) imide, 1-butyl-1-methylpyrrolidinium chloride, 1-butyl-1-methylpyrrolidinium bromide, 1-ethyl-1-methylpyrrolidinium tetrafluoroborate, 1-ethyl-1-methylpyrrolidinium bromide, and 1-methyl-1-propylpyrrolidinium bis(trifluoromethanesulfonyl) imide ([Pyr_{1,3}] [TFSI]).

In some embodiments, the ionic liquid comprises a piperidinium salt. In some embodiments, the ionic liquid comprises a piperidinium salt selected from the group consisting of 1-butyl-1-methylpiperidinium bromide, 1-butyl-1-methylpiperidinium bis(trifluoromethanesulfonyl) imide, and 1-methyl-1-propylpiperidinium bromide.

In some embodiments, the ionic liquid comprises a pyridinium salt. In some embodiments, the ionic liquid comprises a pyridinium salt selected from the group consisting of 1-butylpyridinium chloride, 1-butylpyridinium bromide, 1-butylpyridinium hexafluorophosphate, 1-butyl-4-methylpyridinium bromide, 1-butyl-4-methylpyridinium hexafluorophosphate, 1-butyl-3-methylpyridinium bromide, 1-butylpyridinium tetrafluoroborate, 1-butyl-3-methylpyridinium chloride, 1-butyl-4-methylpyridinium chloride, 1-ethylpyridinium bromide, 1-ethylpyridinium chloride, 1-ethyl-3-methylpyridinium ethyl sulfate, 1-ethyl-3-(hydroxymethyl)pyridinium ethyl sulfate, 1-ethyl-3-methylpyridinium bis(trifluoromethanesulfonyl) imide, 1-hexylpyridinium hexafluorophosphate, and 1-propylpyridinium chloride.

In some embodiments, the ionic liquid comprises an ammonium salt. In some embodiments, the ionic liquid comprises an ammonium salt selected from the group consisting of amyltricthylammonium bis(trifluoromethanesulfonyl) imide, cyclohexyltrimethylammonium bis(trifluoromethanesulfonyl) imide, methyltri-n-octylammonium bis(trifluoromethanesulfonyl) imide, tetrabutylammonium bromide, tetrabutylammonium chloride, tetrabutylammonium iodide, tetrabutylammonium tetrafluoroborate, tetrahexylammonium iodide, tetraamylammonium iodide, tetra-n-octylammonium iodide, tetrabutylammonium hexafluorophosphate, tetraheptylammonium iodide, tetraamylammonium bromide, tetraamylammonium chloride, tetrabutylammonium trifluoromethanesulfonate, tetrahexylammonium bromide, tetraheptylammonium bromide, tetra-n-octylammonium bromide, tetrapropylammonium chloride, tributylmethylammonium bis(trifluoromethanesulfonyl) imide, tetrabutylammonium acetate, and trimethylpropylammonium bis(trifluoromethanesulfonyl) imide.

In some embodiments, the ionic liquid comprises a phosphonium salt. In some embodiments, the ionic liquid comprises a phosphonium salt selected from the group consisting of tributylhexadecylphosphonium bromide, tributylmethylphosphonium iodide, tributyl-n-octylphosphonium bromide, tetrabutylphosphonium bromide, tetra-n-octylphosphonium bromide, tetrabutylphosphonium tetrafluoroborate, tetrabutylphosphonium hexafluorophosphate, tributyl(2-methoxyethyl)phosphonium bis(trifluoromethanesulfonyl) imide, and tributylmethylphosphonium bis(trifluoromethanesulfonyl) imide.

In some embodiments, the ionic liquid comprises a sulfonium salt. In some embodiments, the ionic liquid comprises a sulfonium salt selected from the group consisting of trimethylsulfonium iodide, tributylsulfonium iodide, and triethylsulfonium bis(trifluoromethanesulfonyl) imide ([S_{2,2,2}] [TFSI]).

In some embodiments, the at least one lithium salt, at least one ionic liquid, and water are combined at a temperature of between about 0° C. and about 100° C., about 0° C. and about 80° C., about 0° C. and about 60° C., about 0° C. and about 40° C., about 0° C. and about 20° C., about 20° C. and about 100° C., about 20° C. and about 80° C., about 20° C. and about 60° C., about 20° C. and about 40° C., about 40° C. and about 100° C., about 40° C. and about 80° C., about 40° C. and about 60° C., about 40° C. and about 100° C., about 40° C. and about 80° C., about 40° C. and about 60° C., about 60° C. and about 100° C., about 60° C. and about 80° C., or between about 80° C. and about 100° C. In some embodiments, the at least one lithium salt, at least one ionic liquid, and water are combined at a temperature of between about 20° C. and about 40° C.

In some embodiments, the molar ratio of the at least one polymer to the at least one ionic liquid is from about 1:1 to about 100:1. In some embodiments, the molar ratio of the at least one polymer to the at least one ionic liquid is from about 1:1 to about 2:1, from about 1:1 to about 3:1, from about 1:1 to about 4:1, from about 1:1 to about 5:1, from about 1:1 to about 6:1, from about 1:1 to about 7:1, from about 1:1 to about 8:1, from about 1:1 to about 9:1, from about 1:1 to about 10:1, from about 1:1 to about 12:1, from about 1:1 to about 14:1, from about 1:1 to about 15:1, from about 1:1 to about 20:1, or from about 1:1 to about 50:1.

In some embodiments, the molar ratio of the at least one polymer to the at least one ionic liquid is about 14:1. In some embodiments, the molar ratio of the at least one polymer to the at least one ionic liquid is about 1:1, about 3:2, about 2:1, about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 21:1, about 20:1, about 30:1, about 40:1 or about 50:1.

In some embodiments, the molar ratio of the at least one ionic liquid to water is from about 1:2 to about 1:60. In some embodiments, the molar ratio of the at least one ionic liquid to water is from about 2:1 to about 1:1, from about 1:1 to about 1:2, from about 1:1 to about 1:10, from about 1:1 to about 1:20, from about 1:1 to about 1:30, from about 1:1 to about 1:40, from about 1:1 to about 1:50, from about 1:1 to about 1:60, from about 1:5 to about 1:10, from about 1:5 to about 1:20, from about 1:5 to about 1:30, from about 1:5 to about 1:40, from about 1:5 to about 1:50, from about 1:5 to about 1:60, from about 1:10 to about 1:20, from about 1:10 to about 1:30, from about 1:10 to about 1:40, from about 1:10 to about 1:50, from about 1:10 to about 1:60, from about about 1:20 to about 1:30, from about 1:20 to about 1:40, from about 1:20 to about 1:50, or from about 1:20 to about 1:60.

In some embodiments, the molar ratio of the at least one ionic liquid to water is about 1:15. In some embodiments, the molar ratio of the at least one ionic liquid to water is about 1:1, about 1:2, about 1:3, about 1:4, about 1:5, about 1:6, about 1:7, about 1:8, about 1:9, about 1:10, about 1:15, about 1:20, about 1:25, about 1:50, or about 1:60.

In some embodiments, the molality of the lithium salt and ionic liquid to water is from about 10 mol/kg to about 60 mol/kg. In some embodiments, the molality of the lithium salt and ionic liquid to water is from about 1 mol/kg to about 5 mol/kg, from about 1 mol/kg to about 10 mol/kg, from about 1 mol/kg to about 15 mol/kg, from about 1 mol/kg to about 20 mol/kg, from about 1 mol/kg to about 25 mol/kg, from about 1 mol/kg to about 30 mol/kg, from about 1 mol/kg to about 40 mol/kg, from about 1 mol/kg to about 50 mol/kg, from about 1 mol/kg to about 60 mol/kg, from about 5 mol/kg to about 10 mol/kg, from about 5 mol/kg to about 15 mol/kg, from about 5 mol/kg to about 20 mol/kg, from about 5 mol/kg to about 25 mol/kg, from about 5 mol/kg to about 30 mol/kg, from about 5 mol/kg to about 40 mol/kg, from about 5 mol/kg to about 50 mol/kg, from about 5 mol/kg to about 60 mol/kg, from about 10 mol/kg to about 15 mol/kg, from about 10 mol/kg to about 20 mol/kg, from about 10 mol/kg to about 25 mol/kg, from about 10 mol/kg to about 30 mol/kg, from about 10 mol/kg to about 40 mol/kg, from about 10 mol/kg to about 50 mol/kg, from about 10 mol/kg to about 60 mol/kg, from about 15 mol/kg to about 20 mol/kg, from about 15 mol/kg to about 25 mol/kg, from about 15 mol/kg to about 30 mol/kg, from about 15 mol/kg to about 40 mol/kg, from about 15 mol/kg to about 50 mol/kg, from about 15 mol/kg to about 60 mol/kg, from about 20 mol/kg to about 25 mol/kg, from about 20 mol/kg to about 30 mol/kg, from about 20 mol/kg to about 40 mol/kg, from about 20 mol/kg to about 50 mol/kg, from about 20 mol/kg to about 60 mol/kg, from about 25 mol/kg to about 30 mol/kg, from about 25 mol/kg to about 40 mol/kg, from about 25 mol/kg to about 50 mol/kg, from about 25 mol/kg to about 60 mol/kg, from about 30 mol/kg to about 40 mol/kg, from about 30 mol/kg to about 50 mol/kg, from about 30 mol/kg to about 60 mol/kg, from about 40 mol/kg to about 50 mol/kg, from about 40 mol/kg to about 60 mol/kg, or from about 50 mol/kg to about 60 mol/kg.

In some embodiments, the molality of the lithium salt and ionic liquid to water is about 30 mol/kg. In some embodiments, the molality of the lithium salt and ionic liquid to water is about 1 mol/kg, about 5 mol/kg, about 10 mol/kg, about 15 mol/kg, about 20 mol/kg, about 25 mol/kg, about 30 mol/kg, about 35 mol/kg, about 40 mol/kg, about 45 mol/kg, about 50 mol/kg, about 55 mol/kg, or about 60 mol/kg.

### Polymer

In some embodiments, the electrolyte comprises one, two, three, four, or five polymers. In some embodiments, the electrolyte comprises between 1 and 5, 1 and 4, 1 and 3, 1 and 2, 2 and 5, 2 and 4, 2 and 3, 3 and 5, 3 and 4, or 4 and 5 polymers. In some embodiments, the electrolyte comprises one polymer.

In some embodiments, the at least one polymer comprises polyethylene oxide (PEO), polyacrylonitrile (PAN), polyvinylidene fluoride (PVdf), poly(methyl acrylate) (PMA), poly(methyl methacrylate) (PMMA), poly(oxymethylene) (POM), or polystyrene (PS).

In some embodiments, the weight averaged molecular weight (M_{w}) of the at least one polymer is between about 100,000 g/mol and about 20,000,000 g/mol. In some embodiments, the molecular weight (M_{w}) of the at least one polymer is between about 100,000 g/mol and about 20,000,000 g/ml, about 100,000 g/mol and about 10,000,000 g/mol, about 100,000 g/mol and about 5,000,000 g/mol, about 100,000 g/mol and about 1,000,000 g/mol, about 100,000 g/mol and about 500,000 g/mol, 100,000 g/mol and 250,000 g/mol, about 250,000 g/mol and about 20,000,000 g/ml, about 250,000 g/mol and about 10,000,000 g/mol, about 250,000 g/mol and about 5,000,000 g/mol, about 250,000 g/mol and about 1,000,000 g/mol, about 250,000 g/mol and about 500,000 g/mol, about 500,000 g/mol and about 20,000,000 g/ml, about 500,000 g/mol and about 10,000,000 g/mol, about 500,000 g/mol and about 5,000,000 g/mol, about 500,000 g/mol and about 1,000,000 g/mol, about 1,000,000 g/mol and about 20,000,000 g/ml, about 1,000,000 g/mol and about 10,000,000 g/mol, about 1,000,000 g/mol and about 5,000,000 g/mol, about 5,000,000 g/mol and about 20,000,000 g/ml, about 5,000,000 g/mol and about 10,000,000 g/mol, or about 10,000,000 g/mol and about 20,000,000 g/ml. In some embodiments, the molecular weight (M_{w}) of the at least one polymer is about 100,000 g/mol and about 4,000,000. In some embodiments, the molecular weight (M_{w}) of the at least one polymer is about 100,000 g/mol. In some embodiments, the molecular weight (M_{w}) of the at least one polymer is about 1,000,000 g/mol. In some embodiments, the molecular weight (M_{w}) of the at least one polymer is about 4,000,000 g/mol.

In some embodiments, the at least one polymer comprises a copolymer. A copolymer refers to a polymer comprising more than one type of polymer. In some embodiments, the copolymer comprises at least one first polymer block and at least one second polymer block. In some embodiments, the copolymer is a block copolymer.

In some embodiments, the block copolymer comprises at least two polymer blocks (i.e., a first polymer block and a second polymer block) that are substantially immiscible in one another. In some embodiments, the block copolymer comprises a first polymer block and a second polymer block with a number average molecular weight ratio in a range of from about 5:95 to about 95:5, from about 5:95 to about 90:10, from about 5:95 to about 80:20, from about 5:95 to about 70:30, from about 5:95 to about 60:40, from about 5:95 to about 50:50, from about 5:95 to about 40:60, from about 5:95 to about 30:70, from about 5:95 to about 20:80, from about 5:95 to about 10:90, from about 10:90 to about 95:5, from about 10:90 to about 90:10, from about 10:90 to about 80:20, from about 10:90 to about 70:30, from about 10:90 to about 60:40, from about 10:90 to about 50:50, from about 10:90 to about 40:60, from about 10:90 to about 30:70, from about 10:90 to about 20:80, from about 20:80 to about 95:5, from about 20:80 to about 90:10, from about 20:80 to about 80:20, from about 20:80 to about 70:30, from about 20:80 to about 60:40, from about 20:80 to about 50:50, from about 20:80 to about 40:60, from about 20:80 to about 30:70, from about 30:70 to about 95:5, from about 30:70 to about 90:10, from about 30:70 to about 80:20, from about 30:70 to about 70:30, from about 30:70 to about 60:40, from about 30:70 to about 50:50, from about 30:70 to about 40:60, from about 40:60 to about 95:5, from about 40:60 to about 90:10, from about 40:60 to about 80:20, from about 40:60 to about 70:30, from about 40:60 to about 60:40, from about 40:60 to about 50:50, from about 50:50 to about 95:5, from about 50:50 to about 90:10, from about 50:50 to about 80:20, from about 50:50 to about 70:30, from about 50:50 to about 60:40, from about 60:40 to about 95:5, from about 60:40 to about 90:10, from about 60:40 to about 80:20, from about 60:40 to about 70:30, from about 70:30 to about 95:5, from about 70:30 to about 90:10, from about 70:30 to about 80:20, from about 80:20 to about 95:5, from about 80:20 to about 90:10, or from about 90:10 to about 95:5.

In some embodiments, the mass ratio of the polymer to the at least one lithium salt is between about 1:107 to about 107:1. In some embodiments, the mass ratio of the polymer to the at least one lithium salt in the electrolyte is between about 1:107 to about 107:1, about 1:107 to about 106:1, about 1:107 to about 105:1, about 1:107 to about 104:1, about 1:107 to about 1,000:1, about 1:107 to about 100:1, about 1:107 to about 10:1, about 1:107 to about 1:1, about 1:106 to about 107:1, about 1:106 to about 106:1, about 1:106 to about 105:1, about 1:106 to about 104:1, about 1:106 to about 1,000:1, about 1:106 to about 100:1, about 1:106 to about 10:1, about 1:106 to about 1:1, about 1:105 to about 107:1, about 1:105 to about 106:1, about 1:105 to about 105:1, about 1:105 to about 104:1, about 1:105 to about 1,000:1, about 1:105 to about 100:1, about 1:105 to about 10:1, about 1:105 to about 1:1, 1:104 to about 107:1, about 1:104 to about 106:1, about 1:104 to about 105:1, about 1:104 to about 104:1, about 1:104 to about 1,000:1, about 1:104 to about 100:1, about 1:104 to about 10:1, about 1:104 to about 1:1, 1:103 to about 107:1, about 1:103 to about 106:1, about 1:103 to about 105:1, about 1:103 to about 104:1, about 1:103 to about 1,000:1, about 1:103 to about 100:1, about 1:103 to about 10:1, about 1:103 to about 1:1, 1:100 to about 107:1, about 1:100 to about 106:1, about 1:100 to about 105:1, about 1:100 to about 104:1, about 1:100 to about 1,000:1, about 1:100 to about 100:1, about 1:100 to about 10:1, about 1:100 to about 1:1, 1:10 to about 107:1, about 1:10 to about 106:1, about 1:10 to about 105:1, about 1:10 to about 104:1, about 1:10 to about 1,000:1, about 1:10 to about 100:1, about 1:10 to about 10:1, about 1:10 to about 1:1, 1:1 to about 107:1, about 1:1 to about 106:1, about 1:1 to about 105:1, about 1:1 to about 104:1, about 1:1 to about 1,000:1, about 1:1 to about 100:1, or about 1:1 to about 10:1.

In some embodiments, the molar ratio of the at least one polymer to the at least one lithium salt is from about 1:10 to about 20:1. In some embodiments, the molar ratio of the at least one polymer to the at least one lithium salt is from about 1:5 to about 20:1, from about 1:1 to about 20:1, from about 1:1 to about 15:1, from about 1:1 to about 10:1, from about 1:1 to about 7:1, from about 1:1 to about 5:1, from about 1:1 to about 3:1, from about 5:1 to about 20:1, from about 5:1 to about 15:1, from about 5:1 to about 10:1, or from about 5:1 to about 7:1.

In some embodiments, the molar ratio of the at least one polymer to the at least one lithium salt is about 1:1. In some embodiments, the molar ratio of the at least one polymer to the at least one lithium salt is about 1:2, about 1:1, about 2:1, about 3:1, about 4:1, about 5:1, about 6:1, about 7:1, about 8:1, about 9:1, about 10:1, about 11:1, about 12:1, about 15:1, or about 20:1.

In some embodiments, the electrolyte comprises at least one lithium salt, at least one ionic liquid, and at least one polymer. In some embodiments, the mass ratio of the polymer to the at least one lithium salt and at least one ionic liquid in the electrolyte is between about 1:107 to about 107:1. In some embodiments, the mass ratio of the polymer to the at least one lithium salt is between about 1:107 to about 107:1, about 1:107 to about 106:1, about 1:107 to about 105:1, about 1:107 to about 104:1, about 1:107 to about 1,000:1, about 1:107 to about 100:1, about 1:107 to about 10:1, about 1:107 to about 1:1, about 1:106 to about 107:1, about 1:106 to about 106:1, about 1:106 to about 105:1, about 1:106 to about 104:1, about 1:106 to about 1,000:1, about 1:106 to about 100:1, about 1:106 to about 10:1, about 1:106 to about 1:1, about 1:105 to about 107:1, about 1:105 to about 106:1, about 1:105 to about 105:1, about 1:105 to about 104:1, about 1:105 to about 1,000:1, about 1:105 to about 100:1, about 1:105 to about 10:1, about 1:105 to about 1:1, 1:104 to about 107:1, about 1:104 to about 106:1, about 1:104 to about 105:1, about 1:104 to about 104:1, about 1:104 to about 1,000:1, about 1:104 to about 100:1, about 1:104 to about 10:1, about 1:104 to about 1:1, 1:103 to about 107:1, about 1:103 to about 106:1, about 1:103 to about 105:1, about 1:103 to about 104:1, about 1:103 to about 1,000:1, about 1:103 to about 100:1, about 1:103 to about 10:1, about 1:103 to about 1:1, 1:100 to about 107:1, about 1:100 to about 106:1, about 1:100 to about 105:1, about 1:100 to about 104:1, about 1:100 to about 1,000:1, about 1:100 to about 100:1, about 1:100 to about 10:1, about 1:100 to about 1:1, 1:10 to about 107:1, about 1:10 to about 106:1, about 1:10 to about 105:1, about 1:10 to about 104:1, about 1:10 to about 1,000:1, about 1:10 to about 100:1, about 1:10 to about 10:1, about 1:10 to about 1:1, 1:1 to about 107:1, about 1:1 to about 106:1, about 1:1 to about 105:1, about 1:1 to about 104:1, about 1:1 to about 1,000:1, about 1:1 to about 100:1, or about 1:1 to about 10:1.

In some embodiments, the molar ratio of the at least one polymer to water is from about 1:1 to about 1:6. In some embodiments, the molar ratio of the at least one polymer to water is from about 5:1 to about 1:1, about 2:1 to about 1:1, about 2:1 to about 1:2, about 2:1 to about 1:3, about 2:1 to about 1:4, about 2:1 to about 1:5, about 2:1 to about 1:6, about 1:1 to about 1:2, about 1:1 to about 1:3, about 1:1 to about 1:4, about 1:1 to about 1:5, or about 1:1 to about 1:6.

In some embodiments, the molar ratio of the at least one polymer to water is about 1:2. In some embodiments, the molar ratio of the at least one polymer to water is about 2:1, about 1:1, about 1:3, about 1:4, about 1:5, about 1:6, about 1:7, or about 1:8.

In some embodiments, the aqueous polymer electrolyte further comprises a small plasticizing molecule. In some embodiments, the small plasticizing molecule is used to enhance conductivity and stability without adversely harming the mechanical properties of the aqueous polymer electrolyte. In some embodiments, the aqueous polymer electrolyte further comprises a small plasticizing molecule selected from the group consisting of monoglyme (dimethoxyethane), diglyme (bis(2-methoxyethyl) ether), triglyme, tetraglyme, or a crown ether.

In some embodiments, the at least one lithium salt, at least one polymer, and water are combined at a temperature of between about 0° C. and about 100° C., about 0° C. and about 80° C., about 0° C. and about 60° C., about 0° C. and about 40° C., about 0° C. and about 20° C., about 20° C. and about 100° C., about 20° C. and about 80° C., about 20° C. and about 60° C., about 20° C. and about 40° C., about 40° C. and about 100° C., about 40° C. and about 80° C., about 40° C. and about 60° C., about 40° C. and about 100° C., about 40° C. and about 80° C., about 40° C. and about 60° C., about 60° C. and about 100° C., about 60° C. and about 80° C., or between about 80° C. and about 100° C. In some embodiments, the at least one lithium salt, at least one polymer, and water are combined at a temperature of between about 20° C. and about 40° C.

The present invention describes a method of preparing an electrolyte, comprising:
(a) admixing at least one lithium salt in water, at least one polymer, and, optionally, at least one ionic liquid;
(b) pressing the admixture of (a) at a temperature between about 30° C. and about 150° C. and at a pressure between about 0.2 metric tons and about 2 metric tons.

In some embodiments, the at least one lithium salt, at least one polymer, and optionally, at least one ionic liquid, are mixed with water with a mortar and pestle until a tacky solid mixture is formed. In some embodiments, the aqueous mixture is placed in a pouch and pressed at an elevated temperature with pressure for a period of time. In some embodiments, the aqueous mixture is pressed at an elevated temperature of between about 30° C. and about 150° C., about 30° C. and about 100° C., about 30° C. and about 80° C., about 30° C. and about 60° C., about 60° C. and about 150° C., about 60° C. and about 100° C., about 60° C. and about 80° C., about 80° C. and about 150° C., about 80° C. and about 100° C., or about 100° C. and about 150° C. In some embodiments, the aqueous mixture is pressed at a pressure between about 0.2 metric ton and about 2 metric tons, about 0.2 metric ton and about 1.5 metric ton, about 0.2 metric ton and about 1 metric ton, about 0.2 metric ton and about 0.5 metric ton, about 0.5 metric ton and about 2 metric tons, about 0.5 metric ton and about 1.5 metric ton, about 0.5 metric ton and about 1 metric ton, about 1 metric ton and about 2 metric tons, about 1 metric ton and about 1.5 metric ton, or about 1.5 metric ton and about 2 metric tons. In some embodiments, the aqueous mixture is pressed at a time between about 0.5 minute and about 30 minutes, about 0.5 minute and about 20 minutes, about 0.5 minute and about 10 minutes, about 0.5 minute and about 5 minutes, about 0.5 minute and about 2 minutes, about 0.5 minute and about 1 minutes, about 1 minute and about 30 minutes, about 1 minute and about 20 minutes, about 1 minute and about 10 minutes, about 1 minute and about 5 minutes, about 1 minute and about 2 minutes, about 2 minutes and about 30 minutes, about 2 minutes and about 20 minutes, about 2 minutes and about 10 minutes, about 2 minutes and about 5 minutes, about 5 minutes and about 30 minutes, about 5 minutes and about 20 minutes, about 5 minutes and about 10 minutes, about 10 minutes and about 30 minutes, about 10 minutes and about 20 minutes, or about 20 minutes and about 30 minutes.

In some embodiments, the electrolyte is a thin film having a thickness between about 50 μm and about 300 μm. In some embodiments, the electrolyte is a thin film having a thickness between about 50 μm and about 300 μm, about 50 μm and about 250 μm, about 50 μm and about 200 μm, about 50 μm and about 150 μm, about 50 μm and about 100 μm, about 100 μm and about 300 μm, about 100 μm and about 250 μm, about 100 μm and about 200 μm, about 100 μm and about 150 μm, about 150 μm and about 300 μm, about 150 μm and about 250 μm, about 150 μm and about 200 μm, about 200 μm and about 300 μm, about 200 μm and about 250 μm, or about 250 μm and about 300 μm. In some embodiments, the electrolyte is a thin film having a thickness between about 100 μm and about 200 μm.

In some embodiments, the at least one lithium salt, at least one polymer, and optionally, at least one ionic liquid, are mixed with water and an organic solvent and solution cast as a film onto a substrate. In some embodiments, the organic solvent is selected from the group consisting of 2-methyltetrahydrofuran (2-MeTHF), tetrahydrofuran (THF), 4-methyldioxolane (4-MeDIOX), tetrahydropyran (THP), 1,3-dioxolane (DIOX))glymes, 1,2-dimethoxyethane (DME/mono-glyme), propylene carbonate (PC), ethylene carbonate (EC), dimethyl carbonate (DMC), ethylmethyl carbonate (EMC), fluoroethylene carbonate (FEC), vinylene carbonate (VC), diethyl carbonate (DEC), methyl formate, dimethyl formamide, (DMF), and γ-butyrolactone (GBL). In some embodiments, the organic solvent is THF or DMF.

### Properties of the Aqueous Solid Polymer Electrolytes

The conductivity of an electrolyte is its ability to pass an electric current. How well an electrolyte conducts electricity depends on concentration, mobility of ions, valence of ions, and temperature. The conductivity of an electrolyte can be measured by alternating current (AC) impedance measurements by applying an alternating electrical current to two electrodes immersed in a solution and measuring the resulting voltage.

In some embodiments, the aqueous polymer electrolyte has a high ionic conductivity. In some embodiments, the ionic conductivity of the aqueous polymer electrolyte at 25° C. is at least 1 mS/cm. In some embodiments, the ionic conductivity of the aqueous polymer electrolyte at 25° C. is between about 1 mS/cm and about 10 mS/cm, about 1 mS/cm and about 8 mS/cm, about 1 mS/cm and about 6 mS/cm, about 1 mS/cm and about 4 mS/cm, about 1 mS/cm and about 2 mS/cm, about 2 mS/cm and about 10 mS/cm, about 2 mS/cm and about 8 mS/cm, about 2 mS/cm and about 6 mS/cm, about 2 mS/cm and about 4 mS/cm, about 4 mS/cm and about 10 mS/cm, about 4 mS/cm and about 8 mS/cm, about 4 mS/cm and about 6 mS/cm, about 6 mS/cm and about 10 mS/cm, about 6 mS/cm and about 8 mS/cm, or about 8 mS/cm and about 10 mS/cm. In some embodiments, the ionic conductivity of the aqueous polymer electrolyte at 25° C. is between about 1 mS/cm and about 4 mS/cm.

The electrochemical stability window of a substance is the voltage range at which the substance is neither oxidized nor reduced. The electrochemical stability window is calculated by subtracting the reduction potential (cathodic limit) from the oxidation potential (anodic limit).

Pure water has an electrochemical stability window of 1.23 V.

The electrochemical stability window for an aqueous polymer electrolyte can be measured using cyclic voltammetry (CV).

In some embodiments, the aqueous polymer electrolyte has an electrochemical stability window of between about 0.75 V and about 7 V, about 0.75 V and about 6 V, about 0.75 V and about 5.5 V, about 0.75 V and about 5 V, about 0.75 V and about 4 V, about 0.75 V and about 3 V, about 0.75 V and about 2 V, about 2 V and about 7 V, about 2 V and about 6 V, about 2 V and about 5.5 V, about 2 V and about 5 V, about 2 V and about 4 V, about 2 V and about 3 V, about 3 V and about 7 V, about 3 V and about 6 V, about 3 V and about 5.5 V, about 3 V and about 5 V, about 3 V and about 4 V, about 4 V and about 7 V, about 4 V and about 6 V, about 4 V and about 5.5 V, about 4 V and about 5 V, about 5 V and about 6.5 V, about 5 V and about 6 V, about 5 V and about 5.5 V, about 5.5 V and about 7 V, about 5.5 V and about 6 V, or about 6 V and about 7 V. In some embodiments, the aqueous polymer electrolyte has an electrochemical stability window of between about 5.5 V and about 6.0 V. In some embodiments, the aqueous polymer electrolyte has an electrochemical stability window of between about 5.5 V and about 6.5 V.

### Electrochemical Devices

In some embodiments, the aqueous polymer electrolyte can be used to fabricate electrochemical devices. In some embodiments, the aqueous polymer electrolytes can be used in diversified battery chemistries, such as Li-ion chemistries of high voltage and high capacity. In some embodiments, the aqueous and hybrid electrolytes can be used in beyond Li-ion chemistries such as Li/oxygen, sulfur-based cathode materials and intercalation- or conversion-reaction type materials that include sodium, magnesium, or calcium as energy storage species.

In some embodiments, the aqueous polymer electrolytes are used to prepare an electrochemical cell. In some embodiments, the electrochemical cell comprises an anode and a cathode. In some embodiments, the electrochemical cell comprises an anode, a cathode, and a separator. In some embodiments, the electrochemical cell is a battery.

The present invention describes a electrochemical cell comprising:
(a) an aqueous polymer electrolyte comprising at least one lithium salt in water and at least one polymer, wherein the molality of the at least one lithium salt to water is between about 1 and about 30;
(b) an anode; and
(c) a cathode.

The present invention also describes a electrochemical cell comprising:
(a) an aqueous polymer electrolyte comprising at least one lithium salt in water, at least one ionic liquid, and at least one polymer, wherein the molality of the at least one lithium salt to water is between about 1 and about 30;
(b) an anode; and
(c) a cathode.

In some embodiments, the anode (negative electrode) of the electrochemical cell used with the aqueous polymer electrolyte is selected from the group consisting of metals such as lithium, magnesium, aluminum, zinc, chromium, iron, nickel, tin, lead, copper, silver, palladium, mercury, platinum, gold, and combinations thereof; metal alloys; metal oxides; carbonaceous of varying degrees of graphitization; phosphates; and sulfides. In some embodiments, the anode of the electrochemical cell is selected from the group consisting of aluminum and sulfur. In some embodiments, the anode of the electrochemical cell is aluminum.

In some embodiments, the cathode (positive electrode) of the electrochemical cell used with the aqueous or hybrid electrolyte is selected from the group consisting of ferrate, iron oxide, cuprous oxide, iodate, cupric oxide, mercuric oxide, cobaltic oxide, manganese dioxide, lead oxide, oxygen, nickel oxyhydroxide, nickel dioxide, silver peroxide, permanganate, and bromate. In some embodiments, the cathode is selected from the group consisting of LiCoO₂, LiNi_{0.33}Mn_{0.33}Co_{0.33}O₂, LiNi_{0.5}Mn_{1.5}O₂, LiCoPO₄, LiNiPO₄, LiFePO₄, LiMnO₄, metal oxides, phosphates, conversion-reaction materials based on metal oxides, metal halides, and metal sulfides. In some embodiments, the cathode is LiFePO₄.

In some embodiments, the electrochemical cell includes a separator between the positive electrode and the negative electrode. In some embodiments, the separator is subjected to hydrophilic treatment or perforated such that the separator can be permeated with an aqueous electrolyte solution, allowing ions to pass through the separator. The separator may be any separator that is commonly used in batteries. Examples of the separator include polymer nonwoven fabrics, such as polypropylene nonwoven fabric and poly(phenylene sulfide) nonwoven fabric, and macroporous membranes of olefin resins, such as polyethylene and polypropylene. These can be used alone or in combination.

In some embodiments, electrochemical devices that operate using aqueous polymer electrolytes at high cell voltages are fabricated using techniques known to those of ordinary skill in the art.

In some embodiments, electrochemical devices prepared using aqueous polymer electrolytes of the invention have improved properties.

In some embodiments, battery performance can be quantified with four parameters: cell voltage, capacity, Coulombic efficiency, and cycling stability. While the first two determine the energy density, the latter two dictate the life and energy efficiency.

The “capacity retention” of a battery is a measurement of the fraction of full capacity available from a battery under a specified set of conditions, after the battery has been stored for a given amount of time.

In some embodiments, the capacity retention (in mAh/g) for a battery at a charge rate of C/3 is between about 100 mAh/g and about 150 mAh/g, about 100 mAh/g and about 140 mAh/g, about 100 mAh/g and about 130 mAh/g, about 100 mAh/g and about 120 mAh/g, about 100 mAh/g and about 110 mAh/g, about 110 mAh/g and about 150 mAh/g, about 110 mAh/g and about 140 mAh/g, about 110 mAh/g and about 130 mAh/g, about 110 mAh/g and about 120 mAh/g, about 120 mAh/g and about 150 mAh/g, about 120 mAh/g and about 140 mAh/g, about 120 mAh/g and about 130 mAh/g, about 130 mAh/g and about 150 mAh/g, about 130 mAh/g and about 140 mAh/g, or about 140 mAh/g and about 150 mAh/g. In some embodiments, the capacity retention for a battery at a charge rate of C/3 is between about 120 mAh/g and about 130 mAh/g.

In some embodiments, the Coulombic efficiency for a battery at a charge rate of C/3 is between about 60% and about 99%, about 60% and about 95%, about 60% and about 90%, about 60% and about 85%, about 60% and about 80%, about 60% and about 70%, about 70% and about 99%, about 70% and about 95%, about 70% and about 90%, about 70% and about 85%, about 70% and about 80%, about 80% and about 99%, about 80% and about 95%, about 80% and about 90%, about 80% and about 85%, about 85% and about 99%, about 85% and about 95%, about 85% and about 90%, about 90% and about 99%, about 90% and about 95%, or about 95% and about 99%. In some embodiments, the Coulombic efficiency for a battery at a charge rate of C/3 is between about 90% and about 99%.

In some embodiments, the electrochemical cell operates at a temperature of less than about 100° C., about 90° C., about 80° C., about 70° C., about 60° C., about 50° C., about 40° C., about 30° C., about 20° C., or about 10° C. In some embodiments, the electrochemical cell operates at a temperature between about −40° C. and about 100° C., about −40° C. and about 90° C., about −40° C. and about 80° C., about −40° C. and about 70° C., about −40° C. and about 60° C., about −40° C. and about 50° C., about −40° C. and about 40° C., about −40° C. and about 30° C., about −30° C. and about 100° C., about −30° C. and about 90° C., about −30° C. and about 80° C., about −30° C. and about 70° C., about −30° C. and about 60° C., about −30° C. and about 50° C., about −30° C. and about 40° C., about −30° C. and about 30° C., about −20° C. and about 100° C., about −20° C. and about 90° C., about −20° C. and about 80° C., about −20° C. and about 70° C., about −20° C. and about 60° C., about −20° C. and about 50° C., about −20° C. and about 40° C., or about −20° C. and about 30° C.

In some embodiments, the electrochemical cell has a full cell output voltage greater than 2.5 V, 2.8 V, 3 V, 3.2 V, 3.4 V, 3.6 V, 3.8 V, 4 V, 4.2 V, or 4.4 V. In some embodiments, the electrochemical cell has a full cell output voltage between 1 V and 4.5 V, 1 V and 4 V, 1 V and 3.5 V, 1 V and 3 V, 1 V and 2.5 V, 1 V and 2 V, 2 V and 4.5 V, 2 V and 4 V, 2 V and 3.5 V, 2 V and 3 V, 2 V and 2.5 V, 2.5 V and 4.5 V, 2.5 V and 4 V, 2.5 V and 3.5 V, 2.5 V and 3 V, 3 V and 4.5 V, 3 V and 4 V, 3 V and 3.5 V, 3.5 V and 4.5 V, 3.5 V and 4 V, or 4 V and 4.5 V.

### EXAMPLES

The following examples are illustrative and non-limiting, of the products and methods described herein. Suitable modifications and adaptations of the variety of conditions, formulations, and other parameters normally encountered in the field and which are obvious to those skilled in the art in view of this disclosure are within the spirit and scope of the invention.

### Example 1

### Formulation of an Air Stable Aqueous Solid Polymer Electrolyte

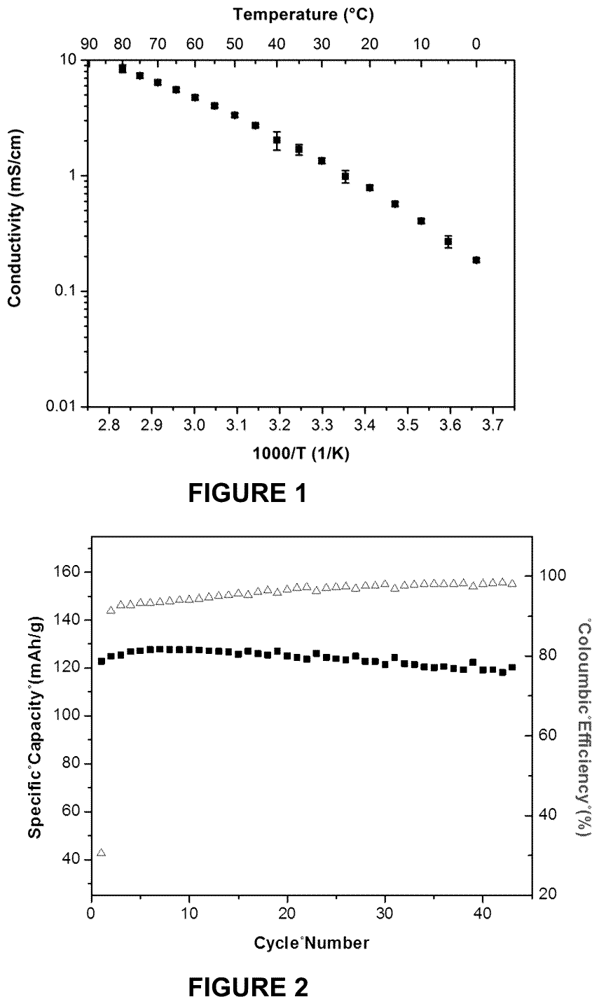

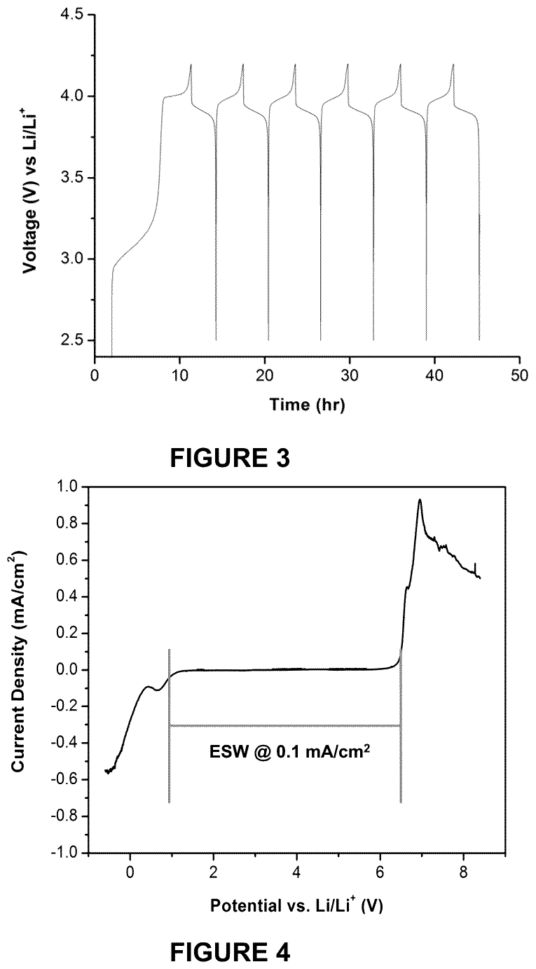

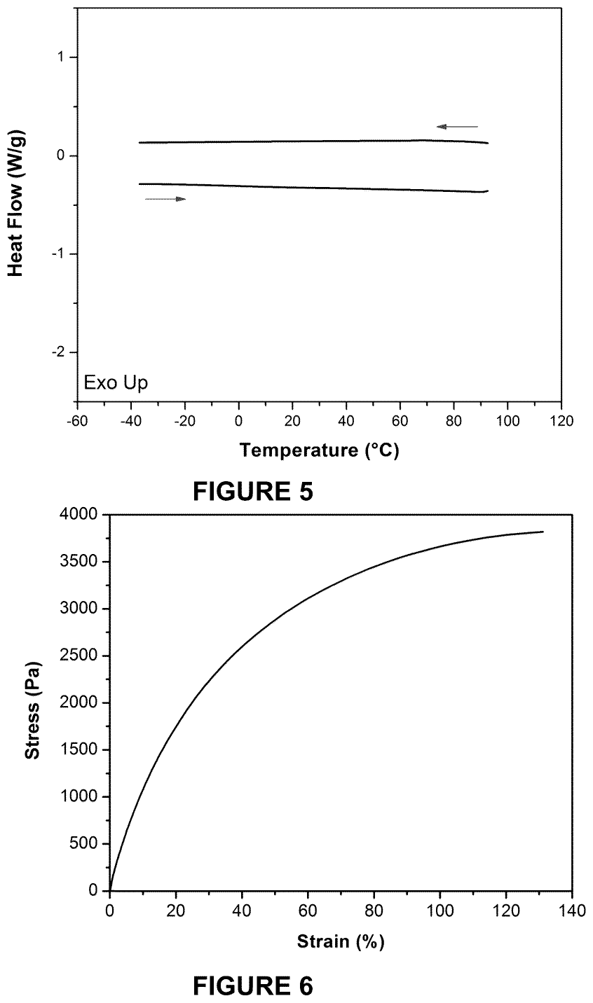

A concentrated 21 molal (moles salt/kg water) solution of lithium bis(trifluoromethylsulfonyl)imide (LiTFSI) salt in water is mixed with 1 million molecular weight polymer poly(ethylene oxide) (PEO) in a 10:3 mass ratio. This solid mixture is then hot-pressed at 85° C. with one metric ton of pressure for one minute. This process results in a translucent, homogeneous, mechanically pliable thin film (˜150 micrometer thickness). The conductivity of the aqueous solid polymer electrolyte was measured via impedance spectroscopy and was plotted versus inverse temperature as shown in FIG. 1. FIG. 2 shows the cycling performance at 25° C. of the aqueous solid polymer electrolyte with a Li₄Ti₅O₁₂ anode and a LiMn₂O₄ cathode. The voltage-time profile for this cycling performance is shown in FIG. 3. The battery test cell was cycled at a charge rate of C/3 with ˜98% coulombic efficiency delivering ˜120 mA/g capacity. FIG. 4 shows linear sweep voltammetry with an Al working electrode, aqueous solid polymer electrolyte, and LiFePO₄ reference electrode coin cell. The electrochemical stability window (ESW) can be defined by a threshold of −0.1 mA/cm² to 0.1 mA/cm² current density response. FIG. 5 shows a differential scanning calorimetry (DSC) thermogram of the aqueous solid polymer electrolyte in the temperature range of −40° C. to 100° C., exhibiting no thermal transitions. FIG. 6 is a stress/strain response of the aqueous solid polymer electrolyte under tension at 25° C. using dynamic mechanical analysis (DMA). The elastic modulus of the aqueous solid polymer electrolyte measured using DMA was G=15.1 kPa.

### Example 2

### Formulation of an Air Stable Aqueous Solid Polymer Electrolyte

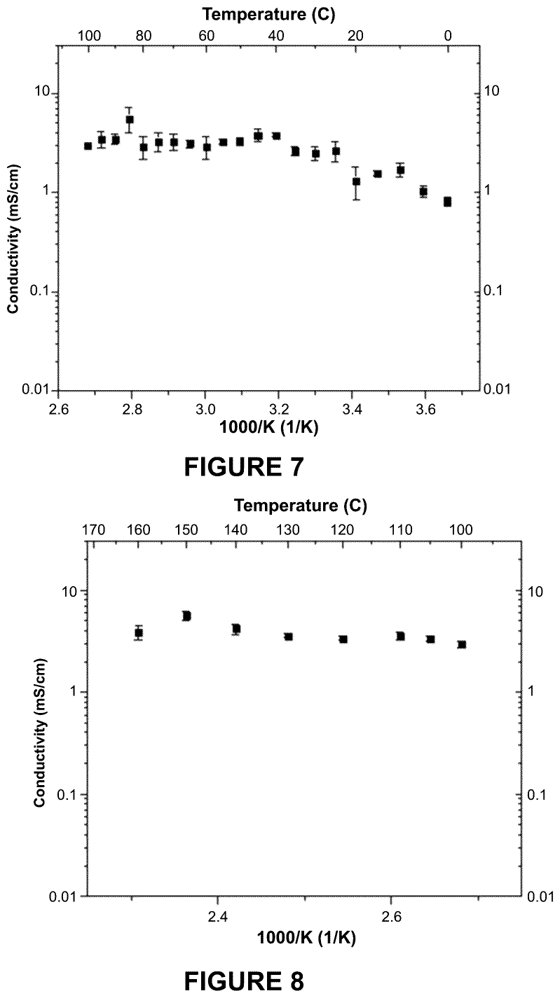

A concentrated 22 molal solution of LiTFSI salt in water was mixed with 100,000 molecular weight polymer poly(acrylonitrile) (PAN) in a 10:3 mass ratio. This solid mixture was then hot-pressed at 85° C. with one metric ton of pressure for five minutes. The measured conductivity is shown in FIG. 7 for a temperature between 0° C. and 100° C. and in FIG. 8 for a temperature between 100° C. and 160° C. The aqueous solid polymer electrolyte showed conductivity of 2.6 mS/cm at 25° C. as well as thermal stability up to 160° C. Conductivity was measured up to 160° C. at which point the cells failed.

### Example 3

### Formulation of an Air Stable Solid Aqueous Polymer Electrolyte

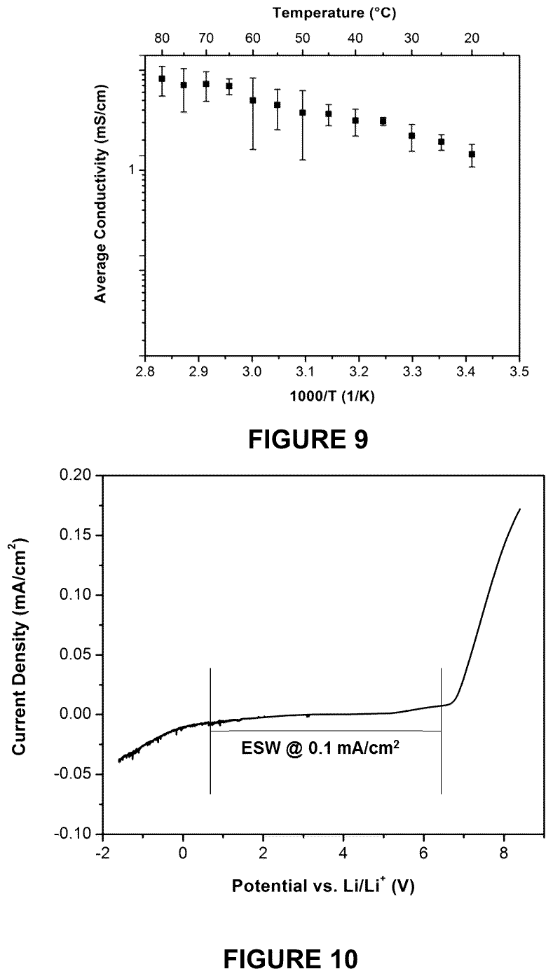

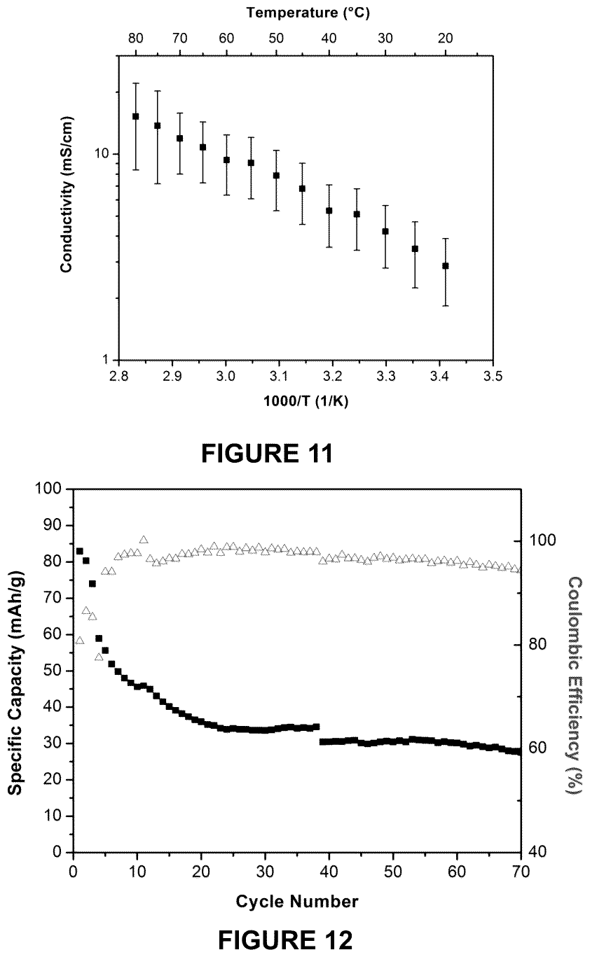

A concentrated 21 molal solution of LiTFSI salt in water is mixed with 4 million molecular weight polymer poly(ethylene oxide) (PEO) in a 10:3 mass ratio. This solid mixture was then hot-pressed at 85° C. with one metric ton of pressure for one minute. The measured conductivity is shown in FIG. 9 for a temperature between 20° C. and 80° C. The solid aqueous polymer electrolyte shows a conductivity of 1.92 mS/cm at 25° C.

### Example 4

### Formulation and Characterization of a Hybrid Aqueous/Ionic Liquid Solid Polymer Electrolyte (HAILSPE)

### Materials and Methods

### Materials

Polyacrylonitrile powder (PAN, MW=230,000 Da) was purchased from Goodfellow Corporation. S_{2,2,2} and lithium-TFSI (LiTFSI) were purchased from Sigma Aldrich. Pyr_{1,3} was purchased from Solvionic. These materials were stored inside a desiccator in a dry environment under vacuum when not in use. 304 stainless steel CR2032 coin cell parts (cases, spacers, wave springs), heat-scalable laminated aluminum pouch film, and 201 nickel ribbon were purchased from MTI Corporation. Polytetrafluoroethylene (PTFE) film (t=0.25 mm) was purchased from McMaster-Carr. Titanium foil (t=0.025 mm) was purchased from Goodfellow Corporation. Lithium iron phosphate (LFP) electrode sheets (32.5×92.5 mm) on aluminum were obtained from Electrodes and More. Graphite electrode sheets on copper were obtained from Argonne National Laboratory. Separator material was obtained from Asahi Kasei. LP57 electrolyte (1 M LiPF₆ in 3:7 v/v EC:EMC) was obtained from Gotion. These materials were stored and handled in a humidity-controlled dry room (relative humidity<1%) or glovebox (MBRAUN) with an argon atmosphere.

### Electrochemical Impedence Spectroscopy (EIS)

Impedance measurements were performed on a Solartron 1287A/1255B platform. HAILSPEs were placed in a symmetrical coin cell using 304 stainless steel blocking electrodes then annealed at 60° C. for 24 hours. A 0.25 mm thick PTFE spacer with a 4 mm inner diameter was used to create a clean, well-defined area of contact between the two blocking electrodes. Electrochemical impedance spectroscopy (EIS) was measured from 1 MHz to 1 Hz with a 10 mV amplitude over a range of temperatures from 0° C. to 80° C., including a one-hour dwell time between each temperature to allow the electrolyte to equilibrate. The samples were made using an empirically determined amount of electrolyte that best fills the volume defined by the PTFE spacer, as defined in M. D. Widstrom, K. B. Ludwig, J. E. Matthews, A. Jarry, M. Erdi, A. v. Cresce, G. Rubloff, P. Kofinas, Enabling high performance all-solid-state lithium metal batteries using solid polymer electrolytes plasticized with ionic liquid, Electrochim Acta. 345 (2020) 136156. https://doi.org/10.1016/j.electacta.2020.136156. Following measurement, all data were analyzed using an error model and linear regression.

### L_{0.5}FP Reference/Counter Electrode Preparation

Due to the constraints of SPEs that limit compatibility with standard reference electrodes in three-electrode configurations, a suitable reference/counter electrode material for two-electrode voltammetry experiments was developed. A porous LFP was chosen because of its wide voltage stability and high surface area that make it both a good reference and counter electrode material. To ensure the stability of the reference electrode's voltage during voltammetry, where it will experience changing degrees of lithiation, the LFP was charged to precisely one-half of its discharge capacity. At this point, which lies directly in the middle of the voltage plateau, a perturbation in the state of charge—in either direction—will have a minimized effect on the voltage.

To prepare half-charged LFP (L_{0.5} FP), pouch cells were constructed with LFP/separator/graphite and filled with enough LP57 electrolyte to fully wet the separator. Prior to assembly, the LFP and graphite electrodes were tabbed with nickel ribbon using a Sonobond ultrasonic metal spot welder, then allowed to dry in a vacuum oven at 100° C. for 24 hours. The pouch cells were vacuum sealed (30 s, −30 psig) after filling. A Maccor 4000-series was used to complete a two-step process: the pouch cell was first cycled at 1C from 2.7 to 3.8 V for two cycles to find the discharge capacity (DC₂), and then fully charged and discharged at C/5 from 2.7 to 3.8 V before finally charging again at C/5 to DC₂/2. Following the half-charging procedure, the L_{0.5} FP was extracted, washed thoroughly with dry dimethyl carbonate to remove any remaining electrolyte, and then allowed to dry in a vacuum oven at 100° C. for 24 hours.

### Linear Sweep Voltammetry and Cyclic Voltammetry

Linear sweep voltammetry (LSV) and cyclic voltammetry (CV) were performed on a Solartron 1287A/1255B platform. L_{0.5}FP/HAILSPE/Ti coin cells were constructed and then annealed at 60° C. for 24 hours. A 0.25 mm thick PTFE spacer with a 6.35 mm inner diameter was used to create a clean, well-defined area of contact between the L_{0.5} FP and Ti working electrode. The coin cells were equilibrated at 25° C. for one hour prior to measurement and then swept at a scan rate of 0.5 mV/s. For LSV, the cell was swept from the open circuit voltage (OCV) to either 6.425 V vs. Li/Li⁺ (3 V vs. reference, oxidative) or −0.575 V vs. Li/Li⁺ (−4 V vs. reference, reductive). In the analogous oxidative CV measurement, the cell was swept from the OCV to 5 V vs. Li/Li⁺ (1.575 V vs. reference) and then back to 3.425 V vs. Li/Li⁺ (0 V vs. reference) for one cycle, for at least five total cycles. In the analogous reductive CV measurement, the cell was swept from the OCV to 1.925 V vs. Li/Li⁺ (−1.50 V vs. reference) and then back to 3.425 V vs. Li/Li⁺ (0 V vs. reference) for one cycle, for at least five total cycles. The measured current response was converted to a current density by dividing by the area of the PTFE spacer (31.67 mm²).

### Thermogravimetric Analysis

The water content of all electrolytes was determined via thermogravimetric analysis (TGA) using a Shimadzu TGA-50 with a TA-60WS interface and FC-60A flow controller. Samples were prepared by loading 15-25 mg of electrolyte in an alumina crucible. Samples were heated at a rate of 10° C./min from room temperature to 150° C., then held isothermally for 45 minutes. A flowrate of 50 mL/min of high purity nitrogen gas (Airgas, Inc.) was used. The instrument's accompanying software was used to calculate the percent mass lost by taking the difference between the initial (t=0 min) and equilibrated (t>55 min) sample mass. The mass loss was attributed entirely to water in the system since LiTFSI, S_{2,2,2}, and Pyr_{1,3} have no vapor pressure and the degradation temperature of PAN is >150° C. The relative amount of water absorbed during electrolyte processing and handling was calculated by

$$( Equation 1 )$$

$${M}_{{H}_{2} O , absorbed} = \frac{x}{100} ( 53.06 {N}_{PAN} + 18.02 {N}_{{H}_{2} O} + {MW}_{IL} {N}_{IL} + 287.10 {N}_{LiTFSI} ) - \frac{1802 {N}_{{H}_{2} O}}{1 - {(}^{x} {/}_{100} )}$$

where x is the percent mass loss measured from TGA, MW_{IL} is the molar mass of the respective ionic liquid (S_{2,2,2} TFSI/Pyr_{1,3} TFSI), and N_{PAN}, N_{H}_{₂}_{O}, NIL, and N_{LiTFSI} are the designated molar amounts of PAN, H₂O, ionic liquid, and LiTFSI for the composition. The final relative amount of water in the electrolyte was calculated by

$${N}_{{H}_{2} O , total} = {N}_{{H}_{2} O} + \frac{{M}_{{H}_{2} O , absorbed}}{18.02} \qquad ( Equation 2 )$$

Differential Scanning Calorimetry (mDSC)

Modulated differential scanning calorimetry (mDSC) was performed on a TA Instruments Q2500 differential scanning calorimeter. Samples were prepared by hermetically sealing 10-15 mg of electrolyte in an aluminum pan. Samples were cooled from room temperature to −70° C., allowed to equilibrate, then heated to 110° C. at a rate of 3° C./min with a ±1° C./min modulation. A flowrate of 50 mL/min of high purity nitrogen gas (Airgas, Inc.) was used. The reversible heat flow data and any calculated transitions were exported from the accompanying TRIOS software.

### Pulsed-Field Gradient Nuclear Magnetic Resonance (Pfg-NMR)

All electrolytes were opened and packed into NMR tubes (5×180 mm) on the same day within a limited amount of time to ensure exposure to a constant ambient atmosphere. The NMR tubes were subsequently sealed to preserve the atmosphere in which they were prepared, preventing any flux of water into or out of the tube. The diffusion coefficients for TFSI⁻(¹⁹F) and Li⁺ (⁷Li) were measured on a 300 MHz Varian-S Direct Drive Wide Bore Nuclear Magnetic Resonance (NMR) spectrometer operating at a magnetic field of 7 T (¹⁹F and ⁷Li Larmor frequencies of 284.4 and 117 MHz, respectively) equipped with a Doty Scientific Z-spec pulsed-field gradient probe (DS-1034). The diffusion coefficients for H₂O and IL⁺ (1H) were also measured on a 300 MHz NMR spectrometer (1H Larmor frequency of 300 MHz) for the two “H2.5” electrolytes. The diffusion coefficients for H₂O and IL⁺ (¹H) in the two “H1” electrolytes were measured on a 400 MHz Bruker NMR spectrometer operating at 9.39 T (¹H Larmor frequency of 401 MHz). The signal was accumulated over 16 transients with an optimized recycling delay of 2-3.5 s in the Varian spectrometer and 2-3 s in the Bruker spectrometer. The diffusion coefficients were measured at room temperature (25° C.) by using a spinecho pulse sequence. The gradient strength, G, was varied in the range of 3-841 G/cm (Varian) and 0.5-50 G/cm (Bruker) for 16 increments. The diffusion time, Δ, and the diffusion pulse length, δ, were set to 10-100 ms and 2-3 ms, respectively, for the Varian spectrometer, and 600-900 ms and 8-12 ms, respectively, for the Bruker spectrometer. From each experiment, the integrated signal strength, S, as a function of the applied gradient was obtained, and the diffusion coefficients, D, were calculated by using least-squares monoexponential (¹⁹F, ⁷Li) or biexponential (¹H) fitting of the Stejskal-Tanner equation, given by

$$S = {S}_{0} {exp}^{- {D ( G δ γ )}^{2} ( Δ - ( \frac{δ}{3} ) )} \qquad ( Equation 3 )$$

where S₀ is the signal strength without a diffusion gradient pair and γ is the nuclear gyromagnetic ratio of the nucleus.

### HAILSPE Preparation

HAILSPEs were prepared via a solvent-free hot-pressing process. First, PAN, deionized H₂O, ionic liquid (S_{2,2,2}/Pyr_{1,3}), and LiTFSI were mixed in the appropriate amounts using a mortar and pestle. The resulting solid mixture was heat-sealed between two sheets of PTFE inside a laminated aluminum pouch to prevent changes in the water content of the electrolyte. The pouch was then pressed at ˜130° C., above the glass transition temperature (T_{g}) of PAN, for 1 min with a force of 1 metric ton using a Carver press, resulting in a homogeneous film with thickness of 100-200 μm.

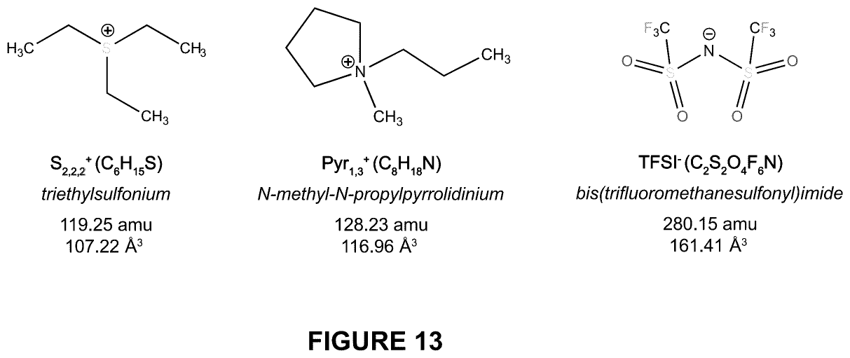

Four HAILSPE systems were fabricated and characterized: two different compositions, HAILSPE-1 and HAILSPE-2.5 (H1 and H2.5), each with two different ionic liquids S_{2,2,2} and Pyr_{1,3}. H1 and H2.5 differ only by the amount of ionic liquid; H1 contains 1 part ionic liquid whereas H2.5 contains 2.5 parts ionic liquid, when compared to the other components. The electrolytes follow the nomenclature of first identifying the ionic liquid used and then identifying the composition that describes the molar ratio of each component (e.g., “S_{2,2,2} H1”). FIG. 13 gives the molecular structure, atomic mass, and van der Waals volume for the TFSI anion and each of the ionic liquid cations used in the HAILSPE systems. Table 1 and Table 2 give the final composition of the electrolytes for different experimental measurements in terms of relative molar ratio, where PAN is the relative molar ratio of the repeat unit. This was done so that the analyses presented are independent of polymer molecular weight, offering better insight into the effect of water and ionic liquid on electrolyte properties.

TABLE 1

| | | | | | σ_{25° C.} | | E_{α} | E_{α} | |
|---|---|---|---|---|---|---|---|---|---|
| | PAN | H₂O | IL | LiTFSI | mS cm⁻¹ | ln A | kJ mol⁻¹ | eV | R² |
| S_{2,2,2} H1 | 6.14 | 14.96 | 1 | 6.93 | 2.31 | 5.79 | 29.60 | 0.307 | 0.9889 |
| Pyr_{1,3} H1 | 6.14 | 24.44 | 1 | 6.93 | 4.55 | 6.30 | 29.12 | 0.302 | 0.9939 |
| S_{2,2,2} H2.5 | 6.14 | 29.09 | 2.5 | 6.93 | 5.01 | 4.11 | 23.45 | 0.243 | 0.9926 |
| Pyr_{1,3} H2.5 | 6.14 | 29.34 | 2.5 | 6.93 | 5.39 | 6.14 | 28.20 | 0.292 | 0.9938 |

Table 1 summarizes the properties determined from EIS and Arrhenius regression for the four HAILSPE systems investigated. The compositions of the electrolyte are provided and represent molar ratios.

TABLE 2

| | | | | | | | D_{TFSI}_{^{−}} × | | σ_{Li}_{⁺}_{_{25° C.}} |
|---|---|---|---|---|---|---|---|---|---|
| | | | | | D_{Li}_{⁺} × 10⁻¹² | D_{IL}_{⁺} × 10⁻¹² | 10⁻¹² | | mS |
| | PAN | H₂O | IL | LiTFSI | m² s⁻¹ | m² s⁻¹ | m² s⁻¹ | t_{Li}_{⁺} | cm⁻¹ |
| S_{2,2,2} H1 | 6.14 | 17.30 | 1 | 6.93 | 6.16 | 2.51 | 1.88 | 0.71 | 1.64 |
| Pyr_{1,3} H1 | 6.14 | 17.79 | 1 | 6.93 | 3.50 | 1.62 | 0.793 | 0.75 | 3.41 |
| S_{2,2,2} H2.5 | 6.14 | 19.00 | 2.5 | 6.93 | 42.2 | 21.6 | 16.7 | 0.58 | 2.91 |
| Pyr_{1,3} H2.5 | 6.14 | 20.57 | 2.5 | 6.93 | 18.3 | 8.46 | 6.57 | 0.60 | 3.23 |

Table 2 summarizes the properties determined from pfg-NMR measurements for the four HAILSPE systems investigated. The compositions of the electrolytes are provided and represent molar ratios. The room temperature lithium-ion conductivity was calculated by σ_{Li}_{⁺}_{_{25° C.}}=t_{Li}_{⁺}×σ_{25° C.} using the ionic conductivity values given in Table 1.

PAN was selected because its strong oxidative stability circumvents the thermodynamic instability at 4 V vs. Li/Li⁺ commonly seen in PEO-based SPEs, which is due to the oxidation of the electron-rich ether oxygens. Furthermore, nitrile-functional polymers like PAN are excellent Lewis bases that can coordinate to and solvate Lit and PAN-based SPEs have shown enhanced anodic limits ˜5.5 V vs Li/Li⁺. The molecular weight of PAN (M_{w}=230,000 Da) was chosen to be as high as commercially available to ensure solid-like properties in the HAILSPE compositions that can contain varying degrees of water and ionic liquid. TFSI was chosen as the anion for both the lithium salt and ionic liquids for its chemical and thermal stability, case of dissociation, and ability to contribute to LiF formation in the SEI. S_{2,2,2}⁺ was chosen as a cation of interest based on our previous work on a nonaqueous ionic liquid SPE (ILSPE), which showed that inclusion of S_{2,2,2} and LiTFSI in a PEO matrix established the propensity to improve ionic conductivity by plasticizing the polymer network to reduce crystallinity. See M. D. Widstrom, K. B. Ludwig, J. E. Matthews, A. Jarry, M. Erdi, A. v. Cresce, G. Rubloff, P. Kofinas, Enabling high performance all-solid-state lithium metal batteries using solid polymer electrolytes plasticized with ionic liquid, Electrochim Acta. 345 (2020) 136156. https://doi.org/10.1016/j.electacta.2020.136156. Furthermore, CV, lithium metal stripping and plating, and galvanostatic cycling measurements indicated strong passivating behavior and interfacial stability at low voltages. Pyr_{1,3}⁺ was chosen as an additional cation of interest because it has been shown to reduce to stable products, such as Li₃N, and contribute to LiF production in the SEI when paired with TFSI⁻ in lithiated systems.

### Differential Scanning Calorimetry

For traditional lithium-ion SPEs that use semicrystalline PEO, the primary ionic transport mechanism is coordination and subdiffusive motion of Li⁺ along the polymer chain backbone, together with intersegmental hopping between polymer chains. Therefore, if appreciable transport of Lit relies on segmental chain motion, improving ionic conductivity in semicrystalline matrices by suppressing crystallinity may enhance polymer chain mobility, which facilitates ionic transport. PAN's relatively high T_{g}˜120° C., or the crossover temperature where polymer chains gain mobility, and lack of crystallinity suggest that Li⁺ will exhibit ionic transport independent of polymer chain mobility.

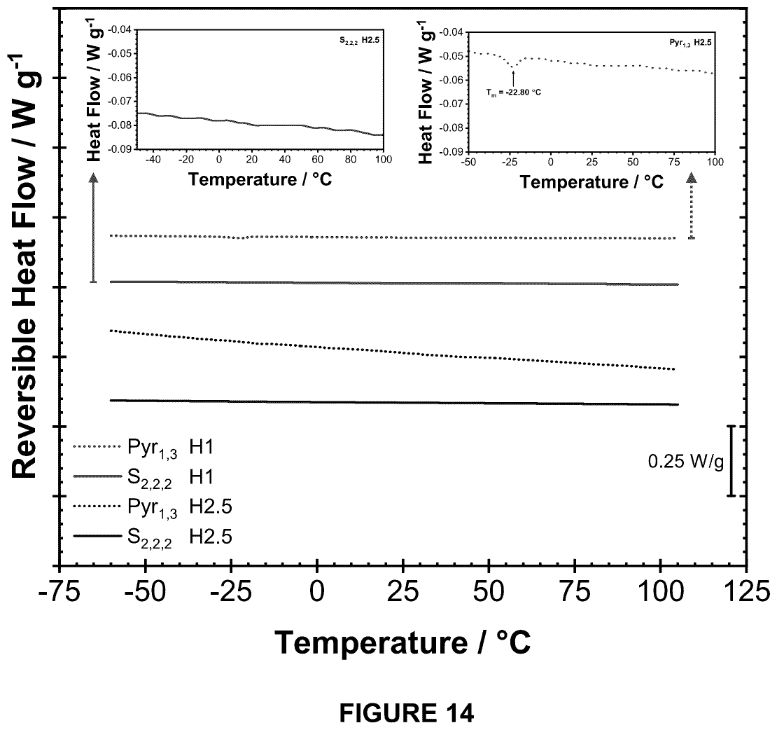

The thermal properties of the four electrolytes were investigated via mDSC; their thermograms are given in FIG. 14. The compositions of the electrolytes used for mDSC analysis, after measuring final water content via TGA, are given in Table 1. mDSC was chosen over traditional DSC because of its increased accuracy and precision for measuring weak transitions or measuring multiple transitions occurring simultaneously. Furthermore, mDSC allows for measurement of the heat capacity and extraction of the reversible heat flow, which can better distinguish thermal responses based on heat capacity related transitions, such as T_{g} or melting transition Tₘ. As observed in FIG. 14, each electrolyte exhibits a relatively flat thermal response, which indicates a suppression of crystallinity for the system. Both H1 electrolytes and S_{2,2,2} H2.5 show zero crystallinity, while Pyr_{1,3} H2.5 exhibits a small Tₘ at ˜−22.80° C. The enthalpy of this transition, found from the area under the curve, is only ˜0.73 J/g, which is relatively insignificant compared to the total latent heat of each of the components. While Pyr_{1,3} H1 has 16.7% less water than Pyr_{1,3} H2.5, no Tₘ is observed in FIG. 14. Furthermore, S_{2,2,2} H2.5 has a similar water content as Pyr_{1,3} H2.5 (<1% difference), yet no transitions are observed. This suggests that the Tₘ in Pyr_{1,3} H2.5 is likely due to a combination of the increased water content, the highest of all four electrolytes studied, and the choice of ionic liquid. The increased ionic liquid content in Pyr_{1,3} H2.5 compared to Pyr_{1,3} H1 may help to plasticize the system and reduce the overall latent heat of the Tₘ. Nevertheless, because only one Tₘ is observed at a relatively low temperature, lower than the expected operating conditions>0° C., the system can be considered homogeneously well mixed with a minimal enough degree of crystallinity to still warrant further investigation.

### Electrochemical Impedence Spectroscopy

To assess ionic mobility in the four HAILSPE systems, EIS was used to measure electrolyte resistance. From the ohmic resistance, R, ionic conductivity, in units of mS/cm, was calculated by

$$σ = 1000 \frac{t}{R * A} \qquad ( Equation 4 )$$

where t and A are the thickness and area of the electrolyte in units of cm and cm², respectively, as defined by the PTFE spacer. After analysis and data correction, the Nyquist plots for each electrolyte system showed pure ionic conductor behavior at all temperatures. A simple equivalent circuit model with only one resistor was used to find the electrolyte resistance from the intercept of the data with the real impedance at high frequencies. This value is representative of the system's ohmic resistance, which includes losses due to the electrolyte, wires, and electric contacts.

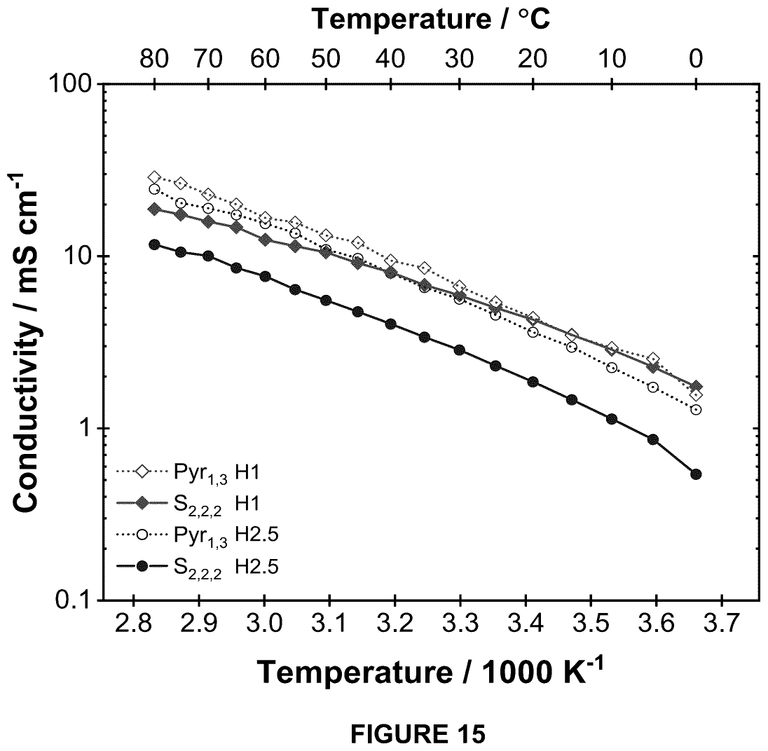

The ionic conductivity values for the four electrolyte systems, over a range of temperatures from 0 to 80° C., are given in FIG. 15 and largely demonstrate the impact of water on the transport properties of these HAILSPEs. The compositions of the electrolytes used for EIS analysis are given in Table 1. Because of the extremely hygroscopic nature of the electrolytes and the difficulty of controlling water absorption during processing in ambient conditions, Pyr_{1,3} H1 has ˜63% more water than S_{2,2,2} H1. This difference in water content results in a large discrepancy in ionic conductivity at all temperatures (e.g., 4.55 mS/cm and 2.31 mS/cm, respectively, at 25° C.), which is consistent with the results of similar systems that show ionic conductivity is heavily correlated with water concentration because of water's ability to coordinate with and solvate Lit. The water content of S_{2,2,2} H2.5 and Pyr_{1,3} H2.5 was more precisely controlled, resulting in <1% difference. As a result, FIG. 15 shows that the ionic conductivity values more closely agree with one another than in the case of H1, particularly at low temperatures (≤30° C.). Furthermore, the water content of Pyr_{1,3} H1 lies closer to S_{2,2,2} and Pyr_{1,3} H2.5 and shows comparable ionic conductivity values.

While FIG. 15 shows that increasing water content (S_{2,2,2} H1 to Pyr_{1,3} H1) leads to a notable improvement in mobility, the choice of ionic liquid and its impact on conductivity is not readily assessable. However, the linear behavior of these four HAILSPE systems with visually different slopes-especially S_{2,2,2} H2.5 compared to Pyr_{1,3} H2.5, which have nearly identical water content-suggests that there is, in fact, a dependency on the ionic liquid chemistry. To elucidate this effect, an Arrhenius regression was performed for the full-temperature ionic conductivity data, in the form of

$$σ = A * exp ( \frac{- {E}_{a}}{RT} ) \qquad ( Equation 5 )$$

where A is the pre-exponential factor and E_{α} is the apparent activation energy. If Equation 5 is linearized, then

$$ln σ = ln A - \frac{{E}_{a}}{R} \cdot \frac{1}{T} \qquad ( Equation 6 )$$

which is in the form of y=mx+b. If ln σ is plotted as a function of inverse temperature, then the slope is

$$- \frac{{E}_{a}}{R}$$

and the y-intercept is ln A.

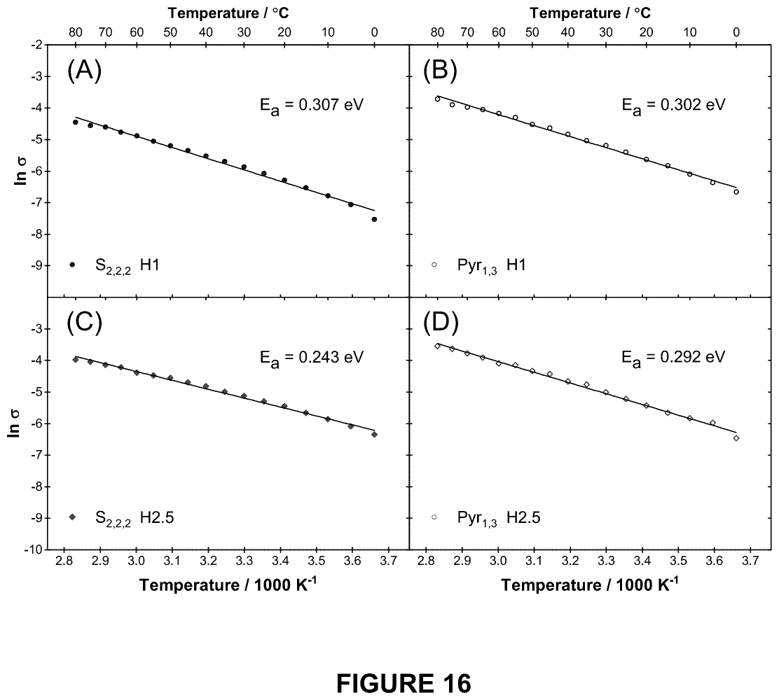

The linearized data for each of the four HAILSPE systems is presented in FIG. 16. Based on Equation 6, E_{α} and ln A were calculated from the slopes and y-intercepts of the fit lines, respectively. A summary of these values, including the R² fit parameter, is presented in Table 1. In SPE systems, E_{α} is often regarded as contribution to ionic conductivity from the segmental motion of the polymer matrix while A is thought to be related to the charge carrier concentration. Thus, a lower E_{α} would indicate further decoupling of ionic transport from polymer chain mobility. Plots (A) and (B) in FIG. 16 present the Arrhenius fit for S_{2,2,2} and Pyr_{1,3} H1, respectively, while Plots (C) and (D) present the Arrhenius fit for S_{2,2,2} and Pyr_{1,3} H2.5, respectively. When there is a large disparity in water content, as in S_{2,2,2} vs Pyr_{1,3} H1, E2 remains constant—0.307 eV and 0.302 eV, respectively—and no apparent trend is discernable. However, when water content is more carefully controlled, FIG. 16 suggests that both E_{α} and ln A increase when changing the ionic liquid chemistry from S_{2,2,2}—0.243 eV and 4.11, respectively—to Pyr_{1,3}—0.292 eV and 6.14, respectively. FIG. 16 also suggests that the H2.5 composition yields lower activation energies, likely due to the increased amount of ionic liquid in the electrolyte.

While it is possible that the difference in E_{α} from changing ionic liquid chemistry is due to an underlying fundamental phenomenon, studies indicate that E_{α} can cover a wide range for most systems, rather than existing as a single value. Nevertheless, the E_{α} found in this work for each of the four HAILSPE systems is more comparable with liquid-phase electrolytes than SPEs. For example, activation energies of 0.259 eV and 0.275 eV were calculated for DME and DMSO organic electrolytes, respectively, under conditions where Li⁺ were fully solvated. In an EC+DEC organic electrolyte where Li⁺ were completely nonsolvated, E_{α} was significantly higher at ˜0.583 eV. Aqueous electrolytes demonstrated E_{α} similar values to the fully solvated organic electrolytes. The water-in-salt electrolyte (WiSE) was found to have an estimated E_{α} of ˜0.286 eV, calculated from approximations based on the available conductivity data, which is comparable to S_{2,2,2} H1, Pyr_{1,3} H1, and Pyr_{1,3} H2.5. The hybrid aqueous/nonaqueous electrolyte (HANE) was found to have an estimated E_{α} of ˜0.228 eV that is comparable to S_{2,2,2} H2.5. In these liquid electrolytes, E_{α} is thought to be related to the reorientation of interacting species rather than polymer segmental motion.

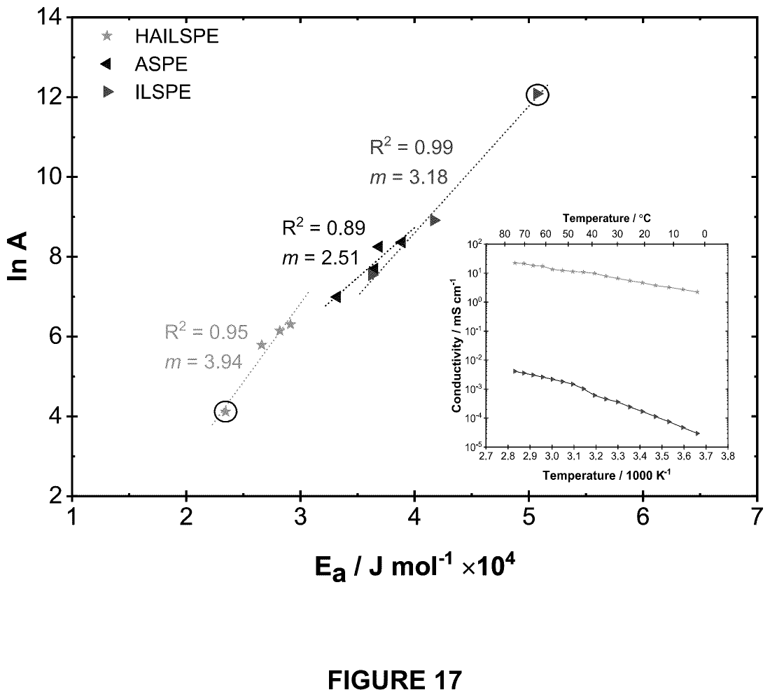

Based on Equation 5, a general design principle can be developed to improve ionic conductivity by decreasing E_{α} or increasing A. This principle, however, is predicated on the assumption that the underlying processes described are entirely different and completely uncorrelated. When a negative correlation between correlation between E_{α} and A parameters exists, then the design principle remains unchanged. If, however, a positive correlation exists, the maximum ionic conductivity for a system corresponds to a minimized A, which is contradictory to the strategy employed for most aqueous electrolytes where the total number of charge carriers is increased to improve electrochemical stability. To assess the degree of correlation for the HAILSPE systems reported here, ln A vs E_{α} was plotted in FIG. 17 for the four electrolytes based on the values extracted from the Arrhenius regressions presented in FIG. 16 and summarized in Table 1. For comparison, the ln A and E_{α} values were extracted for our previously reported aqueous solid polymer electrolyte (ASPE) and nonaqueous ionic liquid solid polymer electrolyte (ILSPE) systems (Table 3 and Table 4). See M. D. Widstrom, O. Borodin, K. B. Ludwig, J. E. Matthews, S. Bhattacharyya, M. Garaga, A. v. Cresce, A. Jarry, M. Erdi, C. Wang, S. Greenbaum, P. Kofinas, Water Domain Enabled Transport in Polymer Electrolytes for Lithium-Ion Batteries, Macromolecules. 54 (2021) 2882-2891. https://doi.org/10.1021/acs.macromol.0c01960; and M. D. Widstrom, K. B. Ludwig, J. E. Matthews, A. Jarry, M. Erdi, A. v. Cresce, G. Rubloff, P. Kofinas, Enabling high performance all-solid-state lithium metal batteries using solid polymer electrolytes plasticized with ionic liquid, Electrochim Acta. 345 (2020) 136156. https://doi.org/10.1016/j.electacta.2020.136156.

TABLE 3

| | | | | | σ_{25° C.} | ln | E_{A} | E_{A} | |
|---|---|---|---|---|---|---|---|---|---|
| | PEO | H₂O | IL | LiTFSI | mS cm⁻¹ | A | kJ mol⁻¹ | eV | R² |
| ASPE 1 | 6 | 8.15 | 0 | 2.63 | 1.75 | 6.99 | 33.23 | 0.345 | 0.9956 |
| ASPE 2 | 6 | 6.92 | 0 | 2.63 | 1.58 | 8.25 | 36.89 | 0.383 | 0.9978 |
| ASPE 3 | 6 | 5.74 | 0 | 2.63 | 0.909 | 7.69 | 36.51 | 0.379 | 0.9980 |
| ASPE 4 | 6 | 4.65 | 0 | 2.63 | 0.681 | 8.36 | 38.91 | 0.404 | 0.9990 |

Table 3 summarizes the properties determined from EIS and Arrhenius regression for the four ASPE systems. The compositions of the electrolyte are provided and represent molar ratios.

TABLE 4

| | | | | | σ_{25° C.} | | E_{A} | E_{A} | |
|---|---|---|---|---|---|---|---|---|---|
| | PEO | H₂O | IL | LiTFSI | mS cm⁻¹ | ln A | kJ mol⁻¹ | eV | R² |
| ILSPE 1 | 20 | 0 | 4 | 2 | 0.965 | 7.54 | 36.23 | 0.376 | 0.9830 |
| 20:4:2 | | | | | | | | | |
| ILSPE 2 | 20 | 0 | 2 | 2 | 0.454 | 8.91 | 41.68 | 0.433 | 0.9744 |
| 20:2:2 | | | | | | | | | |
| ILSPE 3 | 20 | 0 | 1 | 1 | 0.241 | 12.09 | 50.71 | 0.526 | 0.9908 |
| 20:1:1 | | | | | | | | | |

Table 4 summarizes the properties determined from EIS and Arrhenius regression for the three ILSPE systems. The compositions of the electrolyte are provided and represent molar ratios.

FIG. 16 clearly shows that the HAILSPEs have the lowest apparent activation energies of the three systems, ranging from 23.45 KJ/mol to 29.60 KJ/mol. Compared to the ASPEs (33.23-38.91 kJ/mol) and ILSPEs (36.23-50.71 KJ/mol), this reduction in E_{α} can be attributed to the choice of PAN as the polymer matrix instead of PEO, where polymer chain mobility is a major contributor to ionic transport. Similarly, the trend in ln A is consistent with the reduction of overall concentration of Li⁺ from ˜17.9-31.4 m in ASPE systems to ˜4.4-10.4 m in HAILSPE systems when assuming water and ionic liquid as the only solvents. From FIG. 16, a positive correlation between E_{α} and A is observed for each of the three studied systems, with the HAILSPEs (R²=0.95) situated between the ILSPE (R²=0.99) and ASPE (R²=0.89) systems. As with the Arrhenius regression conducted in FIG. 15, the relationship between ln A and Ed in FIG. 16 can be described by the linear equation ln(ln A)=mE_{α}+b. From rearrangement of Equation 6 and substitution of the linear equation, the relationship between the conductivities of two different electrolytes can be described by

$$\frac{{σ}_{2}}{{σ}_{1}} = {( \frac{{A}_{2}}{{A}_{1}} )}^{1 - ( \frac{1}{mRT} )} \qquad ( Equation 7 )$$

which demonstrates that the change in ionic conductivity as a response to a change in A is dependent on the value of mRT. If mRT≥1, then ionic conductivity is proportional to A and increases with increasing A. If, however, 0≤mRT<1, then ionic conductivity is inversely proportional to A and increases with decreasing A. Based on the slopes of the fit lines shown in FIG. 17, mRT<1 for all three of the systems at room temperature, indicating that a decrease in A causes an increase in ionic conductivity. FIG. 17 and the conductivity values given in Table 1, Table 3, and Table 4 corroborate this result; HAILSPEs show the lowest value of ln A (4.11), yet, on average, exhibit ionic conductivities˜4 orders of magnitude greater than the ILSPE composition with the highest value of ln A (FIG. 17, inset). This outcome can be attributed to the design of the HAILSPE systems, which include both water and ionic liquid as plasticizers rather than each individually. While the inclusion of ionic liquid can artificially inflate the ionic conductivity due to the contribution from the cation, the room temperature lithium-specific conductivity σ_{Li}_{⁺}—calculated by t_{Li}_{⁺}×σ_{25° C.}—given in Table 2 remains greater for all four HAILSPE systems than the four ASPE systems previously reported. The determination of t_{Li}_{⁺}, the transport number for Li⁺, is discussed below.
pfg-NMR

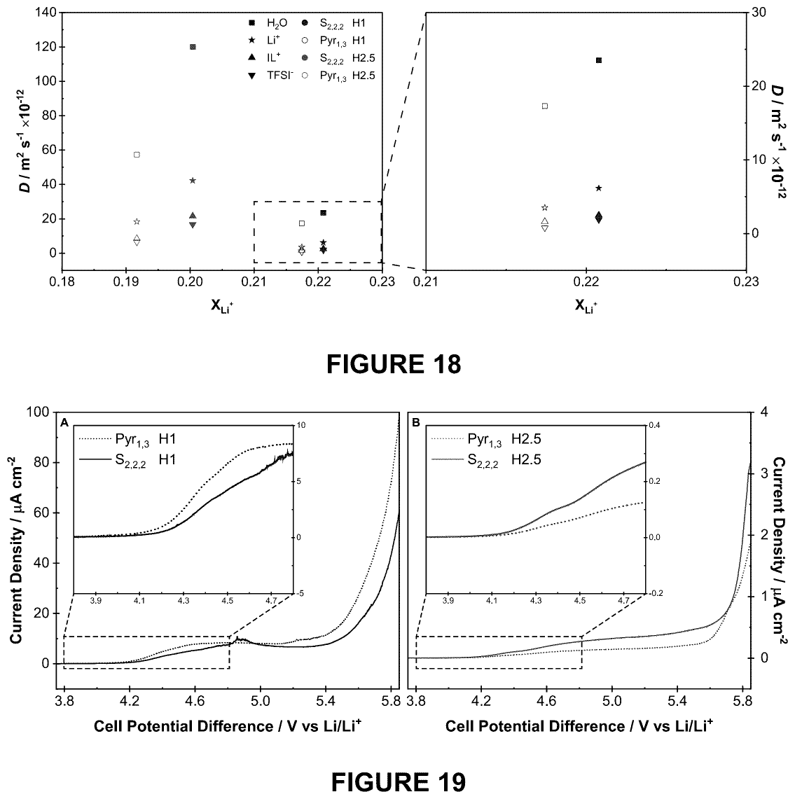

To further investigate transport properties, pfg-NMR measurements were taken for the four HAILSPEs. The compositions of the electrolytes used for pfg-NMR analysis, after measuring final water content via TGA, are given in Table 2. Diffusion coefficients for H₂O (¹H), Li⁺ (⁷Li), IL⁺ (S_{2,2,2}⁺/Pyr_{1,3}⁺; ¹H), and TFSI⁻(¹⁹F) are plotted in FIG. 18 as a function of the lithium-ion mole fraction. For all compositions, H₂O (squares) is the predominantly mobile species based on its diffusion coefficient. For the ions in the system, the diffusion coefficients follow the same order for all electrolytes: Li⁺ (stars)>IL⁺ (up triangle)>TFSI⁻(down triangle). For both S_{2,2,2} H2.5 (green, solid) and Pyr_{1,3} H2.5 (green, empty), D_{H}_{₂}_{O} in FIG. 18—and to a smaller degree, D_{IL}_{⁺}—is likely overestimated because the parafilm wrapping used to prepare the samples is a saturated polyolefin that produces a background signal in the ¹H spectrum. When unsaturated PTFE was used to prepare samples for S_{2,2,2} H1 (blue, solid) and Pyr_{1,3} H1 (blue, empty), the background signal was significantly reduced and D_{H}_{₂}_{O} and D_{IL}_{⁺} more closely resemble D_{Li}_{⁺} and D_{TFSI}_{^{−}} in FIG. 18.

In SPEs, t_{Li}_{⁺} is readily measured using the Bruce-Vincent (BV) method to determine approximately what portion of the ionic conductivity can be attributed to the movement of Li⁺. This technique, however, requires the use of lithium-metal electrodes and is therefore not compatible with aqueous electrolytes. Instead, a transport number can be calculated from the diffusion coefficients obtained through pfg-NMR, given in Table 2, by

$${t}_{Li} + = \frac{{c}_{{Li}^{+}} * {D}_{{Li}^{+}}}{( {c}_{{Li}^{+}} * {D}_{{Li}^{+}} ) + ( {c}_{{TFSI}^{-}} * {D}_{{TFSI}^{-}} ) + ( {c}_{{IL}^{+}} * {D}_{{IL}^{+}} )} \qquad ( Equation 8 )$$

where c_{Li}_{⁺} is the concentration of Li⁺, C_{TFSI}_{^{−}} is the concentration of TFSI⁻, and cut is the ionic liquid cation (S_{2,2,2}+/Pyr_{1,3}+) concentration. The transport numbers calculated from Equation 8 are given in Table 2. The H1 electrolytes exhibited greater transport numbers (0.71, 0.75) at room temperature than the H2.5 electrolytes (0.58, 0.60). This is because the H2.5 systems contain more ionic liquid than the H1 systems, with relatively comparable amounts of polymer, water, and salt, which reduces the concentration of Li⁺ and decreases t_{Li}_{⁺}. Furthermore, the electrolytes with Pyr_{1,3} show greater transport numbers (0.75, 0.60) than the S_{2,2,2} versions (0.71, 0.58), which may be due to self-aggregation of Pyr_{1,3} into slower surfactant-like moieties that would reduce Lit-Pyr_{1,3} interactions in favor of interactions with more mobile water molecules. This speculation agrees with the measured D_{IL}_{⁺} values, which are 1.55-2.55 times smaller for the Pyr_{1,3} electrolytes when compared to their S_{2,2,2} analogs.

The pfg-NMR results presented in FIG. 18 and Table 2 are significant because they indicate a large degree of decoupling of ionic transport from polymer chain mobility and preferential Li⁺ transport. If there was coupling, IL⁺ and TFSI-would be largely unhindered and have higher diffusion coefficients relative to Li⁺, resulting in significantly lower transport numbers˜0.2-0.4 often seen in SPEs. For example, our previously reported ILSPE system, used for comparison in FIG. 17, exhibited t_{Li}_{⁺} values in the range of 0.25-0.35 when measured using the BV method (Table 6). However, our previously reported ASPE system, also used for comparison in FIG. 17, exhibited t_{Li+} values comparable to the HAILSPE systems reported here, in the range of 0.64-0.67 (Table 5). It is interesting to note that the diffusion coefficients of the HAILSPE systems given in Table 2 are approximately the same as the diffusion coefficients for the ASPE systems in Table 5, also measured with pfg-NMR, yet the room temperature ionic conductivities for HAILSPE systems, given in Table 1, are 1.3-7.9 times greater. As discussed above, despite the ionic liquids contributing to total ionic conductivity, the room temperature σ_{Li}_{⁺} is still greater for the HAILSPEs compared to the ASPEs. The diffusion coefficients may offer some insight, which show that the ratio of D_{Li}_{⁺} to D_{TESI}_{^{−}} is ˜3 for HAILSPEs and ˜2 for ASPEs, suggesting that the TFSI—are significantly slower in HAILSPEs, enabling Li⁺ to move relatively faster. Furthermore, this suggests that the transport of Li⁺ is further decoupled from polymer chain mobility, which can also account for the improvement in conductivity.

TABLE 5

| | | | | | D_{Li}_{⁺} × | D_{TFSI}_{^{−}} × | D_{H}_{₂}_{O}_{⁺} × | | σ_{Li}_{⁺}_{_{25° C.}} |
|---|---|---|---|---|---|---|---|---|---|
| | | | | | 10⁻¹² | 10⁻¹² | 10⁻¹² | | mS |
| | PEO | H₂O | IL | LiTFSI | m² s⁻¹ | m² s⁻¹ | m² s⁻¹ | t_{Li}_{⁺} | cm⁻¹ |
| ASPE 1 | 6 | 8.15 | 0 | 2.63 | 14.8 | 8.39 | 64.8 | 0.64 | 1.12 |
| ASPE 2 | 6 | 6.92 | 0 | 2.63 | 12.7 | 6.80 | 55.4 | 0.67 | 1.06 |
| ASPE 3 | 6 | 5.74 | 0 | 2.63 | 7.38 | 3.80 | 43.1 | 0.67 | 0.61 |
| ASPE 4 | 6 | 4.65 | 0 | 2.63 | 4.17 | 2.21 | 30.6 | 0.66 | 0.45 |

Table 5 summarizes the properties determined from pfg-NMR measurements for the four ASPE systems. The compositions of the electrolytes are provided and represent molar ratios. The room temperature lithium-ion conductivity was calculated by σ_{Li}_{_{25° C.}}_{⁺}=t_{Li}_{⁺}×σ_{25° C.} using the ionic conductivity values given in Table 3.

TABLE 6

| | | | | | | σ_{Li}_{⁺}_{_{25° C.}} |
|---|---|---|---|---|---|---|
| | | | | | | mS |
| | PEO | H₂O | IL | LiTFSI | t_{Li}_{⁺} (BV) | cm⁻¹ |
| ILSPE 1 | 20 | 0 | 4 | 2 | 0.31 | 0.30 |
| 20:4:2 | | | | | | |
| ILSPE 2 | 20 | 0 | 2 | 2 | 0.25 | 0.11 |
| 20:2:2 | | | | | | |
| ILSPE 3 | 20 | 0 | 1 | 1 | 0.35 | 0.08 |
| 20:1:1 | | | | | | |

Table 6 summarizes the properties determined from B-V measurements for the three ILSPE systems. The compositions of the electrolytes are provided and represent molar ratios. The room temperature lithium-ion conductivity was calculated by σ_{Li}_{_{25° C.}}_{⁺}=t_{Li}_{⁺}×σ_{25° C.} using the ionic conductivity values given in Table 4.

### Linear Sweep and Cyclic Voltammetry

As discussed previously, PAN was selected because of its strong oxidative stability. To further understand the oxidative stability of HAILSPE systems, LSV was used to assess the anodic limit of the electrolytes. FIG. 19 shows the representative current density of both H1 (Plot A) and H2.5 (Plot B) systems as a function of cell potential. For all systems, the same trend was observed: generally low current evolution starting at ˜4.2 V vs. Li/Li⁺, likely due to minor oxidation of PAN, followed by rapid current evolution at potentials>5.4 V vs. Li/Li⁺ due to complete electrolyte degradation. While it is difficult to accurately assess the electrochemical stability window in SPEs, this result supports the generally favorable oxidative stability of PAN-based electrolytes.

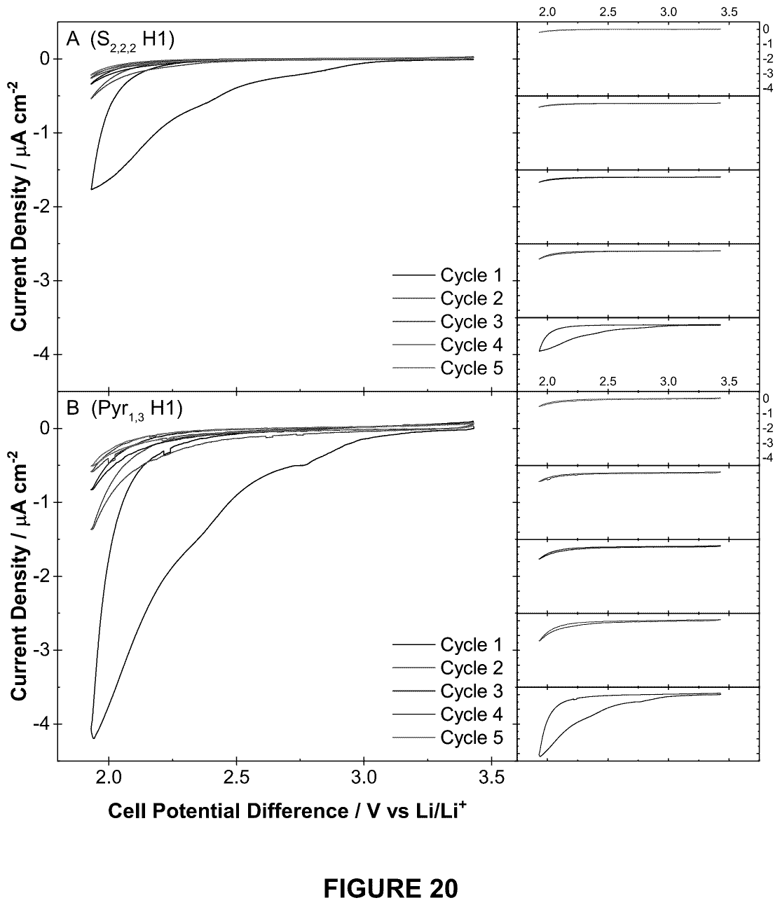

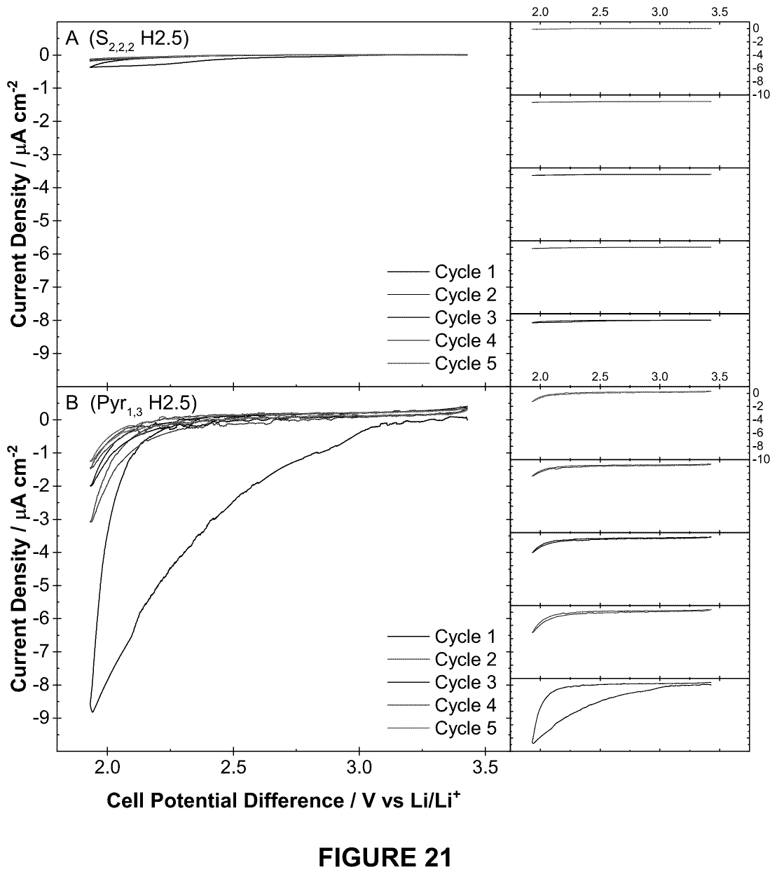

To assess cathodic stability, CV was used to monitor the passivating behavior and SEI formation in each of the four HAILSPE systems. A modest limit of ˜2 V vs. Li/Li⁺ was chosen to investigate this behavior without causing irreversible electrolyte degradation. FIG. 20 and FIG. 21 display the first 5 cycles for H1 and H2.5 electrolytes, respectively. The current response at low potentials is due to H₂O reduction, thus it is expected that systems with more water will yield larger current densities. The results for Pyr_{1,3} H1 and Pyr_{1,3} H2.5 support this claim; in FIG. 21, Plot B, Pyr_{1,3} H2.5 contained ˜3 times as much water and measured a current density˜2 times greater than the Pyr_{1,3} H1 electrolyte at the selected limit shown in FIG. 20, Plot B. Furthermore, it is immediately clear from FIG. 20 and FIG. 21 that for both systems, the Pyr_{1,3} version yields a larger current density in the first cycle than the S_{2,2,2} version. This finding aligns with pfg-NMR results that suggested Pyr_{1,3} systems had reduced Li⁺-Pyr_{1,3}⁺ interactions in favor of interactions with water. Increased Li⁺—H₂O interactions are expected to lead to a higher concentration of water available for reduction as lithium ions shuttle water to the anode surface.

FIG. 20 and FIG. 21 also provide information regarding the quality of the SEI formed during passivation at the selected limit. Trends in successive cycles can indicate one of two main pathways for SEI growth: tunnelling or self-inhibition. In the first case, the SEI is uniform but thin enough to allow electron tunnelling through it. Thus, current evolution indicates an increase in SEI thickness. In CV measurements, tunnelling is represented by a shift in the potential of the reduction peak with consecutive cycling. In the more common second case, the SEI is non-uniform but thick enough to block electron tunnelling through it. Thus, current evolution indicates additional SEI formation at unblocked sites and improves coverage. In CV measurements, self-inhibition is represented by a decrease in the current density with consecutive cycling. The decrease in current density observed over consecutive cycles in FIG. 20 and FIG. 21 clearly indicates a self-inhibitory pathway of SEI growth for both H1 and H2.5 systems. Furthermore, the CV results suggest that growth of the thick SEI is relatively fast and completes with full surface coverage within the first 5 cycles, as evidenced by the drastic decrease in current density after the first full cycle in all cases.

The HAILSPEs disclosed herein provide an alternative pathway to aqueous systems for solid-state analogs, demonstrating a strategy to tune the degree of passivation at the anode while simultaneously improving transport properties. Pyr_{1,3} H2.5 exhibited a room temperature ionic conductivity of 5.39 mS/cm, 3 times greater than even the most conductive ASPE predecessor. This same electrolyte, however, exhibited the largest degree of H₂O reduction before complete passivation, reaching a peak current density of ˜9 μA/cm². When the electrolyte composition is modified slightly, the peak current density of Pyr_{1,3} H1 is limited to ˜4 μA/cm². Switching the ionic liquid chemistry even further reduces the peak current density to <2 μA/cm² for S_{2,2,2} H1, however this electrolyte maintains an ionic conductivity less than half of Pyr_{1,3} H2.5. HAILSPE systems displayed remarkable improvement of transport properties from their ASPE predecessors while demonstrating the capability to tune the degree of passivation.

### Example 5

### Composition-Function Relationships in Hybrid Aqueous/Ionic Liquid Solid Polymer Electrolytes (HAILSPE)

To better understand the ways in which composition influences the electrochemical properties of HAILSPEs, a variety of electrolyte compositions were prepared and characterized to elucidate the effect of each component. Tables 7-13 give the final compositions, in relative molar amounts, for all electrolyte systems used in this work; 3.27-13.57 parts PAN, 6.94-57.30 parts H₂O, 0-4 parts ionic liquid, and 3.03-17.06 parts LiTFSI. The relative molar amount of PAN is based on the monomer repeat unit (53.06 g mol 1) to ensure the analyses presented herein form design goals that are independent of the polymer molecular weight and clarify the influence of water, IL, and LiTFSI on electrolyte properties. Molalities of LiTFSI and [LiTFSI+IL] relative to water are also provided. The compositions were carefully selected to cover a wide range of polymer, water, ionic liquid, and salt contents that yielded well-mixed, homogeneous films which were not phase separated. Two versions of electrolytes H1-H18 and NMR1-NMR8 were made using either S_{2,2,2} or Pyr_{1,3}, except for NMR3 which contained no ionic liquid. Although the electrolytes were designed in groups to elucidate the effect of a single component by keeping all others constant, the hygroscopicity of the systems caused additional water absorption during processing in ambient conditions and often resulted in electrolytes within the same group having differing water contents. However, absorbed water was accounted for via thermogravimetric analysis (TGA) measurements post-processing and the analyses presented in this work reflect the complexity of these quaternary systems.

TABLE 7

| | | | | | | | Molality |
|---|---|---|---|---|---|---|---|
| | | | | | σ_{25° C.} | Molality | (mol kg⁻¹) |
| Group 1 | | | | | mS | (mol kg⁻¹) | [LiTFSI + |
| LiTFSI | PAN | H₂O | S_{2,2,2}TFSI | LiTFSI | cm⁻¹ | [LiTFSI] | S_{2,2,2}TFSI] |
| H1 | 6.14 | 29.47 | 1 | 6.93 | 7.15 | 13.05 | 14.93 |
| H2 | 6.14 | 14.96 | 1 | 6.93 | 2.29 | 25.71 | 29.42 |
| H3 | 6.14 | 7.55 | 1 | 4.46 | 1.57 | 32.78 | 40.13 |
| H4 | 6.14 | 7.8 | 1 | 3.03 | 0.92 | 21.56 | 28.67 |
| | | | | | | | Molality |
| | | | | | σ_{25° C.} | Molality | (mol kg⁻¹) |
| Group 2 | | | | | mS | (mol kg⁻¹) | [LiTFSI + |
| PAN | PAN | H₂O | S_{2,2,2}TFSI | LiTFSI | cm⁻¹ | [LiTFSI] | S_{2,2,2}TFSI] |
| H5 | 3.27 | 13.59 | 1 | 3.03 | 5.08 | 12.37 | 16.46 |
| H6 | 3.27 | 10.71 | 1 | 3.03 | 3.12 | 15.70 | 20.88 |
| H7 | 6.14 | 6.94 | 1 | 3.03 | 0.48 | 24.23 | 32.22 |
| H8 | 10.83 | 10.08 | 1 | 3.03 | 0.017 | 16.68 | 22.19 |
| | | | | | | | Molality |
| | | | | | σ_{25° C.} | Molality | (mol kg⁻¹) |
| Group 3 | | | | | mS | (mol kg⁻¹) | [LiTFSI + |
| H₂O | PAN | H₂O | S_{2,2,2}TFSI | LiTFSI | cm⁻¹ | [LiTFSI] | S_{2,2,2}TFSI] |
| H9 | 4.33 | 18.5 | 1 | 4.46 | 6.58 | 13.38 | 16.38 |
| H10 | 4.33 | 15.31 | 1 | 4.46 | 5.01 | 16.17 | 19.79 |
| H11 | 4.33 | 9.59 | 1 | 4.46 | 0.84 | 25.81 | 31.60 |
| | | | | | | | Molality |
| | | | | | σ_{25° C.} | Molality | (mol kg⁻¹) |
| | | | | | mS | (mol kg⁻¹) | [LiTFSI + |
| Group 4 | PAN | H₂O | S_{2,2,2}TFSI | LiTFSI | cm⁻¹ | [LiTFSI] | S_{2,2,2}TFSI] |
| H12 | 10.83 | 40.84 | 1 | 12.89 | 4.46 | 17.52 | 18.87 |
| H13 | 13.57 | 34.5 | 1 | 16.14 | 2.45 | 25.96 | 27.57 |
| H14 | 13.57 | 56.66 | 1 | 17.06 | 2.26 | 16.71 | 17.69 |
| | | | | | | | Molality |
| Group 5 | | | | | σ_{25° C.} | Molality | (mol kg⁻¹) |
| Ionic | | | | | mS | (mol kg⁻¹) | [LiTFSI + |
| Liquid | PAN | H₂O | S_{2,2,2}TFSI | LiTFSI | cm⁻¹ | [LiTFSI] | S_{2,2,2}TFSI] |
| H15 | 6.14 | 25.82 | 2 | 6.93 | 3.93 | 14.89 | 19.19 |
| H16 | 6.14 | 29.09 | 2.5 | 6.93 | 4.89 | 13.22 | 17.99 |
| H17 | 6.14 | 15.09 | 3 | 6.93 | 1.44 | 25.49 | 36.52 |
| H18 | 6.14 | 23.26 | 4 | 6.93 | 1.71 | 16.53 | 26.08 |

TABLE 8

| | | | | | | | Molality |
|---|---|---|---|---|---|---|---|
| | | | | | σ_{25° C.} | Molality | (mol kg⁻¹) |
| Group 1 | | | | | mS | (mol kg⁻¹) | [LiTFSI + |
| LiTFSI | PAN | H₂O | Pyr_{1,3}TFSI | LiTFSI | cm⁻¹ | [LiTFSI] | Pyr_{1,3}TFSI] |
| H1 | 6.14 | 23.37 | 1 | 6.93 | 4.22 | 16.46 | 18.83 |
| H2 | 6.14 | 24.44 | 1 | 6.93 | 3.7 | 15.74 | 18.01 |
| H3 | 6.14 | 7.79 | 1 | 4.46 | 1.52 | 31.77 | 38.90 |
| H4 | 6.14 | 8.34 | 1 | 3.03 | 0.96 | 20.16 | 26.82 |
| | | | | | | | Molality |
| | | | | | σ_{25° C.} | Molality | (mol kg⁻¹) |
| Group 2 | | | | | mS | (mol kg⁻¹) | [LiTFSI + |
| PAN | PAN | H₂O | Pyr_{1,3}TFSI | LiTFSI | cm⁻¹ | [LiTFSI] | Pyr_{1,3}TFSI] |
| H5 | 3.27 | 13.91 | 1 | 3.03 | 4.28 | 12.09 | 16.08 |
| H6 | 3.27 | 10.57 | 1 | 3.03 | 3.96 | 15.91 | 21.16 |
| H7 | 6.14 | 9.82 | 1 | 3.03 | 0.14 | 17.12 | 22.77 |
| H8 | 10.83 | 10.83 | 1 | 3.03 | 0.0086 | 15.53 | 20.65 |
| | | | | | | | Molality |
| | | | | | σ_{25° C.} | Molality | (mol kg⁻¹) |
| Group 3 | | | | | mS | (mol kg⁻¹) | [LiTFSI + |
| H₂O | PAN | H₂O | Pyr_{1,3}TFSI | LiTFSI | cm⁻¹ | [LiTFSI] | Pyr_{1,3}TFSI] |
| H9 | 4.33 | 19.94 | 1 | 4.46 | 7.01 | 12.41 | 15.20 |
| H10 | 4.33 | 17.22 | 1 | 4.46 | 8.3 | 14.37 | 17.60 |
| H11 | 4.33 | 14.83 | 1 | 4.46 | 1.24 | 16.69 | 20.43 |
| | | | | | | | Molality |
| | | | | | σ_{25° C.} | Molality | (mol kg⁻¹) |
| | | | | | mS | (mol kg⁻¹) | [LiTFSI + |
| Group 4 | PAN | H₂O | Pyr_{1,3}TFSI | LiTFSI | cm⁻¹ | [LiTFSI] | Pyr_{1,3}TFSI] |
| H12 | 10.83 | 32.52 | 1 | 12.89 | 4.59 | 22.00 | 23.70 |
| H13 | 13.57 | 47.2 | 1 | 16.14 | 3.07 | 18.98 | 20.15 |
| H14 | 13.57 | 57.3 | 1 | 17.06 | 1.25 | 16.52 | 17.49 |
| | | | | | | | Molality |
| Group 5 | | | | | σ_{25° C.} | Molality | (mol kg⁻¹) |
| Ionic | | | | | mS | (mol kg⁻¹) | [LiTFSI + |
| Liquid | PAN | H₂O | Pyr_{1,3}TFSI | LiTFSI | cm⁻¹ | [LiTFSI] | Pyr_{1,3}TFSI] |
| H15 | 6.14 | 9.76 | 2 | 6.93 | 0.6 | 39.40 | 50.77 |
| H16 | 6.14 | 29.34 | 2.5 | 6.93 | 5.07 | 13.11 | 17.84 |
| H17 | 6.14 | 21.29 | 3 | 6.93 | 3.56 | 18.06 | 25.88 |
| H18 | 6.14 | 19.71 | 4 | 6.93 | 1.89 | 19.51 | 30.77 |

TABLE 9

| | | | | | | | Molality |
|---|---|---|---|---|---|---|---|
| Group | | | | | σ_{25° C.} | Molality | (mol kg⁻¹) |
| 1 | | | | | mS | (mol kg⁻¹) | [LiTFSI + |
| LiTFSI | PAN | H₂O | Pyr_{1,3}TFSI | LiTFSI | cm⁻¹ | [LiTFSI] | Pyr_{1,3}TFSI] |
| H19 | 6.14 | 14.72 | 1 | 6.93 | 0.97 | 26.13 | 29.90 |
| H20 | 6.14 | 16.08 | 1 | 11 | 0.46 | 37.96 | 41.41 |
| H21 | 6.14 | 19.78 | 1 | 15 | 0.18 | 42.08 | 44.89 |
| Group | | | | | | | Molality |
| 2 | | | | | σ_{25° C.} | Molality | (mol kg⁻¹) |
| Ionic | | | | | mS | (mol kg⁻¹) | [LiTFSI + |
| Liquid | PAN | H₂O | Pyr_{1,3}TFSI | LiTFSI | cm⁻¹ | [LiTFSI] | Pyr_{1,3}TFSI] |
| H22 | 6.14 | 9.92 | 1 | 6.93 | 0.25 | 38.77 | 44.36 |
| H23 | 6.14 | 10.75 | 0.5 | 6.93 | 0.15 | 35.77 | 38.36 |
| H24 | 6.14 | 8.82 | 0 | 6.93 | 0.06 | 43.60 | 43.60 |

### Impedance and Ionic Transport

EIS and mDSC

The room-temperature (25° C.) electrochemical impedance spectroscopy (EIS) response of HAILSPE systems S_{2,2,2}/Pyr_{1,3} H1-H18 and Pyr_{1,3} H19-H24 were measured to assess ionic mobility as a function of composition. Ionic conductivity, in units of mS cm⁻¹, was calculated from Equation 4 (see previous example above), where t (cm) and A (cm²) are the thickness and area, respectively, of the electrolyte defined by the polytetrafluoroethylene (PTFE) spacer, and R is the ohmic resistance. R values were extracted from the impedance response. Impedance responses varied based on HAILSPE composition and fell into two categories based on their Nyquist plot: those that showed a capacitive effect and those that did not. For the electrolytes that did show capacitance, an equivalent circuit model was used that contained a resistor (R1) in series with a second resistor (R2) that is in parallel with a capacitor. To account for the non-ideal behavior seen in the Nyquist plots, a constant phase element was used in place of the ideal capacitor. In these systems, R1 is indicative of the bulk electrolyte resistance to ionic motion while R2 is indicative of the double layer resistance to ionic motion at the electrode interface. Therefore, the sum of R1 and R2 was used to find R for Equation (4). For the electrolytes that did not show capacitance, a simple equivalent circuit model for a pure ionic conductor, which consists of a single resistor, was used to find R from the intercept of the data at high frequencies.

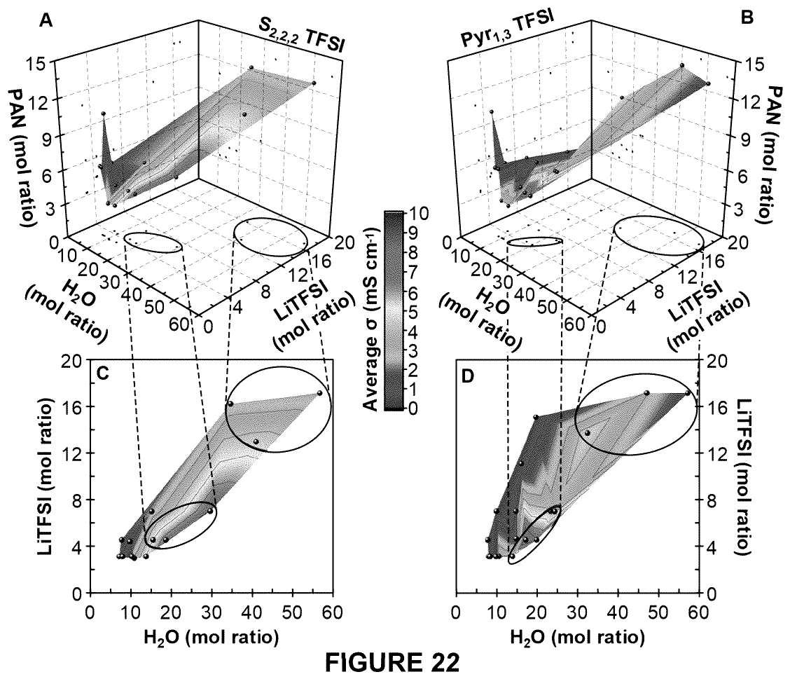

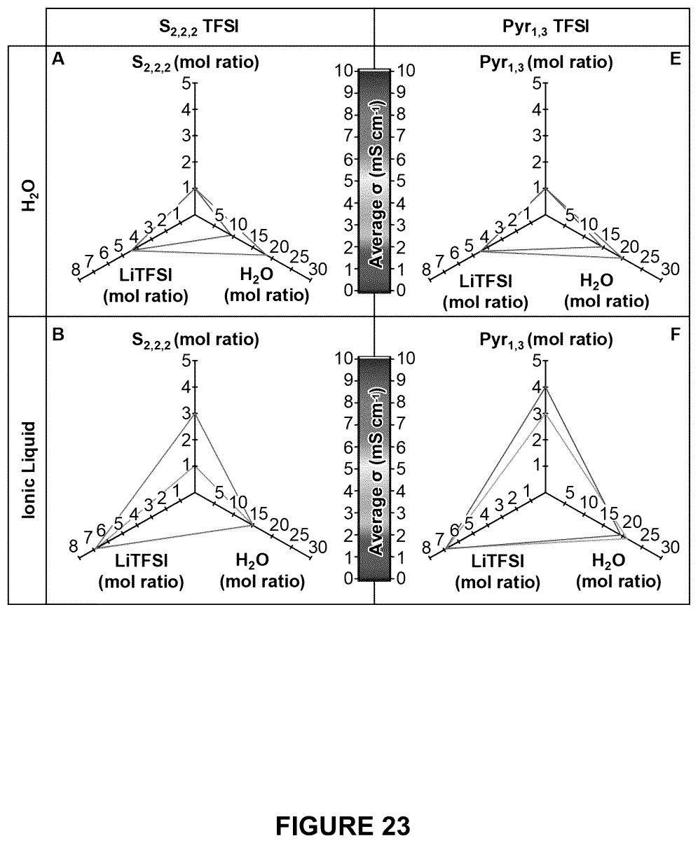

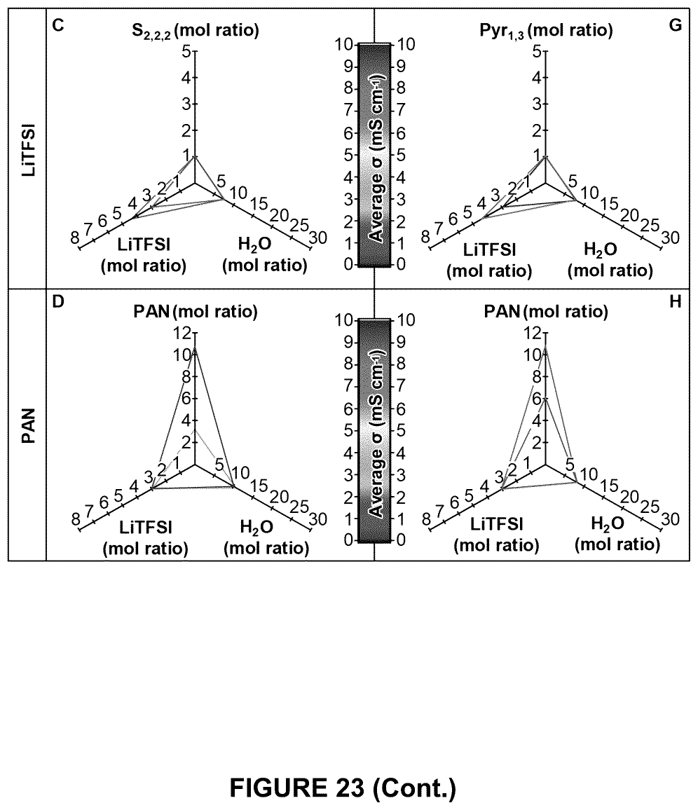

FIG. 22 shows the room-temperature ionic conductivity data for S_{2,2,2} H1-H14, Pyr_{1,3} H1-H14, and Pyr_{1,3} H19-H22, which all contain 1 part ionic liquid, as a function of PAN, H₂O, and LiTFSI composition. Values are indicated by color, with cooler colors (blue) representing low values and warmer colors (red) representing high values. For both S_{2,2,2} and Pyr_{1,3} electrolytes, FIG. 22, Plots A and B clearly show that increasing the relative amount of PAN or LiTFSI in the electrolyte significantly reduces ionic conductivity. Yet, the impact of water is less clear, as a maximum ionic conductivity value is observed only at moderate water concentrations. The ovals in FIG. 22 highlight two noteworthy regions for each set of electrolytes. In the first region, between 10 and 30 parts H₂O, the ionic conductivity values for both S_{2,2,2} and Pyr_{1,3} systems are >5 mS cm 1 with less than 8 parts LiTFSI in FIG. 22, Plots C and D, respectively. In the second region, the water content is doubled to 30-60 parts, but the ionic conductivity values decrease significantly by ≈68% to 2.26 mS cm⁻¹ for S_{2,2,2} and by ≈85% to 1.25 mS cm⁻¹ for Pyr_{1,3} at the highest amount of water (H14). However, compositions with >30 parts H₂O also correspond to the electrolyte systems with the highest LiTFSI content between 12 and 16 parts. To clarify these trends, a more heuristic description of the impacts of composition on ionic conductivity in both S_{2,2,2} and Pyr_{1,3} electrolytes is presented in FIG. 23.

In FIG. 23, Plot A, and FIG. 23, Plot E, both S_{2,2,2} and Pyr_{1,3} systems show a significant increase in ionic conductivity when H₂O is increased and the ionic liquid and LiTFSI contents are held constant. This finding is in agreement with several previous works, which observed that ionic mobility is strongly positively correlated to water concentration. However, these trends are limited to water contents<30 parts when LiTFSI content does not also increase. As discussed above and shown in FIG. 23, Plots C and G, increasing LiTFSI content, even marginally, results in a decrease in ionic conductivity because LiTFSI can aggregate and crystallize at high concentrations, ultimately impeding ionic motion. A similar trend is observed for PAN, in FIG. 23, Plots D and H; increasing the amount of polymer in the system can increase the degree of crystallinity, resulting in lower ionic conductivity due to the lack of segmental motion. The decoupling of ionic transport and polymer chain mobility has been observed in PAN-based electrolytes such that polymer segmental motion is not a major contributor to ionic motion. Electrolyte crystallinity imparted by the polymer matrix—or LiTFSI aggregates—also impedes the movement of free Li⁺ and Li⁺ associated with plasticizer molecules, which are the major contributors to ionic conductivity in these electrolytes. As such, the decrease of ionic conductivity with the increase of LiTFSI agrees with the results seen in FIG. 22, suggesting that the influence of salt on ionic mobility supersedes that of water in regions of the design space where the relative LiTFSI content is >8 parts.

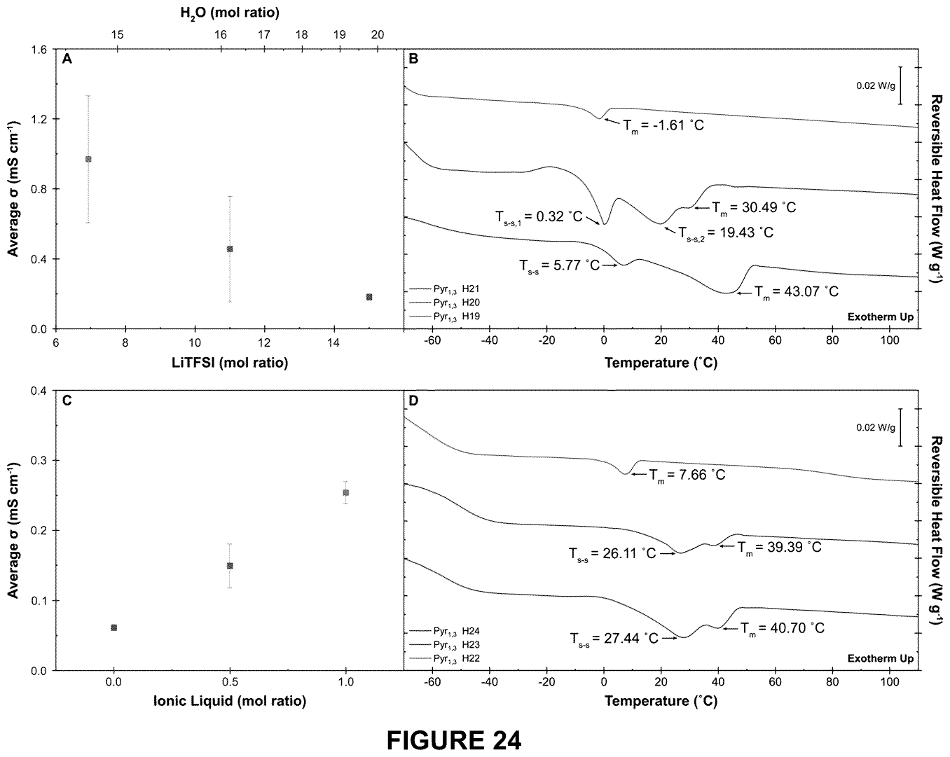

In FIG. 22, the electrolyte compositions >30 parts H₂O (H12-H14) were extraneous systems that did not fit the general categories of Tables 7 and 8, because PAN, H₂O, and ionic liquid contents all changed. To more closely investigate the transition in ionic conductivity at high LiTFSI content, and to remove any effect from PAN, electrolytes H19-H21 were designed and further studied in FIG. 24. Since Pyr_{1,3} H14 showed the largest reduction in ionic conductivity (≈85%), only Pyr_{1,3} H19-H21 electrolytes were synthesized (Table 9). Although these compositions were designed to have the same overall water content and were handled in an environment with a controlled humidity, the hygroscopicity of each electrolyte was different due to their varying salt contents. This led to a large degree of water absorption in the system with the most salt in FIG. 24, Plot A. At 15 parts LiTFSI, Pyr_{1,3} H21 (blue) had the lowest ionic conductivity of the three systems (0.18 mS cm⁻¹), despite having the highest water content. Conversely, Pyr_{1,3} H19 (pink) had the least amount of salt—and water—but displayed the highest ionic conductivity (0.97 mS cm⁻¹). A one-way ANOVA on the mean ionic conductivities of Pyr_{1,3} H19-H21 at a 95% confidence interval showed that H19 and H21 exhibit a statistically significant conductivity difference with a p-value of 0.0045, while H19 and H20 also exhibit a statistically significant conductivity difference with a p-value of 0.0393. Due to the large variation amongst the H20 samples—likely caused by minor fluctuations in water content despite being processed at the same time—the one-way ANOVA found the difference between H20 and H21 was not statistically significant (p=0.3592). However, the general trend of the HAILSPE systems investigated in FIG. 24, Plot A agrees with the trends observed in the HAILSPE systems investigated in FIGS. 22 and 23.

To further understand the results of FIG. 24, Plot A, the thermal properties of the three electrolytes were investigated via modulated differential scanning calorimetry (mDSC); their thermograms are shown in FIG. 24, Plot B. The resulting Pyr_{1,3} H19 electrolyte (pink) exhibited a solid-liquid melting transition, Tₘ, at −1.61° C. Pyr_{1,3} H20 (green), which had the next highest ionic conductivity˜0.45 mS cm 1, exhibited two solid-solid rearrangements (Tₛ₋ₛ), at 0.32 and 19.43° C., before ultimately exhibiting a Tₘ at 30.49° C. Pyr_{1,3} H21 (blue), which had the lowest ionic conductivity, exhibited a Tₛ₋ₛ at 5.77° C. and a Tₘ at 43.07° C. The formation of multiple endothermic peaks upon heating for Pyr_{1,3} H20 and Pyr_{1,3} H21 is attributed to the presence of “excess” water and/or ionic liquid which do not significantly interact with the other components. Pyr_{1,3} H20 and Pyr_{1,3} H21 also exhibit melting temperatures significantly greater than that of Pyr_{1,3} H19 and the operating temperature of 25° C., with an increase in the breadth and intensity of the melting transition. The latent heat for Pyr_{1,3} H20 and Pyr_{1,3} H21—found from the area under the curve—is 12.71 and 10.05 J g⁻¹, respectively. Compared to the latent heat of 0.88 J g⁻¹ for Pyr_{1,3} H19, this suggests a meaningful increase in the degree of crystallinity for these two systems. Thus, the broader melting transitions in Pyr_{1,3} H20 and Pyr_{1,3} H21 are likely the result of a wider distribution of crystal sizes. Furthermore, while many different factors affect Tₘ, the increase in Tₘ for Pyr_{1,3} H20 and Pyr_{1,3} H21 is likely due to this increase in crystallinity, since crystalline lamellae exhibit strong intermolecular forces that severely restrict chain flexibility and increase latent heat. These findings agree with the conductivity values reported in FIG. 24, Plot A, as crystalline structures would impose effective restrictions on the mobility of ions, reducing ionic conductivity.

While FIG. 24, Plot C demonstrates that ionic conductivity increases with increasing relative ionic liquid content up to 1 part, FIG. 23, Plots B and F show that beyond this point, further increasing the amount of IL in the system begins to decrease ionic conductivity; from 2.29 to 1.44 mS cm⁻¹ when increasing the relative amount of S_{2,2,2} to 3 parts from 1, and from 3.56 to 1.89 mS cm⁻¹ when increasing the relative amount of Pyr_{1,3} from 3 parts to 4. Phase separation of the ionic liquid from the bulk electrolyte may be the cause of these drops in conductivity, which was visually observed for systems whose relative ionic liquid content was >2 parts. To this end, the importance of ionic liquid on transport properties below the observed limit of phase separation was also more closely investigated with electrolytes Pyr_{1,3} H22, Pyr_{1,3} H23, and H24 (no ionic liquid) in FIG. 24, Plot C. As the relative LiTFSI content in these electrolytes was held constant, the variation in water content was relatively constant, ranging between 8.82 and 10.75 parts (Table 9). With 1 part ionic liquid, Pyr_{1,3} H22 (pink) had the highest room-temperature ionic conductivity of 0.25 mS cm⁻¹. When the ionic liquid content was halved in Pyr_{1,3} H23 (green) the conductivity decreased to 0.15 mS cm⁻¹, and when the ionic liquid was completely removed from the electrolyte in H24 the ionic conductivity decreased even further to 0.06 mS cm⁻¹. The room-temperature conductivity values of these electrolyte systems are consistent with FIG. 1 and other systems with <10 parts water. A one-way ANOVA of the mean ionic conductivities at a 95% confidence interval was also performed for Pyr_{1,3} H22, Pyr_{1,3} H23, and H24. In this case, because the water contents were relatively constant, the differences of all possible combinations were found to be statistically significant with p-values<0.001.

The results of FIG. 24, Plot C clearly indicate that the inclusion of ionic liquid, to an extent, can promote ionic mobility; FIG. 24, Plot D further explores this result through mDSC. The Pyr_{1,3} H22 system (pink), which has 1 part ionic liquid, exhibited a Tₘ at 7.66° C. with a latent heat of 1.01 J g⁻¹. As the amount of ionic liquid in the electrolytes was decreased, a positive shift in Tₘ and an increase in latent heat was observed. Pyr_{1,3} H23 (green, 0.5 parts ionic liquid) exhibited a Tₘ at 39.39° C. with a latent heat of 4.10 J g 1 and H24 (blue, 0 parts ionic liquid) exhibited a Tₘ at 40.70° C. with a latent heat of 9.11 J g⁻¹. Pyr_{1,3} H23 and H24 also exhibited a single Tₛ₋ₛ at 26.11 and 27.44° C., respectively. As with the increase in LiTFSI content observed in FIG. 24, Plot B, the decrease in ionic liquid content yielded electrolytes that exhibited an increase in the breadth and amplitude of melting transitions. This indicates an increased degree of crystallinity, which is correlated with the decrease in ionic conductivity shown in FIG. 24, Plot C. Thus, the results of FIG. 24, Plot D suggest that ionic liquid is an effective plasticizer that assists in reducing crystallinity and lifting restrictions on ionic mobility, resulting in an increase in ionic conductivity.

pfg-NMR and Lineshape Analysis

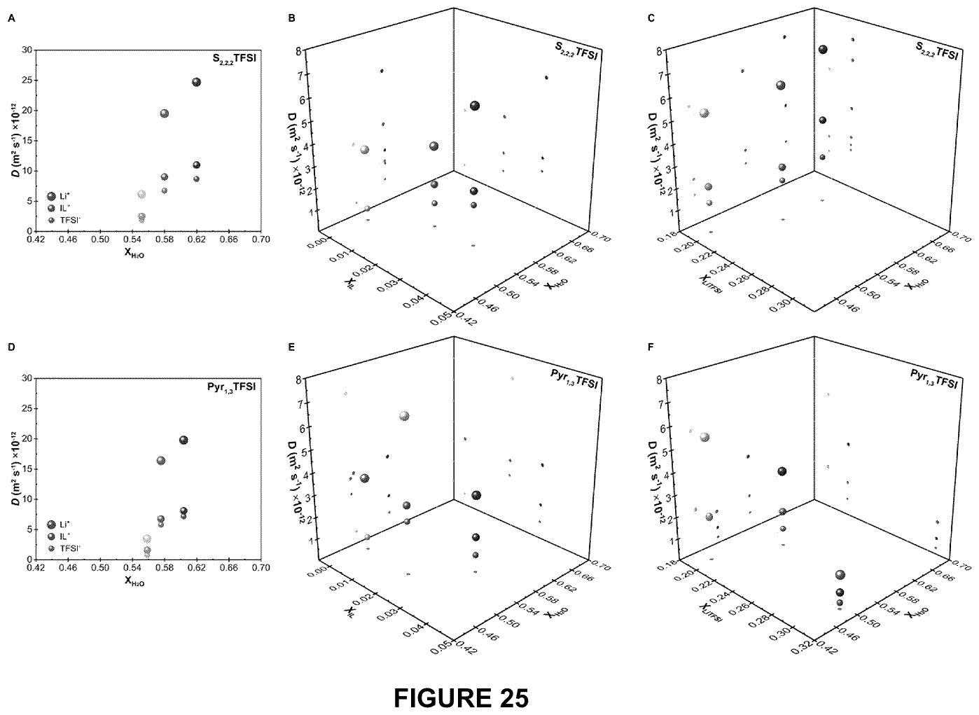

Ionic transport in HAILSPEs was also investigated with pfg-NMR. Much like compositions H1-H18, systems were carefully designed and categorized into three main groups, each focusing on how ionic liquid, LiTFSI, or water influences transport. Tables 10-13, give the relevant compositions for the different systems (NMR1-7) for both S_{2,2,2} and Pyr_{1,3}. From pfg-NMR measurements, diffusion coefficients for H₂O (¹H), Li⁺ (⁷Li), ionic liquid cations (IL⁺) ([S_{2,2,2}]⁺/[Pyr_{1,3}]⁺; ¹H), and [TFSI]⁻(¹⁹F) were calculated and plotted in FIG. 25. Each plot within FIG. 25 focuses on one of three groups in Tables 10-13, with FIG. 25, Plots A-C corresponding to S_{2,2,2} electrolytes and FIG. 25, Plots D-F corresponding to Pyr_{1,3} electrolytes. From FIG. 25, it is immediately clear that the diffusion coefficient of Li⁺ (D_{Li+}) is greater than that of IL⁺ (D_{IL+}) or [TFSI]⁻(D_{TFSI-}), indicating preferential cation transport. In fact, the diffusion coefficients follow the same order for all electrolytes, regardless of changes to composition: D_{Li+} (blue)>D_{IL+} (green)>D_{FTSI-}(red). When only water content is changed, FIG. 25, Plots A and D (“group 3”) suggest that transport is increased for all available ions in both S_{2,2,2} and Pyr_{1,3} systems, respectively. Curiously, the diffusion coefficients increase dramatically, in both systems, when X_{H2O}>0.55.

TABLE 10

| Group | | | | | | | | D_{Li}_{⁺} × | D_{IL}_{⁺} × | D_{TFSI}_{^{−}} × | | σ_{NE25° C.} |
|---|---|---|---|---|---|---|---|---|---|---|---|---|
| 1 Ionic | | | | | | | | 10⁻¹² | 10⁻¹² | 10⁻¹² | | mS |
| Liquid | PAN | H₂O | IL | LiTFSI | X_{H2O} | X_{IL} | X_{LiTFSI} | m² s⁻¹ | m² s⁻¹ | m² s⁻¹ | t_{Li}_{⁺} | cm⁻¹ |
| S_{2,2,2} | 6.14 | 17.30 | 1 | 6.93 | 0.55 | 0.032 | 0.22 | 6.16 | 2.51 | 1.88 | 0.71 | 2.38 |
| NMR1 | | | | | | | | | | | | |
| S_{2,2,2} | 6.14 | 16.61 | 0.5 | 6.93 | 0.55 | 0.017 | 0.23 | 3.75 | 2.00 | 1.11 | 0.74 | 1.50 |
| NMR1 | | | | | | | | | | | | |
| NMR3 | 6.14 | 12.67 | 0 | 6.93 | 0.49 | 0 | 0.27 | 3.34 | 0 | 0.57 | 0.85 | 1.27 |
| Group | | | | | | | | D_{Li}_{⁺} × | D_{IL}_{⁺} × | D_{TFSI}_{^{−}} × | | σ_{NE25° C.} |
| 2 | | | | | | | | 10⁻¹² | 10⁻¹² | 10⁻¹² | | mS |
| LiTFSI | PAN | H₂O | IL | LiTFSI | X_{H2O} | X_{IL} | X_{LiTFSI} | m² s⁻¹ | m² s⁻¹ | m² s⁻¹ | t_{Li}_{⁺} | cm⁻¹ |
| S_{2,2,2} | 6.14 | 17.30 | 1 | 6.93 | 0.55 | 0.032 | 0.22 | 6.16 | 2.51 | 1.88 | 0.71 | 2.38 |
| NMR1 | | | | | | | | | | | | |
| S_{2,2,2} | 6.14 | 31.73 | 1 | 11.00 | 0.64 | 0.020 | 0.22 | 7.08 | 3.90 | 2.14 | 0.72 | 2.89 |
| NMR4 | | | | | | | | | | | | |
| S_{2,2,2} | 6.14 | 9.30 | 1 | 4.00 | 0.45 | 0.049 | 0.18 | 5.4 | 2.13 | 1.39 | 0.70 | 1.80 |
| NMR5 | | | | | | | | | | | | |
| | | | | | | | | D_{Li}_{⁺} × | D_{IL}_{⁺} × | D_{TFSI}_{^{−}} × | | σ_{NE25° C.} |
| Group | | | | | | | | 10⁻¹² | 10⁻¹² | 10⁻¹² | | mS |
| 3 H2O | PAN | H₂O | IL | LiTFSI | X_{H2O} | X_{IL} | X_{LiTFSI} | m² s⁻¹ | m² s⁻¹ | m² s⁻¹ | t_{Li}_{⁺} | cm⁻¹ |
| S_{2,2,2} | 6.14 | 17.30 | 1 | 6.93 | 0.55 | 0.032 | 0.22 | 6.16 | 2.51 | 1.88 | 0.71 | 2.38 |
| NMR1 | | | | | | | | | | | | |
| S_{2,2,2} | 6.14 | 19.41 | 1 | 6.93 | 0.58 | 0.030 | 0.21 | 19.5 | 9.04 | 6.75 | 0.68 | 7.72 |
| NMR6 | | | | | | | | | | | | |
| S_{2,2,2} | 6.14 | 22.92 | 1 | 6.93 | 0.62 | 0.027 | 0.19 | 24.7 | 11.00 | 8.68 | 0.68 | 9.60 |
| NMR7 | | | | | | | | | | | | |

TABLE 11

| Group 1 | | | | | Peak | | | Weakly | XH2O |
|---|---|---|---|---|---|---|---|---|---|
| Ionic | | | | | Position | | FWHM | Bound | (Weakly |
| Liquid | PAN | H₂O | IL | LiTFSI | (ppm) | Amplitude | (ppm) | H2O (%) | Bound) |
| S_{2,2,2} | 6.14 | 17.30 | 1 | 6.93 | 4.04 | 8013 | 0.74 | N/A | N/A |
| NMR1 | | | | | | | | | |
| S_{2,2,2} | 6.14 | 16.61 | 0.5 | 6.93 | 3.98 | 174286 | 0.32 | N/A | N/A |
| NMR2 | | | | | | | | | |
| NMR3 | 6.14 | 12.67 | 0 | 6.93 | 2.50 | 181684 | 0.40 | N/A | N/A |
| | | | | | Peak | | | Weakly | XH2O |
| Group 2 | | | | | Position | | FWHM | Bound | (Weakly |
| LiTFSI | PAN | H₂O | IL | LiTFSI | (ppm) | Amplitude | (ppm) | H2O (%) | Bound) |
| S_{2,2,2} | 6.14 | 17.30 | 1 | 6.93 | 4.04 | 8013 | 0.74 | N/A | N/A |
| NMR1 | | | | | | | | | |
| S_{2,2,2} | 6.14 | 31.73 | 1 | 11.00 | 3.04 | 279855 | 0.41 | N/A | N/A |
| NMR4 | | | | | | | | | |
| S_{2,2,2} | 6.14 | 9.30 | 1 | 4.00 | 2.74 | 767985 | 0.27 | N/A | N/A |
| NMR5 | | | | | | | | | |
| | | | | | Peak | | | Weakly | XH2O |
| Group 3 | | | | | Position | | FWHM | Bound | (Weakly |
| H2O | PAN | H₂O | IL | LiTFSI | (ppm) | Amplitude | (ppm) | H2O (%) | Bound) |
| S_{2,2,2} | 6.14 | 17.30 | 1 | 6.93 | 4.04 | 8013 | 0.74 | 54.63 | 0.30 |
| NMR1 | | | | | | | | | |
| S_{2,2,2} | 6.14 | 19.41 | 1 | 6.93 | 3.20 | 258943 | 0.42 | 58.89 | 0.34 |
| NMR6 | | | | | | | | | |
| S_{2,2,2} | 6.14 | 22.92 | 1 | 6.93 | 3.25 | 404473 | 0.22 | 61.59 | 0.38 |
| NMR7 | | | | | | | | | |

TABLE 12

| Group | | | | | | | | D_{Li}_{⁺} × | D_{IL}_{⁺} × | D_{TFSI}_{^{−}} × | | σ_{NE25° C.} |
|---|---|---|---|---|---|---|---|---|---|---|---|---|
| 1 Ionic | | | | | | | | 10⁻¹² | 10⁻¹² | 10⁻¹² | | mS |
| Liquid | PAN | H₂O | IL | LiTFSI | X_{H2O} | X_{IL} | X_{LiTFSI} | m² s⁻¹ | m² s⁻¹ | m² s⁻¹ | t_{Li}_{⁺} | cm⁻¹ |
| Pyr_{1,3} | 6.14 | 17.79 | 1 | 6.93 | 0.56 | 0.031 | 0.22 | 3.50 | 1.62 | 0.79 | 0.75 | 1.26 |
| NMR1 | | | | | | | | | | | | |
| Pyr_{1,3} | 6.14 | 12.85 | 0.5 | 6.93 | 0.49 | 0.019 | 0.26 | 6.90 | 3.14 | 2.42 | 0.71 | 2.92 |
| NMR2 | | | | | | | | | | | | |
| NMR3 | 6.14 | 12.67 | 0 | 6.93 | 0.49 | 0 | 0.27 | 3.34 | 0 | 0.57 | 0.85 | 1.27 |
| Group | | | | | | | | D_{Li}_{⁺} × | D_{IL}_{⁺} × | D_{TFSI}_{^{−}} × | | σ_{NE25° C.} |
| 2 | | | | | | | | 10⁻¹² | 10⁻¹² | 10⁻¹² | | mS |
| LiTFSI | PAN | H₂O | IL | LiTFSI | X_{H2O} | X_{IL} | X_{LiTFSI} | m² s⁻¹ | m² s⁻¹ | m² s⁻¹ | t_{Li}_{⁺} | cm⁻¹ |
| Pyr_{1,3} | 6.14 | 17.79 | 1 | 6.93 | 0.56 | 0.031 | 0.22 | 3.50 | 1.62 | 0.79 | 0.75 | 1.26 |
| NMR2 | | | | | | | | | | | | |
| Pyr_{1,3} | 6.14 | 17.68 | 1 | 11.00 | 0.49 | 0.028 | 0.31 | 1.52 | 0.74 | 0.29 | 0.80 | 0.59 |
| NMR4 | | | | | | | | | | | | |
| Pyr_{1,3} | 6.14 | 17.14 | 1 | 4.00 | 0.46 | 0.049 | 0.20 | 5.54 | 1.99 | 2.06 | 0.64 | 2.00 |
| NMR5 | | | | | | | | | | | | |
| | | | | | | | | D_{Li}_{⁺} × | D_{IL}_{⁺} × | D_{TFSI}_{^{−}} × | | σ_{NE25° C.} |
| Group | | | | | | | | 10⁻¹² | 10⁻¹² | 10⁻¹² | | mS |
| 3 H2O | PAN | H₂O | IL | LiTFSI | X_{H2O} | X_{IL} | X_{LiTFSI} | m² s⁻¹ | m² s⁻¹ | m² s⁻¹ | t_{Li}_{⁺} | cm⁻¹ |
| Pyr_{1,3} | 6.14 | 17.79 | 1 | 6.93 | 0.56 | 0.031 | 0.22 | 3.50 | 1.62 | 0.79 | 0.75 | 1.26 |
| NMR1 | | | | | | | | | | | | |
| Pyr_{1,3} | 6.14 | 19.07 | 1 | 6.93 | 0.58 | 0.030 | 0.21 | 16.40 | 6.78 | 5.80 | 0.68 | 6.46 |
| NMR6 | | | | | | | | | | | | |
| Pyr_{1,3} | 6.14 | 21.43 | 1 | 6.93 | 0.60 | 0.028 | 0.20 | 19.80 | 8.12 | 7.20 | 0.68 | 7.75 |
| NMR7 | | | | | | | | | | | | |

TABLE 13

| Group 1 | | | | | Peak | | | Weakly | XH2O |
|---|---|---|---|---|---|---|---|---|---|
| Ionic | | | | | Position | | FWHM | Bound | (Weakly |
| Liquid | PAN | H₂O | IL | LiTFSI | (ppm) | Amplitude | (ppm) | H2O (%) | Bound) |
| Pyr_{1,3} | 6.14 | 17.79 | 1 | 6.93 | 3.38 | 157832 | 0.61 | N/A | N/A |
| NMR1 | | | | | | | | | |
| Pyr_{1,3} | 6.14 | 12.85 | 0.5 | 6.93 | 2.71 | 166441 | 0.41 | N/A | N/A |
| NMR2 | | | | | | | | | |
| NMR3 | 6.14 | 12.67 | 0 | 6.93 | 2.50 | 181684 | 0.40 | N/A | N/A |
| | | | | | Peak | | | Weakly | XH2O |
| Group 2 | | | | | Position | | FWHM | Bound | (Weakly |
| LiTFSI | PAN | H₂O | IL | LiTFSI | (ppm) | Amplitude | (ppm) | H2O (%) | Bound) |
| Pyr_{1,3} | 6.14 | 17.79 | 1 | 6.93 | 3.38 | 157832 | 0.61 | N/A | N/A |
| NMR1 | | | | | | | | | |
| Pyr_{1,3} | 6.14 | 17.68 | 1 | 11.00 | 2.62 | 103674 | 1.01 | N/A | N/A |
| NMR4 | | | | | | | | | |
| Pyr_{1,3} | 6.14 | 17.14 | 1 | 4.00 | 2.85 | 62691 | 1.05 | N/A | N/A |
| NMR5 | | | | | | | | | |
| | | | | | Peak | | | Weakly | XH2O |
| Group 3 | | | | | Position | | FWHM | Bound | (Weakly |
| H2O | PAN | H₂O | IL | LiTFSI | (ppm) | Amplitude | (ppm) | H2O (%) | Bound) |
| Pyr_{1,3} | 6.14 | 17.79 | 1 | 6.93 | 3.38 | 157832 | 0.61 | 53.91 | 0.31 |
| NMR1 | | | | | | | | | |
| Pyr_{1,3} | 6.14 | 19.07 | 1 | 6.93 | 2.69 | 526182 | 0.23 | 60.65 | 0.35 |
| NMR6 | | | | | | | | | |
| Pyr_{1,3} | 6.14 | 21.43 | 1 | 6.93 | 3.00 | 299032 | 0.31 | 59.21 | 0.36 |
| NMR7 | | | | | | | | | |

While efforts were made to keep water content as constant as possible, the hygroscopic nature of the electrolyte systems resulted in water content changing when either ionic liquid or LiTFSI content was also changed. As a result, FIG. 25, Plots B and E (“group 1”) and FIG. 25, Plots C and F (“group 2”) present the results as a function of both IL and H₂O or LiTFSI and H₂O content. For S_{2,2,2} electrolyte systems, increasing ionic liquid concentration in FIG. 25, Plot B clearly leads to increased Li⁺ ionic mobility, as D_{Li+} increases from ˜3.75×10 12 to 6.16×10⁻¹² m² s⁻¹ when the ionic liquid content is doubled at the same water concentration (X_{H2O})=0.55). Similarly, for Pyr_{1,3} electrolyte systems, increasing ionic liquid content in FIG. 25, Plot E from 0 (NMR3) to 0.5 parts (Pyr_{1,3} NMR2) resulted in an increase in D_{Li+} from 3.34×10⁻¹² to 6.90×10⁻¹² m² s⁻¹ at X_{H2O})=0.49. Interestingly, further increasing the amount of ionic liquid from 0.5 parts to 1 part (Pyr_{1,3} NMR1) subsequently decreased D_{Li+} to 3.50×10⁻¹² m² s⁻¹, which is similar to that of NMR3. This is likely due to an overestimation of the water content caused by minor changes between the NMR1 sample that was measured with pfg-NMR and the sample that was measured with TGA to calculate the final water amount. The H₂O diffusion coefficient for Pyr_{1,3} NMR1 (1.73×10⁻¹¹ m² s⁻¹) corroborates this claim, as it is consistent with that of NMR3 (1.69×10⁻¹¹ m² s⁻¹) which only has 12.67 parts H₂O.

The influence of LiTFSI content on ionic transport is presented in FIG. 25, Plot C for S_{2,2,2} electrolytes (NMR1, 4, and 5). The results do not readily show an obvious trend as the salt concentrations are relatively constant. The magnitude of D_{Li+} does increase—from 6.16×10⁻¹² to 7.08×10⁻¹² m² s⁻¹—with a slight increase in salt concentration from S_{2,2,2} NMR5 (X_{LiTFSI}=0.18) to S_{2,2,2} NMR1 (X_{LiTFSI}=0.22), however X_{H2O} also increases; this makes it difficult to determine the influence of LiTFSI. When the water concentration is increased at a constant LiTFSI concentration (X_{LiTFSI}=0.22), all three diffusion coefficients increase from S_{2,2,2} NMR1 to S_{2,2,2} NMR2, which is in general agreement with FIGS. 22 and 23. For the Pyr_{1,3} electrolytes, the influence of LiTFSI concentration on ionic mobility is more obvious in FIG. 25, Plot F as the diffusion coefficients from Pyr_{1,3} NMR5 (X_{LiTFSI}=0.20) significantly decrease to Pyr_{1,3} NMR4 (X_{LiTFSI}=0.31) when the salt concentration is increased by more than 50%. Despite X_{H2O} also increasing—from 0.46 to 0.49—D_{Li+} still decreases ≈73%, although the change in salt concentration exceeds that of water. If the salt concentration is held relatively constant, however, and X_{H2O} is significantly increased from 0.46 (Pyr_{1,3} NMR5) to 0.56 (Pyr_{1,3} NMR1; X_{LiTFSI}=0.22), then D_{Li+} decreases by ≈37%. This supports the claim made above that the influence of salt on ionic mobility supersedes that of water.

Regardless of the composition, all S_{2,2,2} and Pyr_{1,3} electrolytes displayed a majority contribution to ionic conductivity from the movement of Li⁺, as shown by the transport number, t_{Li+}. While in non-aqueous systems this is readily measured using the Bruce-Vincent method, this technique requires a lithium metal reference electrode that is not compatible with HAILSPEs. Instead, the pfg-NMR results were used to calculate the transport number using

$$\text{?} = \frac{\text{?} \times \text{?}}{( \text{?} \times \text{?} ) + ( \text{?} \times \text{?} ) + ( \text{?} \times \text{?} )} \qquad ( Equation 9 )$$

$$\text{?} \text{indicates text missing or illegible when filed}$$

where c_{Li+}, c_{TFSI-}, and c_{IL+} are the concentrations of Li⁺, [TFSI]⁻, and ionic liquid cation ([S2,2,2]⁺/[Pyr_{1,3}]⁺), respectively, in units of mol m⁻³. The values of t_{Li+} (Tables 10 and 12) show a decrease with additional water content because the concentration of ions decrease. The results also shed new light on decreasing t_{Li+} with additional ionic liquid and increasing with additional LiTFSI.

As shown in FIG. 24, Plot B, the mDSC results of Pyr_{1,3} H20 and Pyr_{1,3} H21, which showed multiple endothermic peaks upon heating, suggest various degrees of interaction among the components. These interactions, or lack thereof, can have significant implications. In the context of concentrated solid phase aqueous polymer electrolytes, frequent Li⁺—H₂O interactions lead to new domains that facilitate facile ionic transport through the polymer matrix with a high degree of specificity. Consequently, this can be limiting to the overall electrochemical stability of the system as lithium ions shuttle H₂O to the electrode surfaces during charging and discharging, causing water reduction and oxidation. Furthermore, non-interacting, or “free,” water is also able to diffuse to electrode surfaces. Therefore, a common strategy employed is to limit the overall activity of free, unbound H₂O by increasing the concentration of additional species that force it to interact with less mobile moieties. In the context of concentrated liquid phase aqueous electrolytes—such as the WiSE or HANE—this is beneficial as it allows Lit-[TFSI]-interactions to prevail, which leads to anion-derived SEI formation from lithium ions shuttling the anions during charging and discharge. To this end, the degree of strongly interacting (“bound”) and weakly interacting (“weakly bound”) H₂O in HAILSPE systems was investigated.

NMR is a powerful tool for investigating water interactions because spectra are typically sensitive to complex formations and structures, even if interactions are weak. In the absence of interactions, the unbound state has a characteristic, or resonant, frequency of precession. When the unbound state associates with another species, this new interaction alters the local environment causing a shift in this resonant frequency. As such, changes in interactions result in differing spectra depending on several factors, including the degree of interaction, the difference in resonant frequency between the bound (ωb) and weakly bound (ωwb) states, Δω=ω_{wb}−ω_{b}, and the rate of exchange between bound and weakly bound states, kₑₓ. If kₑₓ>>Δω, then the exchange between states is fast and interactions are observed as a single species-averaged peak with a shifted resonant frequency somewhere between ω_{b} and ω_{wb}, based on the degree of interaction. However, if kₑₓ<<Δω, then the exchange between states is slow and interactions are observed as a change in the relative intensity of the peaks at @b and @wb, based on the degree of interaction. Finally, if kₑₓ≈Δω), then the exchange between states occurs at similar time lengths as the resonant frequencies of the two states and interactions are observed as a change in the breadth of the peak (broadening) at the resonant frequency. Some complex systems may observe all three scenarios. Therefore, to both qualitatively and quantitatively assess the degree of bound and unbound water, a lineshape analysis (LSA) derived from the obtained ¹H NMR spectra was conducted.

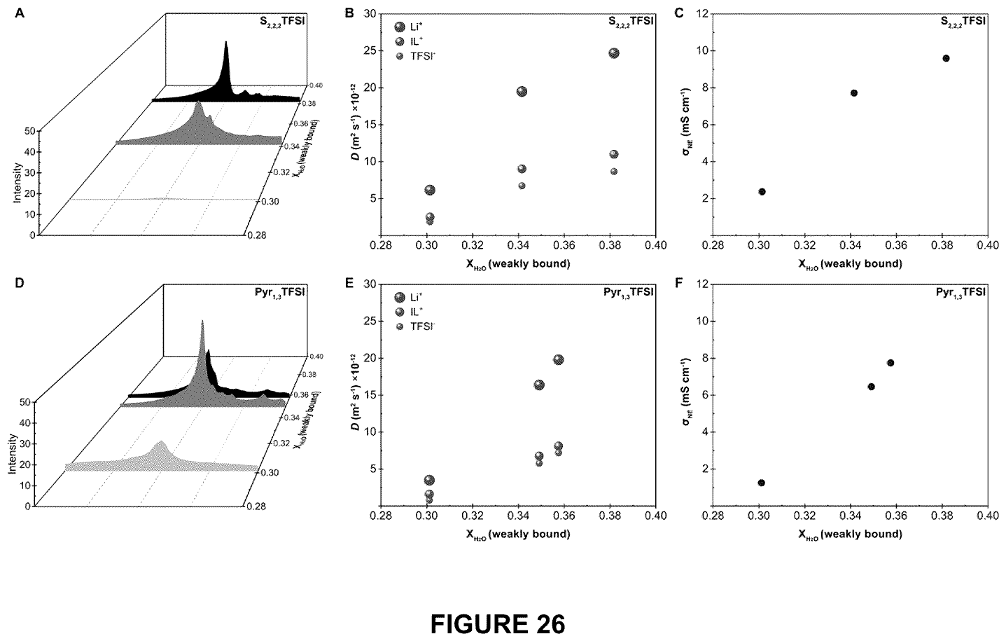

FIG. 26 outlines the LSA for S_{2,2,2} and Pyr_{1,3} NMR1, 6, and 7 (“group 3”) where only the relative water content was changed. Qualitatively, FIG. 26, Plots A and D—which show the measured spectra for S_{2,2,2} and Pyr_{1,3}, respectively—suggest that the HAILSPE systems investigated exhibit a low-to-intermediate kₑₓ, evidenced from the peak broadening and differences in amplitude; while chemical shifts did occur, they are not as significant. The amplitude, A, and position, xₒ, of the primary peak observed in the deconvoluted spectra, which is attributed to water and its various states of interaction, were easily extracted from the spectral data (Tables 11 and 13) for analysis. To quantify the relative peak broadening, the full width at half maximum (FWHM) was calculated of these primary peaks, assuming a Lorentzian lineshape, by

$$F W H M ( A , x , y ) = \sqrt{\frac{4 {y ( {x}_{o} - x )}^{2}}{A - y}} \qquad ( Equation 10 )$$

where x and y are an arbitrary pair of frequency and intensity data within ±0.10 ppm of xₒ. For the S_{2,2,2} electrolytes in FIG. 26, Plot A, both amplitude and FWHM correlated strongly with water concentration displaying R2 values of 0.94 and 0.95, respectively; as the amount of water is increased, the concentration drops along with the probability of interaction, causing the amplitude and FWHM to slowly align with the completely unbound state, indicating weakly bound H₂O. For the Pyr_{1,3} electrolytes in FIG. 26, Plot D, the correlations were significantly weaker (0.41, 0.06). In some cases, this may be due to self-aggregation of the Pyr_{1,3} ionic liquid, which would reduce the degree of water interactions and enhance the frequency of weakly bound water. As the self-aggregation process creates slower surfactant-like moieties, this speculation agrees with the measured D_{IL+} values for Pyr_{1,3} NMR1, 6, and 7, which are 1.33-1.55 times slower than their S_{2,2,2} counterparts.

From the LSA, a quantitative assessment of the amount of strongly bound and weakly bound water in each of the electrolytes was also made based on the relationship between water concentration and FWHM. For each set, boundary conditions were set such that at X_{H2O}=1 water is entirely in the unbound state and as X_{H2O}→0 water is entirely in the bound state. Thus, the amount of bound water in each system was found as a ratio of the sample's FWHM to the FWHM in the completely bound state. The equation of the fit line for the two systems was algebraically rearranged, such that

$$\% {H}_{2} {O}_{bound} ( {S}_{2 , 2 , 2} ) = \frac{F W H M ( ppm ) + 2.7}{7.5} \qquad ( Equation 11 )$$

$$and$$

$$\% {H}_{2} {O}_{bound} ( {Pyr}_{1 , 3} ) = \frac{F W H M ( ppm ) + 2.}{7.6} \qquad ( Equation 12 )$$

FIG. 26, Plots B and E shows the diffusion coefficients from FIG. 25 as a function of the concentration of strongly bound and weakly bound water. Despite the correlation between water concentration and the spectral lineshape of the Pyr_{1,3} electrolytes being weak, data from S_{2,2,2} and Pyr_{1,3} HAILSPEs show that the increase in ionic mobility is correlated with the amount of water in the weakly bound state. Furthermore, the results suggest that the dramatic increase in diffusion coefficients for X_{H2O}>0.55, discussed above in FIG. 25, Plots A and D, may be due to the jump in total weakly bound water that changes the relative viscosity. This trend is translates well to ionic conductivity in FIG. 26, Plots C and F, which is expected as the Nernst-Einstein (NE) derived values are calculated from the obtained pfg-NMR diffusion coefficients by

$$\text{?} = \frac{{F}^{2}}{RT} [ \text{?} ( \text{?} + \text{?} ) + \text{?} ( \text{?} + \text{?} ) ] \qquad ( Equation 13 )$$

$$\text{?} \text{indicates text missing or illegible when filed}$$

where F is the Faraday constant in units of C mol-1. The values predicted from Equation (13) lie within the range of experimentally determined values discussed above.

### Electrochemical Stability and Passivation

Since PAN is not expected to influence the cathodic limit and the effect of LiTFSI concentration is already well characterized, the impact of water and ionic liquid content on the electrochemical stability of HAILSPEs and their ability to passivate was investigated. For this reason, three model electrolyte systems-H2, H15, and H16-were chosen for further exploration (Tables 14 and 15). The electrolyte compositions in Tables 14 and 15 are provided as molar ratios.

TABLE 14

| | PAN | H₂O | S_{2,2,2}TFSI | LiTFSI |
|---|---|---|---|---|
| H2 | 6.14 | 21.20 | 1 | 6.93 |
| H15 | 6.14 | 33.01 | 2 | 6.93 |
| H16 | 6.14 | 30.55 | 2.5 | 6.93 |

TABLE 15

| | PAN | H₂O | Pyr_{1,3}TFSI | LiTFSI |
|---|---|---|---|---|
| H2 | 6.14 | 24.78 | 1 | 6.93 |
| H15 | 6.14 | 29.99 | 2 | 6.93 |
| H16 | 6.14 | 30.91 | 2.5 | 6.93 |

### LSV

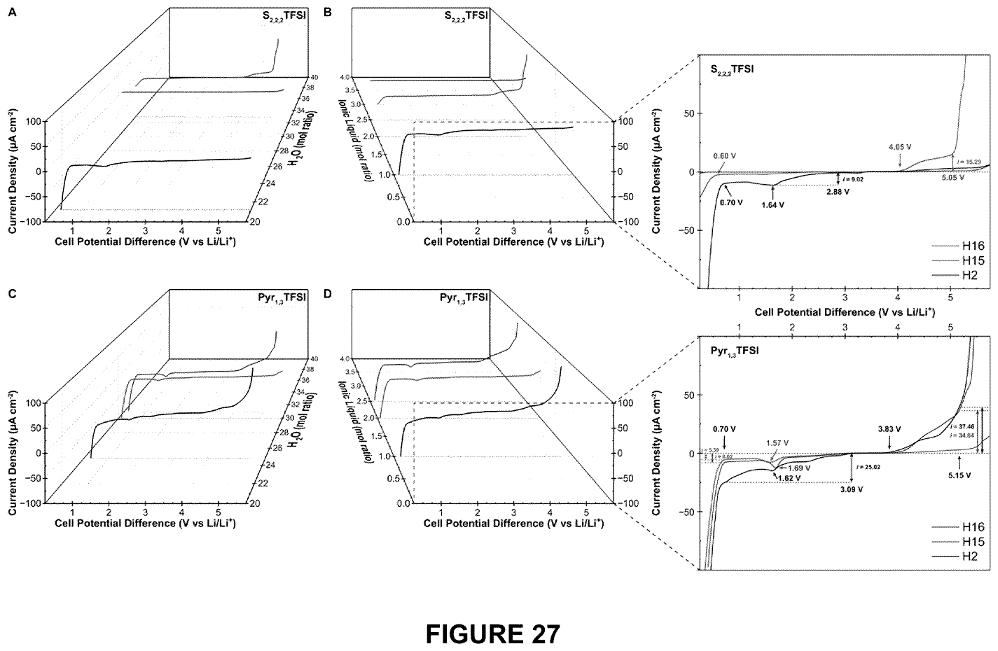

FIG. 27 shows the voltammograms for S_{2,2,2} (Plots A/B) and Pyr_{1,3} (Plots C/D) as a function of both water and ionic liquid content. At the anodic limit>4 V versus Li/Li⁺, water and ionic liquid contents do not have a clear influence, as the onset of electrolyte degradation overlaps for H2 and H16—which contain different H₂O and ionic liquid contents—in both S_{2,2,2} and Pyr_{1,3} systems. Here, the S_{2,2,2} electrolytes show only minor oxidation up to 5.5 V versus Li/Li⁺, while in the Pyr_{1,3} electrolytes the onset of oxidation is shifted down to 4-5 V versus Li/Li⁺ with rapid current evolution at potentials>5 V versus Li/Li⁺. The H15 electrolyte exhibited the opposite behavior, with the Pyr_{1,3} system showing greater anodic stability than the S_{2,2,2} system. Nevertheless, for all six HAILSPEs only minor current evolution was observed between 4 and 5 V versus Li/Li⁺, followed by complete electrolyte degradation for some systems >5 V versus Li/Li⁺. While it can be complicated to precisely determine the ESW in SPEs, these results agree with the generally observed anodic stability of PAN-based SPEs. At the cathodic limit, FIG. 27 indicates that S_{2,2,2} electrolytes are generally more stable than their Pyr_{1,3} counterparts. This is evidenced by the prominent electrolyte reduction at ≈0.70 V versus Li/Li⁺ for all three Pyr_{1,3} HAILSPEs, whereas only one S_{2,2,2} electrolyte (H2) showed reduction at this potential.

### CV

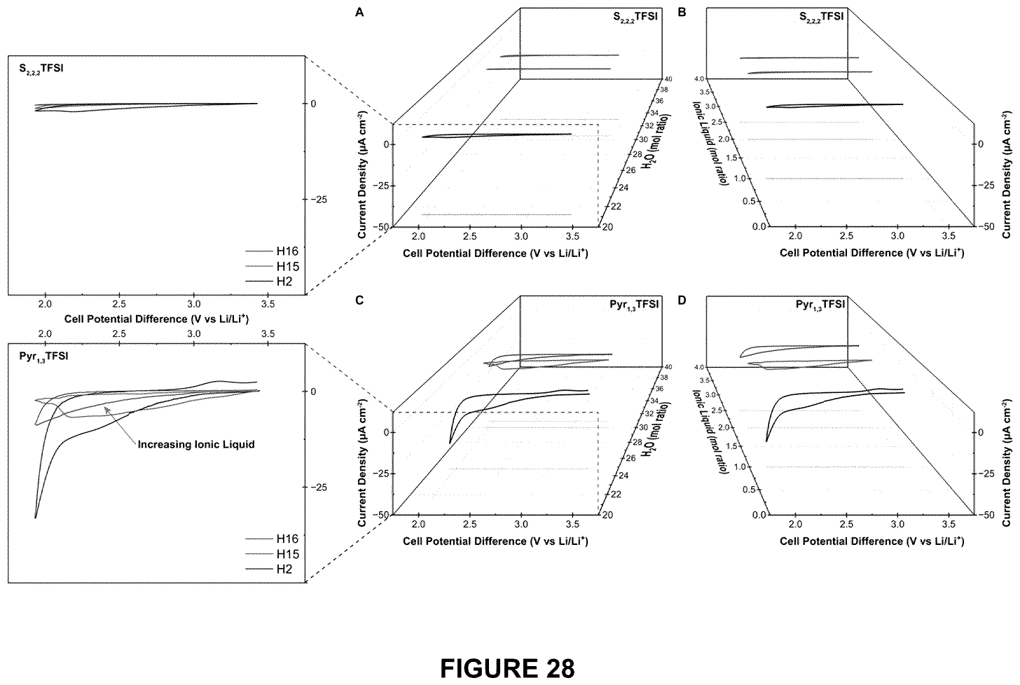

To further investigate the LSV results at the cathodic limit, CV was also performed (FIG. 28) for S_{2,2,2} and Pyr_{1,3}, shown in FIG. 28, Plots A, B, C, and D. A modest limit of ≈2 V versus Li/Li⁺ was chosen so that the measurements would not cause irreversible electrolyte degradation. From the zoomed-in inset, it is immediately apparent that all three Pyr_{1,3} systems exhibit a greater evolution of current at the cathodic limit than their S_{2,2,2} analogs, regardless of water or ionic liquid content, in agreement with FIG. 27. Furthermore, despite S_{2,2,2} and Pyr_{1,3} H2 containing the lowest amount of water (21.20, 24.78), both systems exhibited slower SEI formation that failed to limit H₂O reduction, especially the Pyr_{1,3} electrolyte. Meanwhile, both sets of H15 and H16 electrolytes contained significantly more water (230 parts) and exhibited some current evolution on the first cycle, indicating water reduction. However, this response disappeared on the second and subsequent cycles. This result is also in agreement with FIG. 27, which showed that both S_{2,2,2} and Pyr_{1,3} H2 had poor anodic stability compared to H15 and H16; this difference can be attributed to the increase in ionic liquid in the system from 1 part to 2-2.5 parts, which helps to stabilize SEI formation and create a robust, uniform layer.

### XPS

FIGS. 27 and 28 suggest that both the choice and amount of ionic liquid in the electrolyte impact the electrochemical stability and passivation behavior of the system. Furthermore, as seen in the zoomed-in insets of FIG. 27, a reduction event occurs in both S_{2,2,2} and Pyr_{1,3} electrolytes<2 V versus Li/Li⁺ before water reduction and electrolyte degradation. This behavior has also been observed in WiSEs with ionic liquids. Its origin remains unclear, but it may be caused by 1) reduction of [TFSI]⁻, an essential process in anion-derived SEI formation, or 2) significant generation of hydroxyl groups from the reduction of H₂O, which can nucleophilically attack [TFSI]⁻ and assist in the anion-derived SEI formation. Due to the lack of sensitivity in the two-electrode configuration using L_{0.5} FP, this reduction peak is not always apparent in LSV and CV. Therefore, to further investigate this finding and assess the passivation behavior with greater sensitivity, a three-electrode configuration was necessary. To use the standard Ag/AgCl reference electrode, liquid electrolytes were synthesized sans PAN to circumvent the impracticality of using a fritted reference electrode with the HAILSPEs. These liquid “hybrid aqueous/ionic liquid” electrolytes (HAILEs) were designed with the same H₂O: LiTFSI molar ratio as the HANE, rather than HAILSPEs, to ensure a single-phase system without the solvation power of PAN, but the relative molar amount of the nonaqueous portion—S_{2,2,2} or Pyr_{1,3}—was increased to ensure observation of the reduction of the ionic liquid. The composition of the liquid electrolytes is 1.43 parts H₂O, 2 parts S_{2,2,2}/Pyr_{1,3}, and 1 part LiTFSI. Three-electrode CV was conducted with these electrolytes using a Ti foil working electrode and activated carbon counter electrode at a scan rate of 5 mVs⁻¹. In the first four and 10th cycle from the CV measurements for both HAILEs, the reduction event<2 V versus Li/Li⁺ observed in FIG. 27 was reproduced. Furthermore, the CV results of the HAILEs agree with the observations of FIGS. 27 and 28, which suggested that S_{2,2,2}-based electrolytes provided better cathodic stability and passivation than Pyr_{1,3}. Therefore, the HAILE systems, as designed, are satisfactory analogs for the HAILSPE systems.

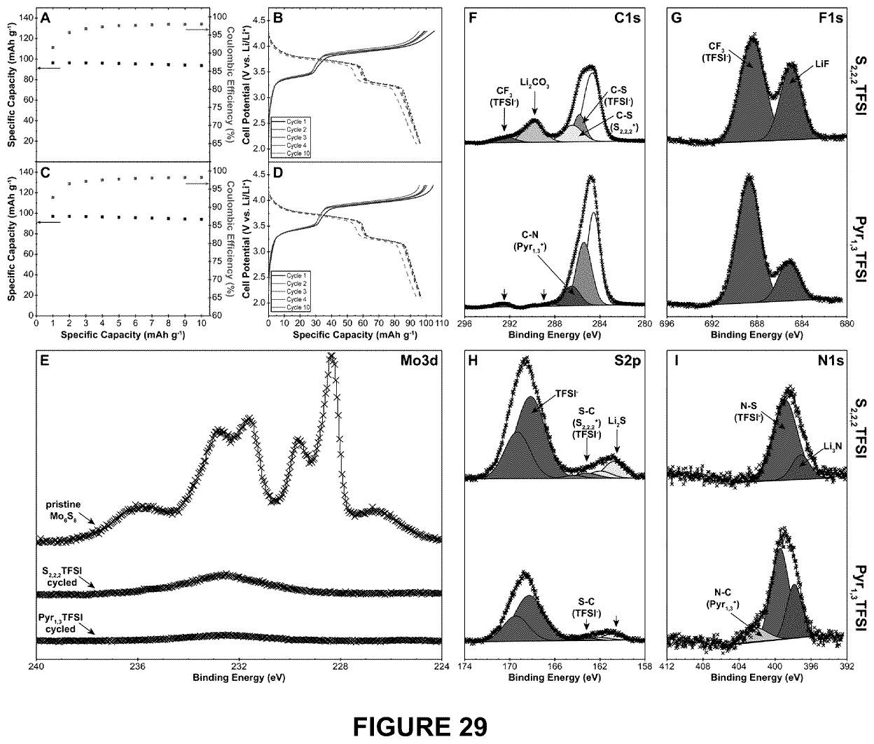

To further investigate the passivation behaviors of the S_{2,2,2} and Pyr_{1,3} electrolytes shown in FIG. 28, XPS analysis was conducted to determine the chemical compositions of the SEI layers formed by the HAILE analogs, shown in FIG. 29. Mo₆S₈/HAILE/LiMn₂O₄ full cells were cycled 10 times; as seen in FIG. 29, Plots A-D, both systems observed strong capacity retention and displayed evidence of SEI growth through the jump in coulombic efficiency from ˜92% in the first cycle to ≈97% by the third cycle. Following the final discharge, cells were carefully opened and the cycled Mo₆S₈ electrodes were extracted. The Mo3d spectra (FIG. 29, Plot E) confirm the presence of SEI formation, as the characteristic Mo(VI) peak, centered ≈232.46 eV, nearly disappeared completely from the pristine anode to the cycled anodes.

The C1s (FIG. 29, Plot F), F1s (FIG. 29, Plot G), S2p (FIG. 29, Plot H), and N1s (FIG. 29, Plot I) XPS core peaks of the cycled Mo₆S₈ electrodes were analyzed to prove the composition of these SEIs. The large characteristic C1s peak in both spectra is attributed to adventitious hydrocarbons at 284.8 eV; both samples exhibited downward shifts due to static charge, therefore all baselines were corrected. At binding energies>292 eV, the CF₃ peak derives from excess LiTFSI salt on the electrode surface that was not completely washed off, as well as the polyvinylidene (PVdF) binder used in the anode. At lower binding energies<287 eV, the detected signals are attributed to C—S and C—N species derived from S_{2,2,2} and Pyr_{1,3}, respectively, as well as the presence of excess LiTFSI. Surprisingly, the C1s in FIG. 29, Plot F also indicate the formation of Li₂CO₃ as an SEI component in the S_{2,2,2} HAILE. Formation of Li₂CO₃ was unexpected, but may be possible through a two-step reaction pathway: 1) nucleophilic substitution (umpolung) of S_{2,2,2} under alkaline conditions to form ethanol, and 2) oxidation of ethanol into CO₃⁻. The oxidation of pure ethanol has been observed at potentials of 2.3-2.4 V versus Li/Li⁺ in various works, which is within the region of current evolution found for the S_{2,2,2} HAILE.

Formation of LiF from the reduction of [TFSI], which is contributed by both LiTFSI and ionic liquid, is apparent from the F1s in FIG. 29, Plot G, which appear at 684.97 and 685.18 eV for S2,2,2 and Pyr_{1,3}, respectively. Interestingly, the amount of LiF formed in the S2,2,2 HAILE is significantly greater than the Pyr_{1,3} electrolyte, which agrees with other studies that show limited LiF growth in Pyr_{1,3}-based electrolytes. The residual signal (688.42 and 688.71 eV) can be attributed to excess LiTFSI salt and the PVdF binder. The S2p spectra in FIG. 29, Plot H indicate the presence of three components. The characteristic peak at 168.15 and 168.28 V for S2,2,2 and Pyr_{1,3}, respectively, is categorically assigned to LiTFSI, while the signal at 163.15 and 163.25 eV can be attributed to sulfonyl groups of LiTFSI and S2,2,2 (only LiTFSI for the Pyr_{1,3} HAILE). At 160.78 and 160.89 eV, the formation of Li₂S is observed, which can be from the decomposition of both LiTFSI and S_{2,2,2}. This is supported by FIG. 29, Plot H, as the S_{2,2,2} HAILE shows a peak (160.78 eV) with greater intensity than the Pyr_{1,3} HAILE (160.89 eV), suggesting that the ionic liquid further contributes to the formation of Li₂S. Similarly, FIG. 29, Plot I shows that the formation of Li₃N is greater in Pyr_{1,3} HAILE (397.86 eV) compared to S_{2,2,2} HAILE (397.18 eV), which is due to the additional decomposition of the ionic liquid along with the decomposition of LiTFSI. FIG. 29, Plot I also shows a characteristic signal assigned to the imide groups of LiTFSI and Pyr_{1,3} (only LiTFSI for the S_{2,2,2} HAILE) at 398.93 and 399.46 eV. The residual peak at 402.44 eV in the Pyr_{1,3} HAILE is attributed to the N⁺ of Pyr_{1,3}⁺.

### Galvanostatic Cycling

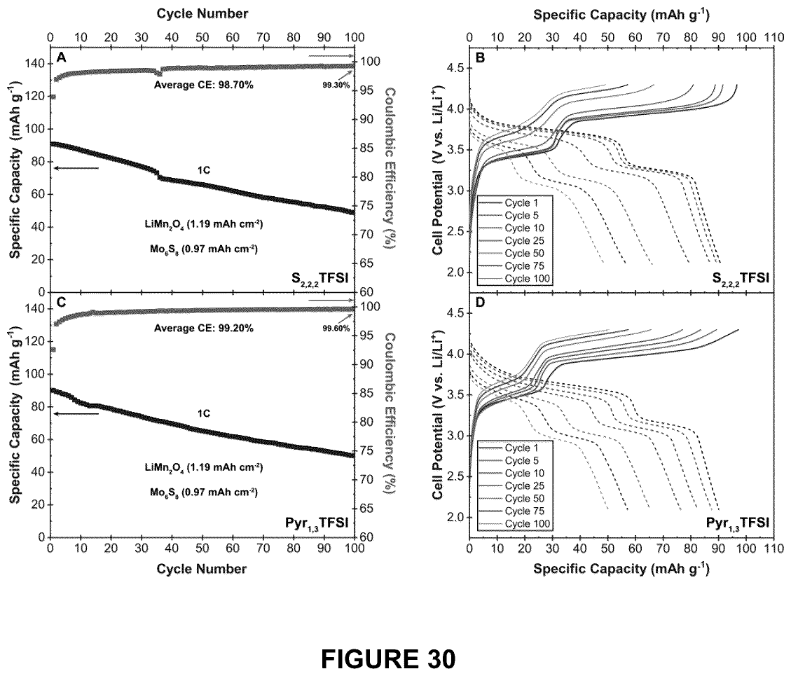

Despite the clear difference in SEI composition and the LSV/CV results suggesting S_{2,2,2} is more stable and better prevents H₂O reduction, the full cell cycling of the S_{2,2,2} and Pyr_{1,3} HAILEs in FIG. 30 show comparable performance over 100 cycles. The electrolytes were cycled in Mo₆S₈ (0.97 mAh cm⁻²)/HAILE/LiMn₂O₄ (1.19 mAh cm⁻²) full cells at a constant charge-discharge rate of 1C at 40° C. A targeted N:P (negative:positive) capacity ratio of 1:1.3 was used to account for irreversible capacity loss during cycling. S_{2,2,2} shows better capacity retention over the first 25 cycles (87.8%) in FIG. 30, Plot B compared to Pyr_{1,3} (82.4%) in FIG. 30, Plot D, but then shows a prominent drop in capacity by cycle 50 to match that of Pyr_{1,3}. Nevertheless, both HAILE systems display relatively efficient cycling (99.3%-99.6% CE) up to 100 cycles with clear SEI growth evidenced by the increase in the CE from the first cycle-93.92% for S_{2,2,2} and 92.60% for Pyr_{1,3}-however, capacity retention decreased to <80% by cycle 35 for both systems. For comparison, the HAILSPE S_{2,2,2} H15 was also cycled in a Mo₆S₈/LiMn₂O₄ full cell. Notably, despite the CE and intermittent EIS clearly showing the formation of an SEI within the first 3-5 cycles, the cycling performance and voltage profile display reduced initial capacity utilization (71.4 mAh g⁻¹), slightly reduced average efficiency (98.27% CE), and worse capacity fading over 100 cycles compared to the HAILE analogs. Furthermore, this HAILSPE system was only capable of cycling at a charge-discharge rate of ≈C/30, which is significantly slower than the 1C rate used for the HAILEs. Since S_{2,2,2} H15 showed electrochemical stability beyond 2 V versus Li/Li⁺ and minimal water reduction at the lower limit of CV in FIG. 28, or significant passivation against H₂O reduction in the case of the HAILEs, a thermodynamic limitation caused by electrolyte degradation is unlikely to be the cause of failure in these systems.

While the exact cause for the cycling behavior observed in FIG. 30 is not fully known, the results indicate poor compatibility between the electrode and electrolytes, likely due to kinetic limitations. This is expected for the HAILSPEs, which is related to the use of porous electrodes tailored for liquid electrolytes that prevent access to available capacity when paired with SPEs. However, because a similar behavior, although not as prominent, is observed in the HAILEs, this behavior may indicate low-quality electrodes. While the intercalation/deintercalation and charge-transfer processes remain efficiently reversible, evidenced by the high coulombic efficiency (>99.30%) after 100 cycles for both liquid and solid systems, the access to usable capacity is being limited with each cycle. This could be due to a reduction in the overall number of lithium redox reactions occurring from the loss of electrical and/or ionic pathways through the bulk electrode or due to loss of contact at the interface directly. The latter only applies to the solid HAILSPEs, which already suffer from poor interfacial wetting due to the solid nature of the electrolyte. A differential capacity analysis (DCA) of the cycling results from FIG. 30 corroborates this, showing both dQ/dV peak shifting and dQ/dV peak reduction for both HAILE and HAILSPE systems. The observation of both peak shifting and reduction with cycling indicates the loss of lithium inventory due to the collapse of both electrical and ionic pathways in the bulk electrode material. This collapse can be caused by processes such as binder decomposition, which decreases particle-particle interactions, and solvent co-intercalation owing to high electrode porosity and/or large pore sizes.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

What is claimed is:

1. An electrolyte, comprising:
(a) at least one lithium salt in water;
(b) at least one ionic liquid; and
(c) at least one polymer;
wherein the mass ratio of the polymer to the at least one lithium salt and at least one ionic liquid in the electrolyte from about 1:1 to about 100:1.

2. The electrolyte of claim 1, wherein the at least one lithium salt comprises an anion selected from the group consisting of bis(trifluoromethane sulfonyl)imide (TFSI⁻), trifluoromethane sulfonate (TF⁻), bis(fluorosulfonyl) imide (FSI⁻), tetrafluorophosphate (BF₄⁻), hexafluorophosphate (PF₆⁻), bis(perfluoroethyl sulfonyl)imide (BETI⁻), 4,5-dicyano-2-trifluoromethanoimidazole (DCMI⁻), [fluoro (nonafluorobutane) sulfonyl] imide (FNF⁻), perchlorate (ClO₄⁻), sulfate (SO₄⁻), bis(oxalate) borate (BOB⁻), dicyanamide (C₂N₃⁻), nitrate (NO₃⁻), acetate (CH₃CO₂⁻), chloride (Cl⁻), bromide (Br⁻), and iodide (I⁻).

3. The electrolyte of claim 1, wherein the at least one lithium salt is LiTFSI.

4. The electrolyte of claim 1, wherein the molality of the lithium salt and ionic liquid to water is from about 10 mol/kg to about 60 mol/kg.

5. The electrolyte of claim 1, wherein the at least one polymer is selected from the group consisting of polyethylene oxide, polyacrylonitrile, polyvinylidene fluoride, poly(methyl acrylate), poly(methyl methacrylate), poly(oxymethylene), and polystyrene.

7. The electrolyte of claim 1, wherein the at least one polymer is polyethylene oxide or polyacrylonitrile.

8. The electrolyte of claim 1, wherein the ionic liquid comprises an anion selected from the group consisting of bis(trifluoromethane sulfonyl)imide (TFSI⁻), trifluoromethane sulfonate (TF⁻), bis(fluorosulfonyl) imide (FSI⁻), tetrafluorophosphate (BF₄⁻), hexafluorophosphate (PF₆⁻), bis(perfluoroethyl sulfonyl)imide (BETI⁻), 4,5-dicyano-2-trifluoromethanoimidazole (DCMI⁻), [fluoro (nonafluorobutane) sulfonyl]imide (FNF⁻), perchlorate (ClO₄⁻), sulfate (SO₄⁻), bis(oxalate) borate (BOB⁻), dicyanamide (C₂N₃⁻), nitrate (NO₃⁻), acetate (CH₃CO₂⁻), chloride (Cl⁻), bromide (Br⁻), and iodide (I⁻).

9. The electrolyte of claim 1, wherein the ionic liquid comprises a cation selected from the group consisting of imidazolium, pyrrolidinium, pyridinium, phosphonium, ammonium, guanidinium, piperidinium, and sulfonium.

10. The electrolyte of claim 9, wherein the pyrrolidinium is 1-methyl-1-propylpyrrolidinium (Pyr_{1,3}).

11. The electrolyte of claim 9, wherein the sulfonium is triethylsulfonium (S2,2,2).

12. The electrolyte of claim 1, wherein the molar ratio of the at least one polymer to water is from about 1:1 to about 1:6.

13. The electrolyte of claim 1, wherein the molar ratio of the at least one ionic liquid to water is from about 1:2 to about 1:60.

14. The electrolyte of claim 1, wherein the mass ratio of the at least one polymer to the at least one lithium salt is between about 1:107 and about 107:1.

15. The electrolyte of claim 1, wherein the electrolyte has an ionic conductivity at 25° C. from about 1 mS/cm to about 7 mS/cm.

16. An electrochemical battery cell comprising:
(a) the electrolyte of claim 1;
(b) a positive electrode; and
(c) a negative electrode.

17. The battery cell of claim 16, wherein the positive electrode is selected from the group consisting of LiCoO₂, LiNi_{0.33}Mn_{0.33}Co_{0.33}O₂, LiNi_{0.5}Mn_{1.5}O₂, LiCoPO₄, LiFePO₄, LiNiPO₄, and LiMn₂O₄.

18. The battery cell of claim 16, wherein the negative electrode is selected from the group consisting of lithium, magnesium, aluminum, zinc, chromium, iron, nickel, tin, lead, hydrogen, copper, silver, palladium, mercury, platinum, gold, molybdenum, sulfur, combinations thereof, and oxides thereof.

19. A method of preparing the electrolyte of claim 1 comprising:
(a) admixing at least one lithium salt in water, at least one ionic liquid, and at least one polymer, wherein the mass ratio of the polymer to the at least one lithium salt and at least one ionic liquid in the electrolyte from about 1:1 to about 100:1; and
(b) pressing the admixture of (a) at a temperature from about 30° C. to about 150° C. and at a pressure from about 0.2 metric tons to about 2 metric tons.

20. The method of claim 19, wherein the electrolyte is a thin film having a thickness from about 50 μm to about 300 μm.
